(19) United States
(12) Patent Application Publication
(10) Pub. No.: US 2015/0069692 A1
(43) Pub. Date: Mar. 12, 2015

(54) SYSTEMS AND METHODS FOR INSECT DISSECTION

(71) Applicant: TOKITAE LLC, Bellevue, WA (US)

(72) Inventors: Anthony V. Finazzo, Lake Forest Park, WA (US); Jennifer Ezu Hu, Seattle, WA (US); Jerry W. Lee, Kirkland, WA (US); Emma Rae Mullen, Seattle, WA (US); John Arthur Ohrt, Redmond, WA (US); David Keith Piech, Seattle, WA (US); Matthew F. Rosen, Seattle, WA (US)

(73) Assignee: TOKITAE LLC, Bellevue, WA (US)

(21) Appl. No.: 14/020,701

(22) Filed: Sep. 6, 2013

(51) Int. Cl. B23Q 3/18

(52) U.S. Cl. CPC B23Q 3/18
USPC 269/55; 269/287; 29/559

(57) ABSTRACT

The present disclosure relates to devices, systems, and methods that may be used to dissect insects. In some embodiments, the systems, devices, and methods may be used to isolate insect salivary glands. In some embodiments, the systems, devices, and methods may be used to isolate mosquito salivary glands. In some embodiments, the systems, devices, and methods may be used to collect mosquito salivary glands.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a device includes, but is not limited to, one or more first members having one or more thorax orifices through which a head portion of an insect can protrude and which restrains a thorax portion of the insect; and one or more second members having one or more head orifices that can accept the head portion of the insect and that are operably coupled to the one or more first members so that lateral movement of the one or more first members relative to the one or more second members substantially immobilizes the head portion of the insect. In some embodiments, a device may optionally include one or more operably coupled drive mechanisms that move either or both of the one or more first members and the one or more second members laterally relative to each other. In some embodiments, a device may optionally include one or more base members that are operably coupled to the one or more first members and to the one or more second members. In some embodiments, a device may optionally include one or more operably coupled sweeper arms. In some embodiments, a device may optionally include one or more operably coupled image acquisition devices. In some embodiments, a device may optionally include one or more operably coupled detectors. In some embodiments, a device may optionally include one or more operably coupled scrapers. In some embodiments, a device may optionally include one or more operably coupled suction assemblies. In addition to the foregoing, other device aspects are described in the claims, drawings, and text forming a part of the present disclosure.

In one aspect, a device includes, but is not limited to, one or more first members having one or more thorax orifices through which a head portion of an insect can protrude and which restrains a thorax portion of the insect, one or more second members having one or more head orifices that can accept the head portion of the insect and that are operably coupled to the one or more first members so that lateral movement of the one or more first members relative to the one or more second members substantially immobilizes the head portion of the insect, one or more base members that are operably coupled to the one or more first members and to the one or more second members, one or more drive mechanisms that are operably coupled to one or more position indicators and that move either or both of the one or more first members and the one or more second members laterally relative to each other; and one or more operably coupled sweeper arms. In addition to the foregoing, other device aspects are described in the claims, drawings, and text forming a part of the present disclosure.

In one aspect, a system includes, but is not limited to, circuitry configured to control one or more drive mechanisms that laterally move one or more first members relative to one or more second members of a device, wherein the one or more first members include one or more thorax orifices through which a head portion of the insect protrudes and which restrains a thorax portion of the insect and the one or more second members include one or more head orifices that accept the head portion of the insect. In some embodiments, a system may optionally include circuitry configured to control one or more sweeper drive mechanisms. In some embodiments, a system may optionally include circuitry configured to control one or more image acquisition devices. In some embodiments, a system may optionally include circuitry configured to control one or more detectors. In some embodiments, a system may optionally include circuitry configured to control one or more movable members that are operably coupled to one or more scrapers. In some embodiments, a system may optionally include circuitry configured to control one or more suction assemblies. In addition to the foregoing, other device aspects are described in the claims, drawings, and text forming a part of the present disclosure.

In one aspect, a system includes, but is not limited to, circuitry configured to control one or more image acquisition devices that are configured to detect one or more insect salivary glands. In addition to the foregoing, other device aspects are described in the claims, drawings, and text forming a part of the present disclosure.

In one aspect, a system includes, but is not limited to, circuitry configured to control one or more movable members that are operably coupled to one or more scrapers in response to receiving one or more signals from one or more image acquisition devices. In addition to the foregoing, other device aspects are described in the claims, drawings, and text forming a part of the present disclosure.

In one aspect, a system includes, but is not limited to, circuitry configured to control one or more suction assemblies in response to detecting one or more insect salivary glands. In addition to the foregoing, other device aspects are described in the claims, drawings, and text forming a part of the present disclosure.

In one aspect, a system includes, but is not limited to, circuitry configured to control one or more image acquisition devices that are configured to detect one or more insect salivary glands and circuitry configured to control one or more moveable members that are operably coupled to one or more scrapers in response to the circuitry configured to control the one or more image acquisition devices that are configured to detect the one or more insect salivary glands. In addition to the foregoing, other device aspects are described in the claims, drawings, and text forming a part of the present disclosure.

In one aspect, a system includes, but is not limited to, circuitry configured to control one or more image acquisition devices that are configured to detect one or more insect salivary glands and circuitry configured to control one or more suction assemblies in response to the circuitry configured to control the one or more image acquisition devices that are configured to detect the one or more insect salivary glands. In addition to the foregoing, other device aspects are described in the claims, drawings, and text forming a part of the present disclosure.

In one aspect, a system includes, but is not limited to, a fixed signal-bearing tangible medium bearing one or more instructions to control one or more drive mechanisms that laterally move one or more first members of a device relative to one or more second members of the device, wherein the one or more first members include one or more thorax orifices through which a head portion of a insect can protrude and which restrains a thorax portion of the insect and the one or more second members include one or more head orifices that can accept the head portion of the insect. In some embodiments, a system may optionally include one or more instructions to control one or more sweeper drive mechanisms. In some embodiments, a system may optionally include one or more instructions to control one or more image acquisition devices. In some embodiments, a system may optionally include one or more instructions to control one or more detectors. In some embodiments, a system may optionally include one or more instructions to control one or more moveable members that are operably coupled to one or more scrapers. In some embodiments, a system may optionally include one or more instructions to control one or more suction assemblies. In addition to the foregoing, other device aspects are described in the claims, drawings, and text forming a part of the present disclosure.

In one aspect, a system includes, but is not limited to, a fixed signal-bearing tangible medium bearing one or more instructions to control one or more image acquisition devices that are configured to detect one or more insect salivary glands. In addition to the foregoing, other device aspects are described in the claims, drawings, and text forming a part of the present disclosure.

In one aspect, a system includes, but is not limited to, a fixed signal-bearing tangible medium bearing one or more instructions to control one or more movable members that are operably coupled to one or more scrapers in response to receiving one or more signals from one or more image acquisition devices that are configured to detect one or more insect salivary glands. In addition to the foregoing, other device aspects are described in the claims, drawings, and text forming a part of the present disclosure.

In one aspect, a system includes, but is not limited to, a fixed signal-bearing tangible medium bearing one or more instructions to control one or more suction units in response to receiving one or more signals from one or more image acquisition devices that are configured to detect one or more insect salivary glands. In addition to the foregoing, other device aspects are described in the claims, drawings, and text forming a part of the present disclosure.

In one aspect, a system includes, but is not limited to, means for controlling one or more drive mechanisms that laterally move one or more first members of a device relative to one or more second members of the device, wherein the one or more first members include one or more thorax orifices through which a head portion of an insect can protrude and which restrains a thorax portion of the insect and the one or more second members include one or more head orifices that can accept the head portion of the insect. In some embodiments, a system may optionally include means for controlling one or more sweeper drive mechanisms. In some embodiments, a system may optionally include means for controlling one or more image acquisition devices. In some embodiments, a system may optionally include means for controlling one or more detectors. In some embodiments, a system may optionally include means for controlling one or more moveable members that are operably coupled to one or more scrapers. In some embodiments, a system may optionally include means for controlling one or more suction assemblies. In addition to the foregoing, other device aspects are described in the claims, drawings, and text forming a part of the present disclosure.

In one aspect, a system includes, but is not limited to, means for controlling one or more image acquisition devices units that are configured to detect one or more insect salivary glands. In addition to the foregoing, other device aspects are described in the claims, drawings, and text forming a part of the present disclosure.

In one aspect, a system includes, but is not limited to, means for controlling one or more moveable members that are operably coupled to one or more scrapers in response to receiving one or more signals from one or more image acquisition devices that are configured to detect one or more insect salivary glands. In addition to the foregoing, other device aspects are described in the claims, drawings, and text forming a part of the present disclosure.

In one aspect, a system includes, but is not limited to, means for controlling one or more suction assemblies in response to receiving one or more signals from one or more image acquisition devices that are configured to detect one or more insect salivary glands. In addition to the foregoing, other device aspects are described in the claims, drawings, and text forming a part of the present disclosure.

In one aspect, a method includes, but is not limited to, introducing an insect into a device that includes one or more first members that are operably coupled to one or more second members, wherein the one or more first members include one or more thorax orifices through which a head portion of the insect protrudes and which restrains a thorax portion of the insect and the one or more second members include one or more head orifices that accept the head portion of the insect, laterally moving one or both of the one or more first members and the one or more second members relative to each other to substantially immobilize the head portion of the insect, and substantially separating the thorax portion of the insect from the head portion of the insect. In some embodiments, a method may optionally include collecting one or more salivary glands from the insect. In addition to the foregoing, other device aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 2 illustrates example components of system 100 in which embodiments may be implemented.

FIG. 3 illustrates example components of system 100 in which embodiments may be implemented.

FIG. 4 illustrates a side view of an example device 400 in which embodiments may be implemented.

FIG. 5 illustrates a side view of an example device 400 in which embodiments may be implemented.

FIG. 6 illustrates a top view of an example device 400 in which embodiments may be implemented.

FIG. 7A illustrates a component of example device 400 in which embodiments may be implemented.

FIG. 7B illustrates a component of example device 400 in which embodiments may be implemented.

FIG. 7C illustrates a component of example device 400 in which embodiments may be implemented.

FIG. 7D illustrates a component of example device 400 in which embodiments may be implemented.

FIG. 7E illustrates a component of example device 400 in which embodiments may be implemented.

FIG. 8 illustrates a component of example device 400 in which embodiments may be implemented.

FIG. 9 illustrates a component of example device 400 in which embodiments may be implemented.

FIG. 10 illustrates a component of example device 400 in which embodiments may be implemented.

FIG. 11 illustrates a component of example device 400 in which embodiments may be implemented.

FIG. 12 illustrates a component of example device 400 in which embodiments may be implemented.

FIG. 13 illustrates a component of example device 400 in which embodiments may be implemented.

FIG. 14 illustrates a component of example device 400 in which embodiments may be implemented.

FIG. 15 illustrates a component of example device 400 in which embodiments may be implemented.

FIG. 16 illustrates a component of example device 400 in which embodiments may be implemented.

FIG. 17 illustrates a component of example device 400 in which embodiments may be implemented.

FIG. 18 illustrates an alternate embodiment of a first member and a second member in which embodiments may be implemented.

FIG. 19 illustrates an alternate embodiment of a first member and a second member in which embodiments may be implemented.

FIG. 20 illustrates an alternate embodiment of a first member and a second member in which embodiments may be implemented.

FIG. 21 illustrates an alternate embodiment of a first member and a second member in which embodiments may be implemented.

FIG. 22 illustrates an alternate embodiment of a first member and a second member in which embodiments may be implemented.

FIG. 23 illustrates an alternate embodiment of a first member and a second member in which embodiments may be implemented.

FIG. 24 illustrates an alternate embodiment of a first member and a second member in which embodiments may be implemented.

FIG. 25 illustrates an alternate embodiment of a first member and a second member in which embodiments may be implemented.

FIG. 26 illustrates an alternate embodiment of a first member and a second member in which embodiments may be implemented.

FIG. 27 illustrates an alternate embodiment of a first member and a second member in which embodiments may be implemented.

FIG. 28 illustrates an example system 2800 in which embodiments may be implemented.

FIG. 29 illustrates an example system 2900 in which embodiments may be implemented.

FIG. 30 illustrates an example system 3000 in which embodiments may be implemented.

FIG. 31 illustrates an example system 3100 in which embodiments may be implemented.

FIG. 32 illustrates an example system 3200 in which embodiments may be implemented.

FIG. 33 illustrates an example system 3300 in which embodiments may be implemented.

FIG. 34 illustrates an example system 3400 in which embodiments may be implemented.

FIG. 35 illustrates an example system 3500 in which embodiments may be implemented.

FIG. 36 illustrates an example system 3600 in which embodiments may be implemented.

FIG. 37 illustrates an example system 3700 in which embodiments may be implemented.

FIG. 38 illustrates an example system 3800 in which embodiments may be implemented.

FIG. 39 illustrates an example system 3900 in which embodiments may be implemented.

FIG. 40 illustrates an example system 4000 in which embodiments may be implemented.

FIG. 41 illustrates an example system 4100 in which embodiments may be implemented.

FIG. 42 illustrates an example system 4200 in which embodiments may be implemented.

FIG. 43 illustrates an example system 4300 in which embodiments may be implemented.

FIG. 44 illustrates an example system 4400 in which embodiments may be implemented.

FIG. 45 illustrates an example operational flow 4500 in which embodiments may be implemented.

FIG. 46 illustrates an example operational flow 4600 in which embodiments may be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

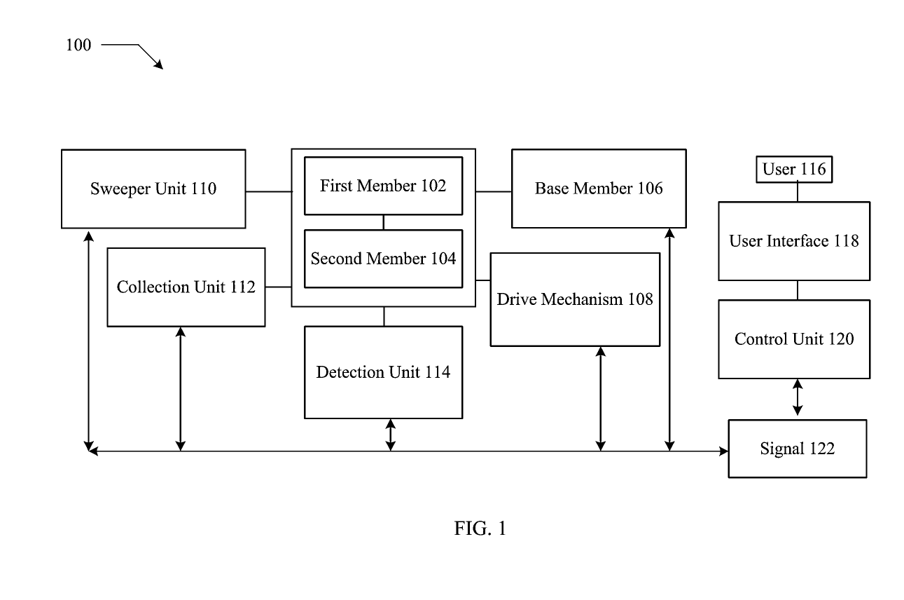

FIG. 1 illustrates an example system 100 in which embodiments may be implemented. The system 100 may include one or more first members 102. The system 100 may include one or more second members 104. The system 100 may include one or more drive mechanisms 108. The system 100 may include one or more base members 106. The system 100 may include one or more sweeper units 110. The system 100 may include one or more detection units 114. The system 100 may include one or more collection units 112. The system 100 may include one or more signals 122. The system 100 may include one or more control units 120. The system 100 may include one or more user interfaces 118.

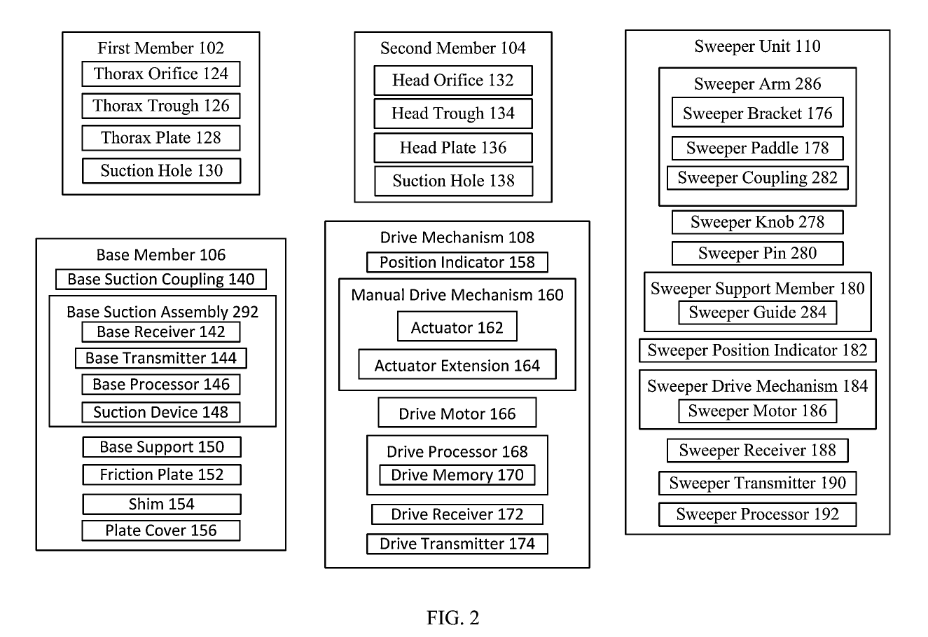

FIG. 2 illustrates example embodiments of components of system 100. The illustrated components include a first member 102, a second member 104, a base member 106, a drive mechanism 108, and a sweeper unit 110.

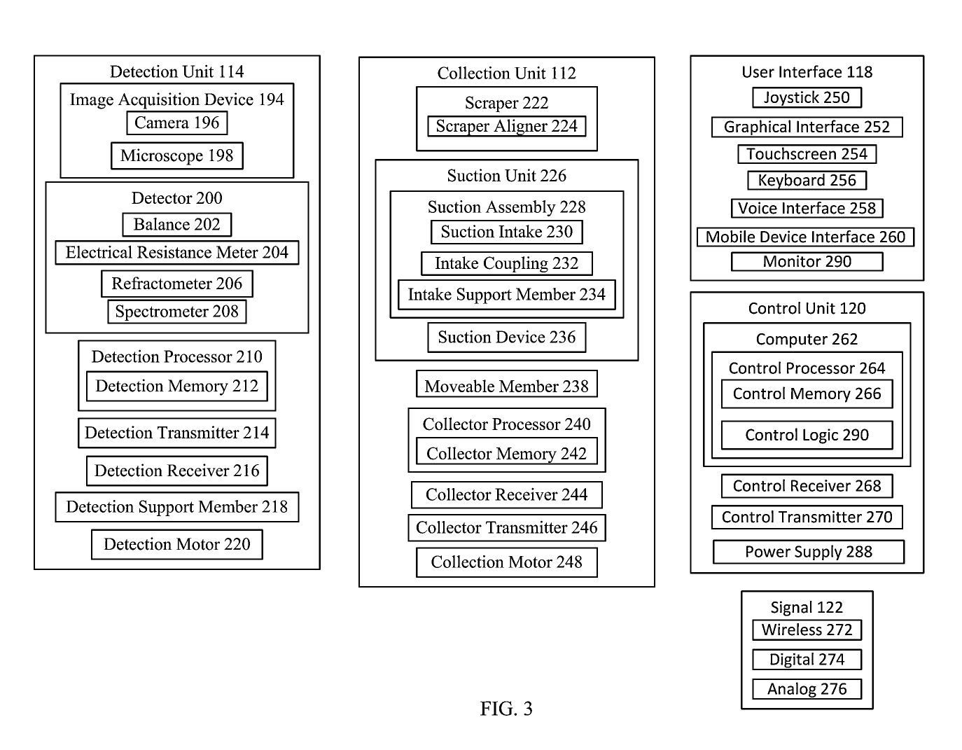

FIG. 3 illustrates example embodiments of components of system 100. The illustrated components include a detection unit 114, a collection unit 112, a user interface 118, a control unit 120, and a signal 122.

### First Member and Second Member

In some embodiments system 100, may include one or more first members 102. In some embodiments system 100, may include one first member 102. In some embodiments system 100, may include two or more first members 102. In some embodiments system 100, may include a plurality of first members 102. In some embodiments system 100, may include one or more first members 102 that each include one or more thorax orifices 124. In some embodiments system 100, may include one or more first members 102 that each include one thorax orifice 124. In some embodiments system 100, may include one or more first members 102 that each include two or more thorax orifices 124. In some embodiments system 100, may include one or more first members 102 that each include a plurality of thorax orifices 124. In some embodiments system 100, may include one or more first members 102 having one or more thorax orifices 124 through which a head portion of an insect can protrude and which restrains a thorax portion of the insect. For example, in some embodiments, a first member 102 may be configured such that an insect may be positioned relative to a first member 102 so that the thorax portion of the insect is held on one side of the first member 102 and at least a portion of the head of the insect passes through the thorax orifice 124 of the first member 102 and protrudes from the opposite side of the first member 102. In some embodiments, a portion of the head of the insect can pass through the thorax orifice 124 of the first member 102 and protrude from the opposite side of the first member 102. In some embodiments, the entire head of the insect can pass through the thorax orifice 124 of the first member 102 and protrude from the opposite side of the first member 102. In some embodiments, the entire head of the insect and a portion of the neck of the insect can pass through the thorax orifice 124 of the first member 102 and protrude from the opposite side of the first member 102. First members 102 may be configured in numerous ways. In some embodiments, a first member 102 may be configured as a thorax plate 128 that is substantially planar on the top and bottom sides of the plate. In some embodiments, a first member 102 may be configured as a sheet that is substantially planar on one side of the sheet and substantially non-planar on the opposite side of the sheet. For example, in some embodiments, the bottom side of the sheet may be substantially planar and the top side of the sheet may be contoured.

A thorax orifice 124 may be configured in numerous ways. For example, in some embodiments, a thorax orifice 124 may be configured as a substantially circular hole that passes through the first member 102. In some embodiments, a thorax orifice 124 may be configured as an oval-shaped hole that passes through the first member 102. In some embodiments, a thorax orifice 124 may be configured as a cone-shaped depression in the first member 102 that includes a hole that is located substantially at the apex of the cone that passes through the first member 102. In some embodiments, a thorax orifice 124 may be configured as a truncated cone in the first member 102. In some embodiments, a thorax orifice 124 may include a thorax trough 126 that is continuous with the thorax orifice 124 (see FIG. 25). For example, in some embodiments, a thorax orifice 124 may include a thorax trough 126 that provides a cavity that is continuous with the thorax orifice 124. Accordingly, in some embodiments, a thorax orifice 124 may be specifically configured for use with one or more identified insects. Examples of such insects include, but are not limited to, mosquitos, bees, wasps, hornets, beetles, ticks, fruit flies, crickets, and the like. In some embodiments, a first member 102 may be configured so that the first member 102 may be modified for use with different types of insects. For example, in some embodiments, a first member 102 may be configured to accept varying types of inserts that define different thorax orifices 124. For example, in some embodiments, a first member 102 may be configured as a substantially planar sheet that includes one or more threaded holes into which an insert that defines a thorax orifice 124 for a specific type of insect may be inserted. Such inserts may include numerous types of attachment means. Examples of such attachment means include, but are not limited to, friction fittings, snap fittings, screw fittings, and the like.

In some embodiments, a first member 102 may include one or more suction holes 130 that pass through the first member 102. Suction holes 130 may be configured in numerous ways. For example, in some embodiments, a suction hole 130 may be configured so that the cross-sectional diameter of the suction hole 130 is smaller than the cross-sectional diameter of the head of an insect.

A first member 102 may be constructed from numerous types of material. Examples of such materials include, but are not limited to, metal, plastic, ceramics, fiberboard, paper, glass, fiberglass, and the like. In some embodiments, a first member 102 may be constructed from a combination of materials.

A first member 102 may be constructed through use of many fabrication methods. For example, in some embodiments, a first member 102 may be machined. In some embodiments, a first member 102 may be constructed through use of a three-dimensional printer. In some embodiments, a first member 102 may be cast. In some embodiments, a first member 102 may be stamped. In some embodiments, a first member 102 may be fabricated through use of a laser. In some embodiments, a first member 102 may be fabricated through use of a water jet.

A thorax orifice 124 may be created through the use of numerous types of fabrication methods. Examples, of such methods include, but are not limited to, drilling, pressing, stamping, laser cutting, water jet cutting, machining, and the like.

A first member 102 may be configured in numerous ways. For example, in some embodiments, a first member 102 may be configured as a square plate. In some embodiments, a first member 102 may be configured as a rectangular plate. In some embodiments, a first member 102 may be configured as a curved plate. First members may be constructed that have a wide variety of thicknesses. For example, in some embodiments, a first member may be configured as a plate having a thickness that is between about 1.0 inch and about 0.01 inch. In some embodiments, a first member may be configured as a plate having a thickness that is between about 0.5 inch and about 0.05 inch. In some embodiments, a first member may be configured as a plate having a thickness that is between about 0.1 inch and about 0.05 inch. In some embodiments, a first member may be configured as a plate having a thickness that is between about 0.07 inch and about 0.06 inch. In some embodiments, a first member may be configured as a plate having a thickness that is about 0.062 inch.

In some embodiments system 100, may include one or more second members 104. In some embodiments system 100, may include one second member 104. In some embodiments system 100, may include two or more second members 104. In some embodiments system 100, may include a plurality of second members 104. In some embodiments system 100, may include one or more second members 104 that each include one or more head orifices 132. In some embodiments system 100, may include one or more second members 104 that each include one head orifice 132. In some embodiments system 100, may include one or more second members 104 that each include two or more head orifices 132. In some embodiments system 100, may include one or more second members 104 that each include a plurality of head orifices 132. In some embodiments system 100, may include one or more second members 104 having one or more head orifices 132 that are configured to accept a portion of the head of an insect. In some embodiments system 100, may include one or more second members 104 having one or more head orifices 132 that are configured to accept the head of an insect. In some embodiments system 100, may include one or more second members 104 having one or more head orifices 132 that are configured to accept the head of an insect and a portion of the neck of the insect. Second members 104 may be configured in numerous ways. In some embodiments, a second member 104 may be configured as a head plate 136 that is substantially planar on the top and bottom sides of the plate. In some embodiments, a second member 104 may be configured as a sheet that is substantially planar on one side of the sheet and substantially non-planar on the opposite side of the sheet. For example, in some embodiments, the top side of the sheet may be substantially planar and the bottom side of the sheet may be contoured.

A head orifice 132 may be configured in numerous ways. For example, in some embodiments, a head orifice 132 may be configured as a substantially circular hole that passes through the second member 104. In some embodiments, a head orifice 132 may be configured as an oval-shaped hole that passes through the second member 104. In some embodiments, a head orifice 132 may be configured as a rectangular-shaped hole that passes through the second member 104. In some embodiments, a head orifice 132 may be configured as a depression in the second member 104. In some embodiments, a head orifice 132 may include a head trough 134 that is continuous with the head orifice 132 (see FIG. 26). For example, in some embodiments, a head orifice 132 may include a head trough 134 that provides a cavity that is continuous with the head orifice 132. Accordingly, in some embodiments, a head orifice 132 may be specifically configured for use with one or more identified insects. Examples of such insects include, but are not limited to, mosquitos, bees, wasps, hornets, beetles, ticks, fruit flies, crickets, and the like. In some embodiments, a second member 104 may be configured so that the second member 104 may be modified for use with different types of insects. For example, in some embodiments, a second member 104 may be configured to accept varying types of inserts that define different head orifices 132. For example, in some embodiments, a second member 104 may be configured as a substantially planar plate that includes one or more threaded holes into which an insert that defines a head orifice 132 for a specific type of insect may be inserted. Such inserts may include numerous types of attachment means. Examples of such attachment means include, but are not limited to, friction fittings, snap fittings, screw fittings, and the like.

In some embodiments, a second member 104 may include one or more suction holes 138 that pass through the second member 102. Suction holes 138 may be configured in numerous ways. For example, in some embodiments, a suction hole 138 may be configured so that the cross-sectional diameter of the suction hole 138 is smaller than the cross-sectional diameter of the head of an insect.

A second member 104 may be constructed from numerous types of material. Examples of such materials include, but are not limited to, metal, plastic, ceramics, fiberboard, paper, glass, fiberglass, and the like. In some embodiments, a second member 104 may be constructed from a combination of materials.

A second member 104 may be constructed through use of many fabrication methods. For example, in some embodiments, a second member 104 may be machined. In some embodiments, a second member 104 may be constructed through use of a three-dimensional printer. In some embodiments, a second member 104 may be cast. In some embodiments, a second member 104 may be stamped. In some embodiments, a first member 102 may be fabricated through use of a laser. In some embodiments, a first member 102 may be fabricated through use of a water jet. A head orifice 132 may be created through the use of numerous types of fabrication methods. Examples, of such methods include, but are not limited to, drilling, pressing, stamping, laser cutting, water jet cutting, machining, and the like.

A second member 104 may be configured in numerous ways. For example, in some embodiments, a second member 104 may be configured as a square plate. In some embodiments, a second member 104 may be configured as a rectangular plate. In some embodiments, a second member 104 may be configured as a curved plate. Second members may be constructed that have a wide variety of thicknesses. For example, in some embodiments, a second member may be configured as a plate having a thickness that is between about 1.0 inch and about 0.01 inch. In some embodiments, a second member may be configured as a plate having a thickness that is between about 0.5 inch and about 0.01 inch. In some embodiments, a second member may be configured as a plate having a thickness that is between about 0.5 inch and about 0.1 inch. In some embodiments, a second member may be configured as a plate having a thickness that is between about 0.3 inch and about 0.1 inch. In some embodiments, a second member may be configured as a plate having a thickness that is about 0.2 inch.

In some embodiments system 100, may include a first member 102 that is operably coupled to a second member 104. Numerous figures herein show a first member 102 and a second member 104 with a space between them for illustration purposes. However, in some embodiments, a first member 102 and a second member 104 are in direct physical contact with each other. In some embodiments system 100, may include a first member 102 that is slideably coupled to a second member 104. A first member 102 may be operably coupled to a second member 104 in numerous ways. For example, in some embodiments, a first member 102 may be operably coupled to a second member 104 through use of a dovetail coupling. In some embodiments, a first member 102 may be operably coupled to a second member 104 through use of a tongue and groove coupling. In some embodiments, a first member 102 may be operably coupled to a second member 104 through use of a friction plate 152, a shim 154, a plate cover 156, or combinations thereof. In some embodiments, a first member 102 and a second member 104 may be operably coupled so that an insect may be positioned relative to the first member 102 and the second member 104 so that the thorax portion of the insect is held on one side of the first member 102 with at least a portion of the head of the insect passing through the thorax orifice 124 of the first member 102 and protruding from the opposite side of the first member 102 into the head orifice 132 of the second member 104. In some embodiments, the first member 102 and the second member 104 are operably coupled so that substantially lateral movement of either of the first member 102 or the second member 104 relative to each other will substantially immobilize the head and thorax portion of an insect that is introduced into the first member 102 and the second member 104. In some embodiments, such immobilization of the insect allows the thorax portion of the insect to be swept from (or removed from, or at least partially removed from) the immobilized head portion of the insect to extract one or more insect salivary glands from the thorax portion of the insect. Accordingly, in some embodiments, the first member 102 and the second member 104 may be used to extract salivary glands from an insect.

### Drive Mechanism

In some embodiments system 100, may include one or more drive mechanisms 108. In some embodiments, a drive mechanism 108 may be configured to move either or both of a first member 102 or a second member 104 relative to each other. In some embodiments, a drive mechanism 108 may be configured to move either or both of a first member 102 or a second member 104 lateral to each other. In some embodiments, a drive mechanism 108 may be operably coupled to a first member 102. In some embodiments, a drive mechanism 108 may be operably coupled to a second member 104. In some embodiments, a drive mechanism 108 may be operably coupled to a first member 102 and to a second member 104. In some embodiments, a drive mechanism 108 may include a position indicator 158 that is configured to indicate the position of a first member 102 relative to a second member 104. In some embodiments, a drive mechanism 108 may include an actuator 162. In some embodiments, a drive mechanism 108 may include an actuator 162 that is operably coupled to an actuator extension 164. A drive mechanism 108 may be configured in numerous ways. For example, in some embodiments, a drive mechanism 108 may include a screw type mechanism whereby turning a threaded screw will cause movement of a first member 102 and/or second member 104 relative to each other. In some embodiments, a drive mechanism 108 may be a cog type mechanism whereby turning a toothed wheel will cause movement of a first member 102 or second member 104 relative to each other. In some embodiments, a drive mechanism 108 may be a chain-drive type mechanism whereby turning a gear that is coupled to a chain will cause movement of a first member 102 or second member 104 relative to each other. In some embodiments, a drive mechanism 108 may be a manual drive mechanism 160. For example, in some embodiments, a user 116 may manually turn a wheel that is attached to a screw type mechanism in order to move a first member 102 and/or a second member 104 relative to each other. In some embodiments, a drive mechanism 108 may include a drive motor 166. For example, in some embodiments, a drive motor 166 may be operably coupled to a threaded screw that is included within a drive mechanism 108 whereby turning the screw with the drive motor will cause movement of a first member 102 and/or second member 104 relative to each other. A drive mechanism 108 may include numerous types of drive motors 166. Examples of such drive motors 166 include, but are not limited to, electric motors, piezoelectric motors, stepper motors, and the like. In some embodiments, a drive mechanism 108 may include one or more drive processors 168. In some embodiments, a drive mechanism 108 may include one or more drive receivers 172. In some embodiments, a drive mechanism 108 may include one or more drive transmitters 174. Accordingly, in some embodiments, a drive mechanism 108 may be configured to receive one or more signals 122. In some embodiments, a drive mechanism 108 may be configured to process one or more signals 122. In some embodiments, a drive mechanism 108 may be configured to transmit one or more signals 122. For example, in some embodiments, a drive mechanism 108 may be configured to receive one or more signals 122 that direct the operation of a drive motor 166 that causes movement of a first member 102 relative to a second member 104. Accordingly, in some embodiments, the operation of a drive mechanism 108 may be controlled electronically. In some embodiments, a drive mechanism 108 may be configured to receive one or more signals 122 that are transmitted by a detection unit 114. For example, in some embodiments, a drive mechanism 108 may be configured to receive one or more signals 122 that are transmitted by an image acquisition device 194. In some embodiments, a drive mechanism 108 may be configured to receive one or more signals 122 that are transmitted by a detector 200. In some embodiments, a drive mechanism 108 may be configured to receive one or more signals 122 that are transmitted by a control unit 120. In some embodiments, a drive mechanism 108 may be configured to receive one or more signals 122 that are transmitted by a collection unit 112. In some embodiments, a drive mechanism 108 may be configured to receive one or more signals 122 that are transmitted by a sweeper unit 110. Accordingly, in some embodiments, a user 116 may utilize a user interface 118 to cause one or more signals 122 to be sent from one or more control units 120 that control the operation of one or more drive mechanisms 108.

In some embodiments, a drive mechanism 108 may be configured to operate in accordance with a feedback loop. For example, in some embodiments, a drive mechanism 108 may be configured to operate in coordination with an image acquisition device 194. In some embodiments, an image acquisition device 194 may be configured to acquire one or more images of an insect that may be introduced into a first member 102 and a second member 104 in a manner that provides for immobilization of the insect upon movement of the first member 102 relative to the second member 104. Accordingly, in some embodiments, an image acquisition device 194 may detect the position of the insect and transmit one or more signals 122 that direct a drive mechanism 108 to move a first member 102 and/or a second member 104 relative to each other in order to immobilize the insect. In some embodiments, a drive mechanism 108 may receive the one or more signals 122 that cause the drive mechanism 108 to move the first member 102 and/or second member 104 relative to each other and then transmit one or more signals 122 indicating completion of the operation. The image acquisition device 194 may receive the one or more signals 122 and then detect whether the insect has been immobilized. Accordingly, such a feedback loop may be repeated until an insect is immobilized. In some embodiments, a user 116 may control one or more drive mechanisms 108 in response to one or more images obtained by an image acquisition device 194. For example, in some embodiments, an image acquisition device 194 may obtain one or more images of an insect that may be introduced into a first member 102 and a second member 104. The images may be sent to a user interface 118 that allows a user 116 to observe whether an insect has been immobilized in the first member 102 and the second member 104 and then cause one or more signals 122 to be sent from one or more control units 120 that control movement of one or more drive mechanisms 108. Accordingly, in some embodiments, a user 116 may electronically control one or more drive mechanisms 108 to cause immobilization of an insect in a first member 102 and a second member 104.

In some embodiments, a feedback loop may be used to calibrate a drive mechanism 108. For example, in some embodiments, a drive mechanism 108 may include a stepper motor that advances the drive mechanism incrementally. Accordingly, in some embodiments, a feedback loop may be used to correlate the operation of a stepper motor with a change in position of a first member 102 relative to a second member 104.

In some embodiments, a system that includes a computer program for executing a computer process on a computing device may be used to control a drive mechanism 108. In some embodiments, such a system is provided that includes a fixed signal-bearing tangible medium (or non-transitory medium) bearing one or more instructions to control one or more drive mechanisms 108 that laterally move one or more first members 102 of a device relative to one or more second members 104 of the device; wherein the one or more first members 102 include one or more thorax orifices 124 through which a head portion of an insect can protrude and which restrains a thorax portion of the insect and the one or more second members 104 include one or more head orifices 132 that can accept the head portion of the insect. In some embodiments, the system may optionally include one or more instructions to control one or more sweeper drive mechanisms 184. In some embodiments, the system may optionally include one or more instructions to control one or more image acquisition devices 194. In some embodiments, the system may optionally include one or more instructions to control one or more detectors. In some embodiments, the system may optionally include one or more instructions to control one or more moveable members 238 that are operably coupled to one or more scrapers 222. In some embodiments, the system may optionally include one or more instructions to control one or more suction assemblies 228. The one or more instructions may be, for example, computer executable and/or logic-implemented instructions. In some embodiments, the fixed signal-bearing tangible medium may include a computer-readable medium. In some embodiments, the signal-bearing medium may include a recordable medium. In some embodiments, the signal-bearing medium may include a communications medium.

### Base Member

In some embodiments, system 100 may include one or more base members 106. In some embodiments, a base member 106 may be operably coupled to a first member 102. In some embodiments, a base member 106 may be operably coupled to a second member 104. In some embodiments, a base member 106 may be operably coupled to a first member 102 and to a second member 104. In some embodiments, a base member 106 may be operably coupled to a second member 104 that is operably coupled to a first member 102. In some embodiments, a base member 106 may be operably coupled to a base support 150. In some embodiments, a base member 106 may be operably coupled to a friction plate 152. In some embodiments, a base member 106 may be operably coupled to a shim 154. In some embodiments, a base member 106 may be operably coupled to a plate cover 156. In some embodiments, a base member 106 may be configured as a container having an open top that can be operably coupled to a first member 102 and to a second member 104. In some embodiments, a base member 106 may include one or more base suction couplings 140. Accordingly, in some embodiments, a base member 106 that is coupled to a first member 102 and to a second member 104 may be coupled to a suction device 148 that will create suction through a thorax orifice 124 in the first member 102 and a head orifice 132 in the second member 104. In some embodiments, a base suction assembly 292 may include one or more suction devices 148. Numerous types of suction devices 148 may be used in conjunction with a base member 106. Examples of such suction devices 148 include, but are not limited to, suction pumps, vacuum pumps, and the like. In some embodiments, a suction device 148 may be included within a base member 106 with the inlet positioned within the base member 106 and the discharge positioned to the outside of the base member 106. In some embodiments, a base member 106 may include one or more base suction assemblies 292. In some embodiments, a base suction assembly 292 may include one or more base receivers 142. In some embodiments, a base suction assembly 292 may include one or more base processors 146. In some embodiments, a base suction assembly 292 may include one or more base transmitters 144. Accordingly, in some embodiments, a base suction assembly 292 may receive one or more signals 122 that control the operation of a suction device 148. In some embodiments, such signals 122 may be transmitted by a control unit 120. In some embodiments, a base suction assembly 292 may transmit one or more signals 122. For example, in some embodiments, a base suction assembly 292 may transmit one or more signals 122 that indicate the status of the suction device 148. In some embodiments, such signals 122 may be received by a control unit 120. In some embodiments, a base member 106 may include one or more sensors that detect the amount of suction applied to the base member 106.

In some embodiments, a user 116 may control one or more suction devices 148 in response to one or more images obtained by an image acquisition device 194. For example, in some embodiments, an image acquisition device 194 may obtain one or more images of an insect that may be introduced into a first member 102 and a second member 104. The images may be sent to a user interface 118 that allows a user 116 to observe whether an insect has been immobilized in the first member 102 and the second member 104 and then cause one or more signals 122 to be sent from one or more control units 120 that control the operation of one or more suction devices 148 that draw an insect into the first member 102 and the second member 104. Accordingly, in some embodiments, a user 116 may electronically control one or more suction devices 148 to draw one or more insects into a first member 102 and a second member 104.

### Sweeper Unit

In some embodiments, system 100 may include one or more sweeper units 110. In some embodiments, a sweeper unit 110 may include one or more sweeper arms 286. In some embodiments, a sweeper arm 286 may include a sweeper paddle 178 that is operably coupled to a sweeper bracket 176. In some embodiments, a sweeper arm 286 may be operably coupled to a sweeper support member 180. In some embodiments, a sweeper arm 286 may be moveably coupled to a sweeper support member 180. For example, in some embodiments, a sweeper support member 180 may be configured to allow an operably coupled sweeper arm 286 to move within the sweeper support member 180. In some embodiments, a sweeper arm 286 may be operably coupled to a sweeper support member 180 that is operably coupled to a first member 102. In some embodiments, a sweeper arm 286 may be operably coupled to a first member 102 directly. For example, in some embodiments, a sweeper arm 286 may be slideably coupled to a first member 102 through a dovetail coupling. In some embodiments, a sweeper arm 286 is configured to be used to sweep the thorax portion from the head portion of an insect that is immobilized in a first member 102. In some embodiments, a sweeper arm 286 is configured to be used to sweep the thorax portion from the head portion of an insect that is immobilized in a first member 102 so that insect salivary glands may be extracted from the thorax portion of the insect. Accordingly, in some embodiments, a sweeper arm 286 may be moved across an operably coupled first member 102 such that the sweeper arm 286 sweeps the thorax of an insect that is immobilized in the first member 102.

In some embodiments system 100, may include one or more sweeper drive mechanisms 184. In some embodiments, a sweeper drive mechanism 184 may be operably coupled to a sweeper arm 286. In some embodiments, a sweeper drive mechanism 184 may be operably coupled to a sweeper arm 286 that is operably coupled to a sweeper support member 180. In some embodiments, a sweeper drive mechanism 184 may be operably coupled to a sweeper arm 286 that is operably coupled to a sweeper support member 180 that is operably coupled to a first member 102. In some embodiments, a sweeper drive mechanism 184 may be operably coupled to a second member 104. In some embodiments, a sweeper drive mechanism 184 may be operably coupled to a first member 102 and to a second member 104. In some embodiments, a sweeper drive mechanism 184 may include a sweeper position indicator 182 that is configured to indicate the position of a sweeper arm 286 relative to a first member 102.

A sweeper drive mechanism 184 may be configured in numerous ways. For example, in some embodiments, a sweeper drive mechanism 184 may be a screw type mechanism whereby turning a threaded screw will cause movement of a sweeper arm. In some embodiments, a sweeper drive mechanism 184 may be a screw type mechanism whereby turning a threaded screw will cause movement of a sweeper arm 286 relative to an operably coupled first member 102. In some embodiments, a sweeper drive mechanism 184 may be a cog type mechanism whereby turning a toothed wheel will cause movement of an operably coupled sweeper arm 286. In some embodiments, a sweeper drive mechanism 184 may be a chain-drive type mechanism whereby turning a gear that is coupled to a chain will cause movement of an operably coupled sweeper arm 286. In some embodiments, a sweeper drive mechanism 184 may be a manual drive mechanism 160. For example, in some embodiments, a user 116 may manually turn a wheel that is attached to a screw type mechanism in order to move an operably coupled sweeper arm 286.

In some embodiments, a sweeper drive mechanism 184 may include a sweeper motor 186. For example, in some embodiments, a sweeper motor 186 may be operably coupled to a threaded screw that is included within a sweeper drive mechanism 184 whereby turning the screw with the drive motor will cause movement of an operably coupled sweeper arm 286. A sweeper drive mechanism 184 may include numerous types of sweeper motors 186. Examples of such sweeper motors 186 include, but are not limited to, electric motors, piezoelectric motors, stepper motors, and the like.

In some embodiments, a sweeper drive mechanism 184 may include one or more sweeper processors 192. In some embodiments, a sweeper drive mechanism 184 may include one or more sweeper receivers 188. In some embodiments, a sweeper drive mechanism 184 may include one or more sweeper transmitters 190. Accordingly, in some embodiments, a sweeper drive mechanism 184 may be configured to receive one or more signals 122. In some embodiments, a sweeper drive mechanism 184 may be configured to process one or more signals 122. In some embodiments, a sweeper drive mechanism 184 may be configured to transmit one or more signals 122. For example, in some embodiments, a sweeper drive mechanism 184 may be configured to receive one or more signals 122 that direct the sweeper motor 186 to cause movement of an operably coupled sweeper arm 286. Accordingly, in some embodiments, the operation of a sweeper drive mechanism 184 may be controlled electronically. In some embodiments, a sweeper drive mechanism 184 may be configured to receive one or more signals 122 that are transmitted by a detection unit 114. For example, in some embodiments, a sweeper drive mechanism 184 may be configured to receive one or more signals 122 that are transmitted by an image acquisition device 194. In some embodiments, a sweeper drive mechanism 184 may be configured to receive one or more signals 122 that are transmitted by a detector 200. In some embodiments, a sweeper drive mechanism 184 may be configured to receive one or more signals 122 that are transmitted by a control unit 120. In some embodiments, a sweeper drive mechanism 184 may be configured to receive one or more signals 122 that are transmitted by a collection unit 112.

In some embodiments, a user 116 may control one or more sweeper drive mechanisms 184 electronically. For example, in some embodiments, a user 116 may control one or more sweeper motors 186 in response to one or more images obtained by an image acquisition device 194. For example, in some embodiments, an image acquisition device 194 may obtain one or more images of an insect that is immobilized in a first member 102 and a second member 104. The images may be sent to a user interface 118 that allows a user 116 to observe whether a thorax portion of the immobilized insect has been swept from the immobilized insect by a sweeper arm 286. Accordingly, in some embodiments, the user 116 may cause one or more signals 122 to be sent from one or more control units 120 that control the operation of one or more sweeper motors 186 that cause a sweeper arm 286 to sweep the thorax portion from an immobilized insect. Accordingly, in some embodiments, a user 116 may electronically control one or more sweeper arms 286 that sweep the thorax portion from an immobilized insect in order to extract a salivary gland from the immobilized insect.

In some embodiments, a sweeper drive mechanism 184 may be configured to operate in accordance with a feedback loop. In some embodiments, a sweeper drive mechanism 184 may be configured to operate in such a feedback loop to sweep the thorax portion from the head portion of an immobilized insect. For example, in some embodiments, an image acquisition device 194 may be configured to acquire one or more images of an insect that is immobilized in a first member 102 and a second member 104. The image acquisition device 194 may detect the position of the thorax of the insect and transmit one or more signals 122 that direct a sweeper drive mechanism 184 to move an operably coupled sweeper arm 286 in order to sweep the thorax portion of the insect away from the immobilized head portion of the insect. In some embodiments, a sweeper drive mechanism 184 may receive the one or more signals 122 that direct the sweeper drive mechanism 184 to move the operably coupled sweeper arm 286 and then transmit one or more signals 122 indicating completion of the operation. The image acquisition device 194 may receive the one or more signals 122 and then detect whether the thorax portion of the insect has been swept from the immobilized head portion of the insect. Accordingly, such a feedback loop may be repeated until the thorax portion of the insect has been swept from the immobilized head portion of the insect. In another example, in some embodiments, an image acquisition device 194 may be configured to acquire one or more images of an insect salivary gland that is extracted from the thorax region of an insect that is immobilized in a first member 102 and a second member 104. The image acquisition device 194 may detect a position of a salivary gland and transmit one or more signals 122 that direct a sweeper drive mechanism 184 to move an operably coupled sweeper arm 286 in order to sweep the thorax portion of the insect away from the immobilized head portion of the insect to allow the salivary gland to be extracted from the thorax portion of the immobilized insect. In some embodiments, a sweeper drive mechanism 184 may receive the one or more signals 122 that direct the sweeper drive mechanism 184 to move the operably coupled sweeper arm 286 and then transmit one or more signals 122 indicating completion of the operation. The image acquisition device 194 may receive the one or more signals 122 and then detect whether one or more salivary glands have been extracted from the thorax portion of the insect. Accordingly, such a feedback loop may be repeated until the salivary gland has been extracted from the thorax portion of the insect.

In some embodiments, a feedback loop may be used to calibrate a sweeper drive mechanism 184. For example, in some embodiments, a sweeper drive mechanism 184 may include a stepper motor that advances the sweeper drive mechanism 184 incrementally. Accordingly, in some embodiments, a feedback loop may be used to correlate the operation of a stepper motor with a change in position of an operably coupled sweeper arm 286.

### Detection Unit

In some embodiments, system 100 may include one or more detection units 114. Detection units 114 may be configured in numerous ways. For example, in some embodiments, a detection unit 114 may be configured to detect one or more insects. In some embodiments, a detection unit 114 may be configured to detect one or more insect parts. For example, in some embodiments, a detection unit 114 may be configured to detect a head portion of an insect. In some embodiments, a detection unit 114 may be configured to detect a thorax portion of an insect. In some embodiments, a detection unit 114 may be configured to detect a head portion and a thorax portion of an insect. In some embodiments, a detection unit 114 may be configured to detect an insect salivary gland. In some embodiments, a detection unit 114 may be configured to detect a salivary gland from numerous types of insects. Examples of such insects include, but are not limited to, mosquitos, bees, wasps, beetles, ticks, fruit flies, and the like. In some embodiments, a detection unit 114 may be configured to detect a sporozoite. In some embodiments, a detection unit 114 may be configured to detect a malaria sporozoite. Detection units 114 may be configured to utilize numerous methods for detection. For example, in some embodiments, a detection unit may detect a fluorescently tagged sporozoite. In some embodiments, a detection unit may detect a sporozoite that expresses green fluorescent protein.

In some embodiments, a detection unit 114 may use spectroscopy for detection. Accordingly, in some embodiments, a detection unit 114 may include one or more spectrometers 208. Examples of such spectrometers 208 include, but are not limited to, ultraviolet/visible light spectrometers 208, fluorescence spectrometers 208, circular dichroism spectrometers 208, and the like.

In some embodiments, a detection unit 114 may be configured to acquire an image through use of an image acquisition device 194. Accordingly, in some embodiments, a detection unit 114 may include one or more image acquisition devices 194. Numerous types of image acquisition devices 194 may be used within a detection unit 114. Examples of such image acquisition devices 194 include, but are not limited to, cameras 196, microscopes 198, charge coupled devices, and the like. Numerous image acquisition methods may be used by one or more image acquisition devices 194. Examples of such methods include, but are not limited to, bright field microscopy, confocal microscopy, dark field microscopy, digital microscopy, fluorescence interference contrast microscopy, fluorescence microscopy, multifocal plane microscopy, phase contrast microscopy, and the like. In some embodiments, two-dimensional imaging with a grayscale device may be used to produce a digitized image. In some embodiments, three-dimensional imaging may be used to produce a depth map. In some embodiments, structured light methods may be used for imaging. In some embodiments, shading methods may be used for imaging. In some embodiments, passive stereoscopic methods may be used for imaging. In some embodiments, active stereoscopic methods may be used for imaging. In some embodiments, an image acquisition device 194 may utilize a database that includes one or more images of an insect salivary gland. For example, in some embodiments, a database may include one or more images of a salivary gland from a specific type of insect. An image acquisition device 194 may then obtain one or more images from an insect that is immobilized in a first member 102 and a second member 104 and then compare the acquired images to one or more images in the database to determine the presence of a salivary gland from the immobilized insect. Such a protocol may be utilized with numerous types of insects. Examples of such insects include, but are not limited to, mosquitos, bees, wasps, hornets, fruit flies, beetles, ticks, and the like. In some embodiments, an image detection device 194 may detect an x-y grid that may be projected onto a first member 102 and determine the position of an insect salivary gland on the first member 102. In some embodiments, an image detection device 194 may detect one or more fiducial markers on a first member 102 and determine the position of an insect salivary gland on the first member 102.

In some embodiments, a detection unit 114 may include one or more detectors 200. Examples of such detectors 200 include, but are not limited to, balances 202, electrical resistance meters 204, refractometers 206, spectrometers 208, and the like. In some embodiments, a salivary gland may be placed into such a detector 200 to confirm the identity of the salivary gland.

In some embodiments, a detection unit 114 may include one or more detection support members 218. In some embodiments, an image acquisition device 194 may be operably coupled to a detection support member 218. In some embodiments, a detector 200 may be operably coupled to a detection support member 218. In some embodiments, a detection support member 218 may be operably coupled to a first member 102. In some embodiments, a detection support member 218 may be operably coupled to a second member 104. In some embodiments, a detection support member 218 may be operably coupled to a first member 102 and to a second member 104. In some embodiments, a detection support member 218 may be operably coupled to a base member 106. In some embodiments, a detection support member 218 may include one or more detection motors 220. In some embodiments, one or more detection motors 220 may be operably coupled to one or more detection drive mechanisms that are operably coupled to one or more detection support members 218. For example, in some embodiments, a detection motor 220 may be operably coupled to a cog that is operably coupled to a toothed rail that is operably coupled to a detection support member 218 and configured to cause motion of the detection support member 218. In some embodiments, a detection motor 220 may be operably coupled to a threaded member that is operably coupled to a threaded hole in a detection support member 218 so that rotation of the threaded member causes motion of the detection support member 218. Accordingly, in some embodiments, a detection support member 218 may be mobile. In some embodiments, a detection support member 218 that is mobile may be operably coupled to one or more detectors 200. In some embodiments, a detection support member 218 that is mobile may be operably coupled to one or more image acquisition devices 194.

In some embodiments, a mobile detection support member 218 that is operably coupled to an image acquisition device 194 may be configured to move the image acquisition device 194 to collect multiple images. For example, in some embodiments, a detection support member 218 that is operably coupled to an image acquisition device 194 may be configured to move the image acquisition device 194 to collect images along the length, width, or length and width of a first member 102. Accordingly, in some embodiments, such a configuration may be used to detect multiple insects and/or insect parts that are immobilized in a first member 102 and a second member 104. In some embodiments, such a configuration may be used to detect one or more salivary glands that have been extracted from one or more insects. In some embodiments, such a configuration may be used to detect one or more salivary glands that have been extracted from one or more mosquitos.

In some embodiments, a detection unit 114 may include one or more detection receivers 216. In some embodiments, a detection unit 114 may include one or more detection processors 210. In some embodiments, a detection unit 114 may include one or more detection transmitters 214. In some embodiments, a detection unit 114 may include one or more detection receivers 216. Accordingly, in some embodiments, a detection unit 114 may be configured to receive one or more signals 122. In some embodiments, a detection unit 114 may be configured to process one or more signals 122. In some embodiments, a detection unit 114 may be configured to transmit one or more signals 122.

In some embodiments, a detection unit 114 may be configured to receive one or more signals 122 that are transmitted by one or more control units 120. In some embodiments, a detection unit 114 may be configured to receive one or more signals 122 that are transmitted by one or more base members 106. In some embodiments, a detection unit 114 may be configured to receive one or more signals 122 that are transmitted by one or more drive mechanisms 108. In some embodiments, a detection unit 114 may be configured to receive one or more signals 122 that are transmitted by one or more collection units 112. In some embodiments, a detection unit 114 may be configured to receive one or more signals 122 that are transmitted by one or more sweeper units 110. In some embodiments, a detection unit 114 may be configured to receive one or more signals 122 that are transmitted by one or more control units 120 in response to user 116 input.

In some embodiments, a user 116 may control the position of a detection support member 218 electronically. For example, in some embodiments, a user 116 may control one or more detection motors 220 in response to one or more images obtained by an image acquisition device 194. For example, in some embodiments, an image acquisition device 194 may obtain one or more images. The one or more images may be sent to a user interface 118 that allows a user 116 to observe the one or more images. Accordingly, in some embodiments, the user 116 may cause one or more signals 122 to be sent from one or more control units 120 that control the operation of one or more detection motors 220 that cause a detection support member 218 to position an operably coupled image acquisition device 194 in a desired position.

In some embodiments, a detection unit 114 may be configured to transmit one or more signals 122 that are received by one or more control units 120. In some embodiments, a detection unit 114 may be configured to transmit one or more signals 122 that are received by one or more collection units 112. In some embodiments, a detection unit 114 may be configured to transmit one or more signals 122 that are received by one or more base members 106. In some embodiments, a detection unit 114 may be configured to transmit one or more signals 122 that are received by one or more sweeper units 110. In some embodiments, a detection unit 114 may be configured to transmit one or more signals 122 that are received by one or more user interfaces 118.

In some embodiments, a detection unit 114 may be configured to transmit one or more signals 122 that direct one or more suction devices 148 that are operably coupled to a base member. In some embodiments, a detection unit 114 may be configured to detect whether one or more insects are being introduced into one or more thorax orifices 124 in a first member 102. Accordingly, in some embodiments, a detection unit 114 may be configured to transmit one or more signals 122 that control the level of suction produced by one or more suction devices 148 that are operably coupled with one or more base members 106 associated with a first member 102 to effect introduction of an insect into a thorax orifice 124 of the first member 102. In some embodiments, the one or more signals 122 may be transmitted directly from the detection unit 114 to the base member 106. In some embodiments, the one or more signals 122 may be transmitted to a control unit 120 that receives the one or more signals 122 and transmits one or more signals 122 that are received by the base member 106.

In some embodiments, a detection unit 114 may be configured to transmit one or more signals 122 that direct one or more drive mechanisms 108. In some embodiments, a detection unit 114 may be configured to detect whether one or more insects are being immobilized in a first member 102 and a second member 102. Accordingly, in some embodiments, a detection unit 114 may be configured to transmit one or more signals 122 that direct one more drive motors 166 that are operably coupled to move a first member 102 and/or a second member 104 relative to each other. In some embodiments, the one or more signals 122 may be transmitted directly from the detection unit 114 to the drive mechanism 108. In some embodiments, the one or more signals 122 may be transmitted to a control unit 120 that receives the one or more signals 122 and transmits one or more signals 122 that are received by the drive mechanism 108.

In some embodiments, a detection unit 114 may be configured to transmit one or more signals 122 that direct one or more sweeper units 110. In some embodiments, a detection unit 114 may be configured to detect whether the thorax portion of an insect has been swept from the head region of the insect to extract a salivary gland from the thorax of the insect. Accordingly, in some embodiments, a detection unit 114 may be configured to transmit one or more signals 122 that direct one more sweeper drive mechanisms 184. In some embodiments, the one or more signals 122 may be transmitted directly from the detection unit 114 to the sweeper unit 110. In some embodiments, the one or more signals 122 may be transmitted to a control unit 120 that receives the one or more signals 122 and transmits one or more signals 122 that are received by the sweeper unit 110.

In some embodiments, a detection unit 114 may be configured to transmit one or more signals 122 that direct one or more collection units 112. In some embodiments, a detection unit 114 may be configured to detect the position of an insect salivary gland. Accordingly, in some embodiments, a detection unit 114 may be configured to transmit one or more signals 122 that direct a collection unit 112 that is configured to collect an insect salivary gland. For example, in some embodiments, a detection unit 114 may be configured to transmit one or more signals 122 that direct the collection unit 112 to the position of the insect salivary gland so that the collection unit 112 can collect the insect salivary gland. In some embodiments, the one or more signals 122 may be transmitted directly from the detection unit 114 to the collection unit. In some embodiments, the one or more signals 122 may be transmitted to a control unit 120 that receives the one or more signals 122 and transmits one or more signals 122 that are received by the collection unit 112.

In some embodiments, a system that includes a computer program for executing a computer process on a computing device may be used to control an image acquisition device 194 that is configured to detect one or more insect salivary glands. In some embodiments, such a system is provided that includes a fixed signal-bearing tangible medium (or non-transitory medium) bearing one or more instructions to control one or more image acquisition devices 194 that are configured to detect one or more insect salivary glands. The one or more instructions may be, for example, computer executable and/or logic-implemented instructions. In some embodiments, the fixed signal-bearing tangible medium may include a computer-readable medium. In some embodiments, the signal-bearing medium may include a recordable medium. In some embodiments, the signal-bearing medium may include a communications medium.

### Collection Unit

In some embodiments, system 100 may include one or more collection units 112. Collection units 112 may be configured in numerous ways. In some embodiments, a collection unit 112 may be configured to collect an insect salivary gland. In some embodiments, a collection unit 112 may be configured to collect an insect salivary gland through the use of suction. In some embodiments, a collection unit 112 may be configured to collect an insect salivary gland with a scraper 222. In some embodiments, a collection unit 112 may be configured to utilize a fluid stream to collect an insect salivary gland.

In some embodiments, a collection unit 112 may be configured to position a suction intake 230 next to an insect salivary gland so that the insect salivary gland may be collected into the suction intake 230. Accordingly, in some embodiments, a collection unit 112 may include a suction intake 230 that is operably coupled to a suction device 148 through an intake coupling 232. In some embodiments, a collection unit 112 may include a suction intake 230 that is operably coupled to an intake support member 234. In some embodiments, a collection unit 112 may include a suction intake 230 that is operably coupled to an intake support member 234 that includes a collection motor 248. Accordingly, in some embodiments, an intake support member 234 may be mobile.

In some embodiments, an intake support member 234 may be operably coupled to a moveable member 238. In some embodiments, a moveable member 238 that is operably coupled to a suction intake 230 may be configured to move the suction intake 230 to collect multiple insect salivary glands. For example, in some embodiments, a moveable member 238 that is operably coupled to a suction intake 230 may be configured to move the suction intake 230 to collect insect salivary glands along the length, width, or length and width of a first member 102. In some embodiments, such a configuration may be used to collect one or more salivary glands that have been extracted from one or more mosquitos.

In some embodiments, a collection unit 112 may be configured to position a scraper 222 next to an insect salivary gland so that the scraper 222 may collect the insect salivary gland. Accordingly, in some embodiments, a collection unit 112 may include a scraper 222 that is operably coupled to a scraper aligner 224. In some embodiments, a collection unit 112 may include a scraper 222 that is operably coupled to a scraper aligner 224 that includes a collection motor 248. Accordingly, in some embodiments, a scraper 222 may be mobile.

In some embodiments, a scraper 222 may be operably coupled to a moveable member 238. In some embodiments, a moveable member 238 that is operably coupled to a scraper 222 may be configured to move the scraper 222 to collect multiple insect salivary glands. For example, in some embodiments, a moveable member 238 that is operably coupled to a scraper 222 may be configured to move the scraper 222 to collect insect salivary glands along the length, width, or length and width of a first member 102. In some embodiments, such a configuration may be used to collect one or more salivary glands that have been extracted from one or more mosquitos.

In some embodiments, a collection unit may be configured to apply fluid to a salivary gland. For example, in some embodiments, a collection unit may include one or more fluid nozzels that are operably coupled to one or more fluid containing reservoirs and one or more pumps such that fluid may be expelled from the one or more fluid nozzels. Accordingly, in some embodiments, a collection unit may be configured to apply fluid to an insect salivary gland. In some embodiments, a collection unit may be configured to wash an insect salivary gland with fluid. In some embodiments, application of a fluid to an insect salivary gland may be coupled with other collection methods. For example, in some embodiments, a collection unit may be used to apply fluid to an insect salivary gland that then collect the insect salivary gland by scraping the insect salivary gland. In some embodiments, a collection unit may be used to apply fluid to an insect salivary gland that then collect the insect salivary gland by applying suction to the insect salivary gland.

In some embodiments, a collection unit 112 may include one or more moveable members 238 that may include one or more collection motors 248. In some embodiments, one or more collection motors 248 may be operably coupled to one or more collection drive mechanisms that are operably coupled to one or more moveable members 238. For example, in some embodiments, a collection motor 248 may be operably coupled to a cog that is operably coupled to a toothed rail that is operably coupled to a moveable member 238 and configured to cause motion of the moveable member 238. In some embodiments, a collection motor 248 may be operably coupled to a threaded member that is operably coupled to a threaded hole in a moveable member 238 so that rotation of the threaded member causes motion of the moveable member 238. Accordingly, in some embodiments, a moveable member 238 may be mobile.

In some embodiments, a collection unit 112 may include one or more collector receivers 244. In some embodiments, a collection unit 112 may include one or more collector processors 240. In some embodiments, a collection unit 112 may include collector memory 242. In some embodiments, a collection unit 112 may include one or more collector receivers 244. In some embodiments, a collection unit 112 may include one or more collector transmitters 246. Accordingly, in some embodiments, a collection unit 112 may be configured to receive one or more signals 122. In some embodiments, a collection unit 112 may be configured to process one or more signals 122. In some embodiments, a collection unit 112 may be configured to transmit one or more signals 122.

In some embodiments, a collection unit 112 may receive one or more signals 122 that are transmitted by one or more control units 120. In some embodiments, a collection unit 112 may receive one or more signals 122 that are transmitted by one or more detection units 114. In some embodiments, a collection unit 112 may receive one or more signals 122 that are transmitted by one or more base members 106. In some embodiments, a collection unit 112 may receive one or more signals 122 that are transmitted by one or more sweeper units 110.

In some embodiments, a collection unit 112 may transmit one or more signals 122 that are received by one or more control units 120. In some embodiments, a collection unit 112 may transmit one or more signals 122 that are received by one or more detection units 114. In some embodiments, a collection unit 112 may transmit one or more signals 122 that are received by one or more base members 106. In some embodiments, a collection unit 112 may transmit one or more signals 122 that are received by one or more sweeper units 110.

In some embodiments, a collection unit 112 may receive one or more signals 122 that are transmitted by one or more detection units 114 that direct the collection unit 112 to collect one or more salivary glands. For example, in some embodiments, one or more signals 122 may be received that direct a moveable member 238 that is coupled to a suction assembly 228 to position a suction intake 230 of the suction assembly 228 next to an insect salivary gland so that the insect salivary gland may be collected. In some embodiments, one or more signals 122 may be received that direct a moveable member 238 that is coupled to a scraper 222 to position the scraper 222 next to an insect salivary gland so that the insect salivary gland may be collected.

In some embodiments, a collection unit 112 may receive one or more signals 122 that are transmitted by one or more control units 120 that direct the collection unit 112 to collect one or more salivary glands. For example, in some embodiments, one or more signals 122 may be received that direct a moveable member 238 that is coupled to a suction assembly 228 to position a suction intake 230 of the suction assembly 228 next to an insect salivary gland so that the insect salivary gland may be collected. In some embodiments, one or more signals 122 may be received that direct a moveable member 238 that is coupled to a scraper 222 to position the scraper 222 next to an insect salivary gland so that the insect salivary gland may be collected. Accordingly, in some embodiments, a user 116 may control one or more collection units 112 through use of a user interface 118 that is operably coupled to a control unit 120.

In some embodiments, a user 116 may control the position of a moveable member 238 electronically. In some embodiments, a user 116 may control one or more collection motors 248 in response to one or more images obtained by an image acquisition device 194. For example, in some embodiments, an image acquisition device 194 may obtain one or more images. The one or more images may be sent to a user interface 118 that allows a user 116 to observe the one or more images. Accordingly, in some embodiments, the user 116 may cause one or more signals 122 to be sent from one or more control units 120 that control the operation of one or more collection motors 248 that cause a collection unit 112 to position an operably coupled suction intake 230 next to an insect salivary gland so that the insect salivary gland may be collected. In some embodiments, the user 116 may cause one or more signals 122 to be sent from one or more control units 120 that control the operation of one or more collection motors 248 that cause a collection unit 112 to position an operably coupled scraper 222 next to an insect salivary gland so that the insect salivary gland may be collected.

In some embodiments, a system that includes a computer program for executing a computer process on a computing device may be used to control one or more movable members 238 that are operably coupled to one or more scrapers 222 in response to receiving one or more signals 122 from one or more image acquisition devices 194 that are configured to detect one or more insect salivary glands. In some embodiments, such a system is provided that includes a fixed signal-bearing tangible medium bearing one or more instructions to control one or more movable members 238 that are operably coupled to one or more scrapers 222 in response to receiving one or more signals 122 from one or more image acquisition devices 194 that are configured to detect one or more insect salivary glands. The one or more instructions may be, for example, computer executable and/or logic-implemented instructions. In some embodiments, the fixed signal-bearing tangible medium may include a computer-readable medium. In some embodiments, the signal-bearing medium may include a recordable medium. In some embodiments, the signal-bearing medium may include a communications medium.

In some embodiments, a system that includes a computer program for executing a computer process on a computing device may be used to control one or more suction units 226 in response to receiving one or more signals 122 from one or more image acquisition devices 194 that are configured to detect one or more insect salivary glands. In some embodiments, such a system is provided that includes a fixed signal-bearing tangible medium bearing one or more instructions to control one or more suction units 226 in response to receiving one or more signals 122 from one or more image acquisition devices 194 that are configured to detect one or more insect salivary glands. The one or more instructions may be, for example, computer executable and/or logic-implemented instructions. In some embodiments, the fixed signal-bearing tangible medium may include a computer-readable medium. In some embodiments, the signal-bearing medium may include a recordable medium. In some embodiments, the signal-bearing medium may include a communications medium.

### Signal

In some embodiments, system 100 may utilize numerous types of signals 122. Numerous types of signals 122 may be used within system 100. Examples of such signals 122 include, but are not limited to, wireless signals 272, analog signals 276, digital signals 274, encrypted signals 122, Bluetooth signals 122, and the like. Accordingly, system 100 may include receivers, transmitters, and processors that are configured to receive, transmit, and process numerous types of signals 122.

### Control Unit

In some embodiments, system 100 may include one or more control units 120. In some embodiments, a control unit 120 may include one or more computers 262. In some embodiments, a control unit 120 may include one or more control receivers 268. In some embodiments, a control unit 120 may include one or more control transmitters 270. In some embodiments, a control unit 120 may include one or more control processors 264. In some embodiments, a control unit 120 may include control memory 266. In some embodiments, a control unit 120 may include control logic 290. In some embodiments, a control unit 120 may include one or more power supplies 28. In some embodiments, a control unit 120 may be operably coupled to one or more user interfaces 118.

In some embodiments, a control unit 120 may receive one or more signals 122 from one or more user interfaces 118. In some embodiments, a control unit 120 may receive one or more signals 122 from one or more drive mechanisms 108. In some embodiments, a control unit 120 may receive one or more signals 122 from one or more base members 106. In some embodiments, a control unit 120 may receive one or more signals 122 from one or more detection units 114. In some embodiments, a control unit 120 may receive one or more signals 122 from one or more collection units 112. In some embodiments, a control unit 120 may receive one or more signals 122 from one or more sweeper units 110.

In some embodiments, a control unit 120 may transmit one or more signals 122 that are received by one or more user interfaces 118. In some embodiments, a control unit 120 may transmit one or more signals 122 that are received by one or more drive mechanisms 108. In some embodiments, a control unit 120 may transmit one or more signals 122 that are received by one or more base members 106. In some embodiments, a control unit 120 may transmit one or more signals 122 that are received by one or more detection units 114. In some embodiments, a control unit 120 may transmit one or more signals 122 that are received by one or more collection units 112. In some embodiments, a control unit 120 may transmit one or more signals 122 that are received by one or more sweeper units 110.

In some embodiments, a control unit 120 may transmit one or more signals 122 that direct one or more base members 106. For example, in some embodiments, a control unit 120 may transmit one or more signals 122 that direct a suction device 148 to increase or decrease the amount of suction produced by the suction device 148. In some embodiments, a control unit 120 may receive one or more signals 122 that are transmitted by a base member 106 that indicate the level at which a suction device 148 is operating. In some embodiments, a control unit 120 may transmit one or more signals 122 that direct a suction device 148 to increase or decrease the amount of suction produced by the suction device 148 in response to user 116 input.

In some embodiments, a control unit 120 may transmit one or more signals 122 that control one or more drive mechanisms 108. For example, in some embodiments, a control unit 120 may transmit one or more signals 122 that direct a drive motor 166 to move one or more first members 102 and/or one or more second members 104 relative to each other. In some embodiments, a control unit 120 may receive one or more signals 122 that are transmitted by a drive mechanism 108 that indicate the level at which a drive motor 166 is operating. In some embodiments, a control unit 120 may transmit one or more signals 122 that direct a drive motor 166 in response to user 116 input.

In some embodiments, a control unit 120 may transmit one or more signals 122 that control one or more detection units 114. For example, in some embodiments, a control unit 120 may transmit one or more signals 122 that direct one or more image acquisition devices 194 to obtain one or more images. In some embodiments, a control unit 120 may transmit one or more signals 122 that control the position of one or more detection support members 218. Accordingly, in some embodiments, a control unit 120 may transmit one or more signals 122 that direct a detection support member 218 to position an operably coupled image acquisition device 194 to collect images at one or more selected positions. In some embodiments, a control unit 120 may transmit one or more signals 122 that direct the operation of a detection unit 114 in response to user 116 input. In some embodiments, a control unit 120 may transmit one or more signals 122 that control one or more detector 200s. For example, in some embodiments, a control unit 120 may transmit one or more signals 122 that control one or more spectrometers 208.

In some embodiments, a control unit 120 may transmit one or more signals 122 that control one or more collection units 112. For example, in some embodiments, a control unit 120 may transmit one or more signals 122 that direct a collection unit 112 to collect one or more insect salivary glands. For example, in some embodiments, a control unit 120 may transmit one or more signals 122 that direct a moveable member 238 to position a suction intake 230 to collect one or more insect salivary glands. In some embodiments, a control unit 120 may transmit one or more signals 122 that direct a moveable member 238 to position a scraper 222 to collect one or more insect salivary glands. Accordingly, in some embodiments, a control unit 120 may receive one or more signals 122 from a detection unit 114 that indicate the position of one or more insect salivary glands and then transmit one or more signals 122 that direct one or more collection units 112 in response to the position of the one or more salivary glands.

In some embodiments, a control unit 120 may transmit one or more signals 122 that control one or more sweeper units 110. In some embodiments, a control unit 120 may transmit one or more signals 122 that direct a sweeper drive mechanism 184 to move on operably coupled sweeper arm 286. Accordingly, in some embodiments, a control unit 120 may receive one or more signals 122 from a detection unit 114 that indicates the position of a thorax portion of an insect and then transmit one or more signals 122 that direct one or more sweeper units 110 to sweep the thorax portion of the insect.

In some embodiments, a control unit 120 may process an image that includes an x-y grid that may be projected onto a first member 102 and determine the position of an insect salivary gland on the first member 102. In some embodiments, a control unit 120 may process an image that includes one or more fiducial markers on a first member 102 and determine the position of an insect salivary gland on the first member 102. Accordingly, a control unit 120 may be configured in numerous ways to detect the position of an insect salivary gland.

### User Interface

In some embodiments, system 100 may include one or more user interfaces 118. System 100 may include numerous types of user interfaces 118. Examples of user interfaces 118 include, but are not limited to, graphical interfaces 252, monitors 290, touchscreens 254, keyboards 256, joysticks 250, voice interfaces 258, interfaces with mobile devices 260, and the like. Accordingly, in some embodiments, a user 116 may interact with system 100 wirelessly. In some embodiments, a user interface 118 may include control logic which may be configured to control aspects of system 100.

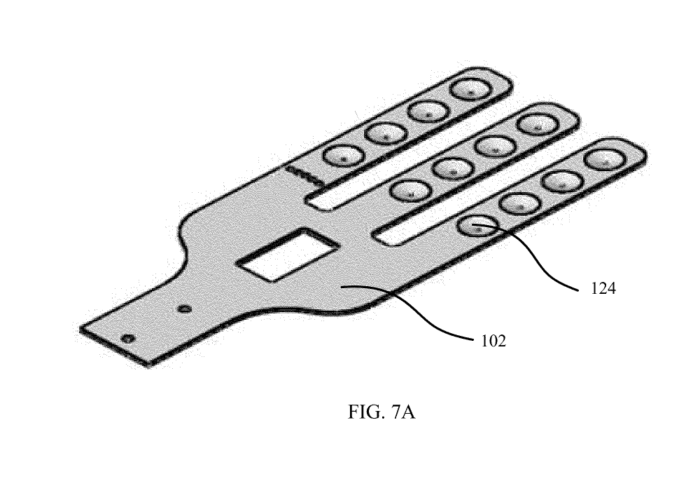

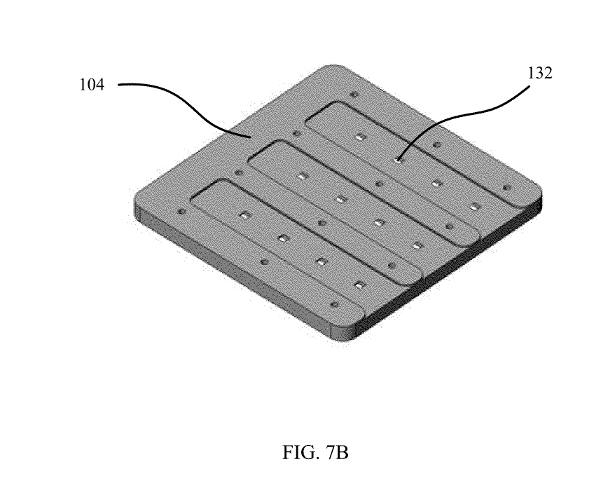

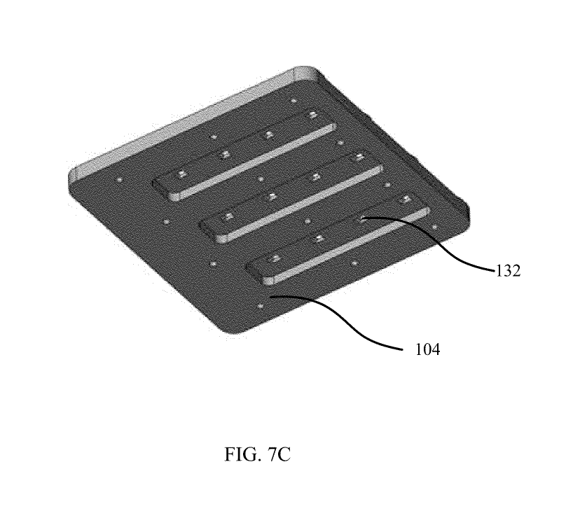

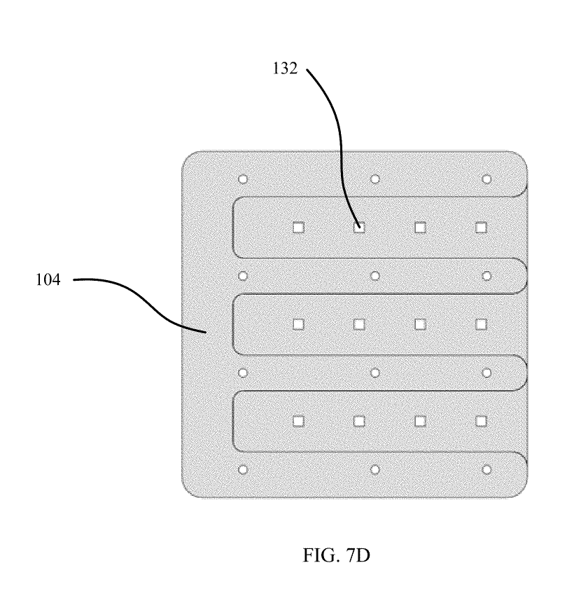

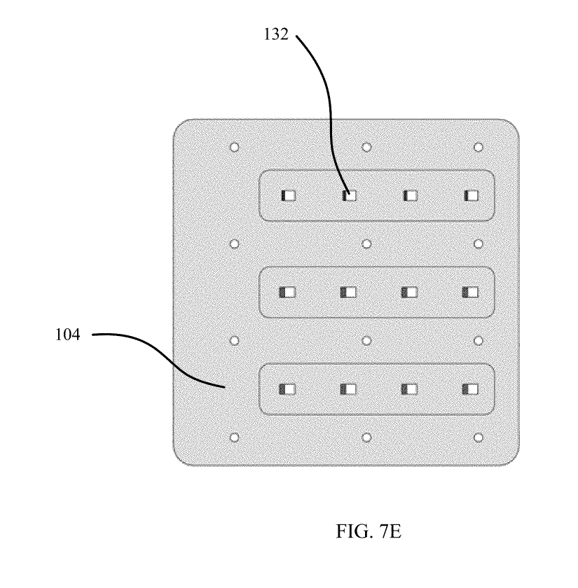

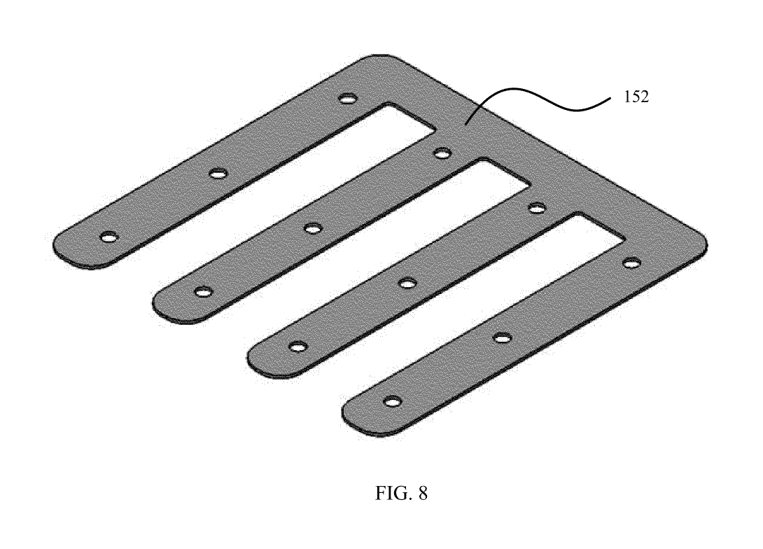

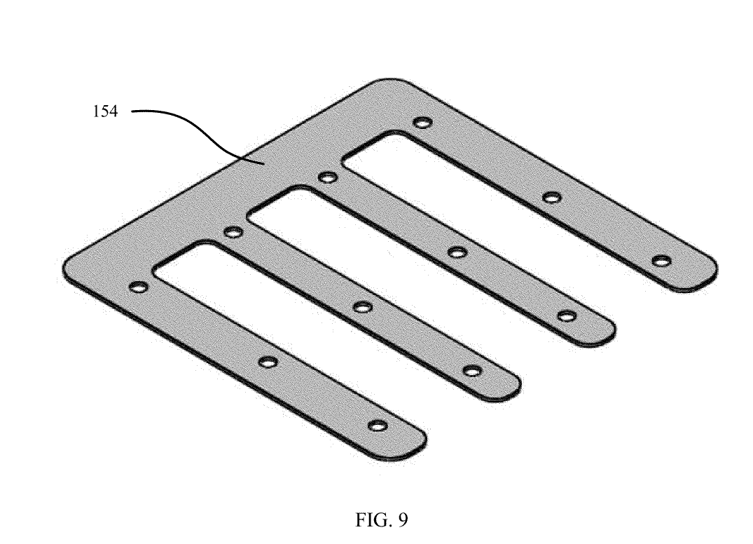

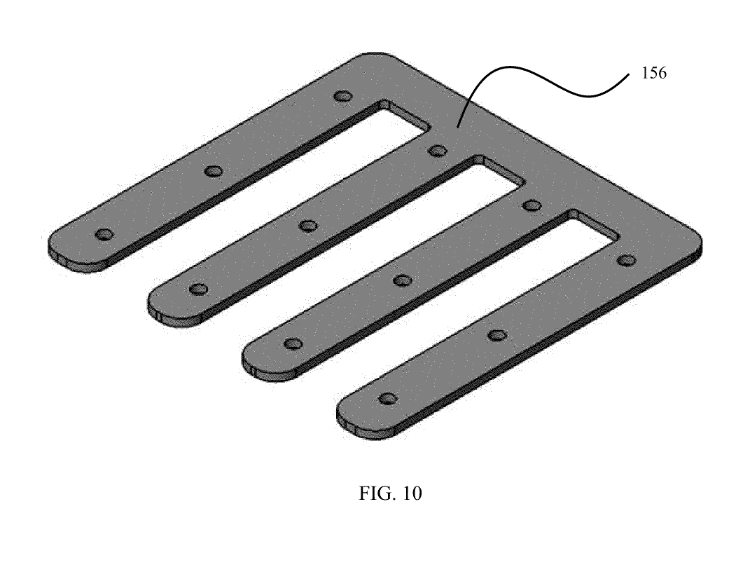

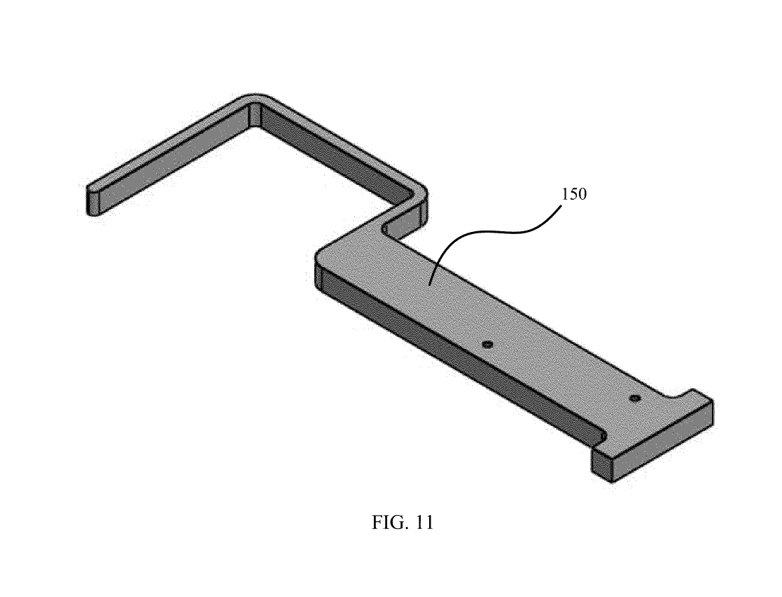

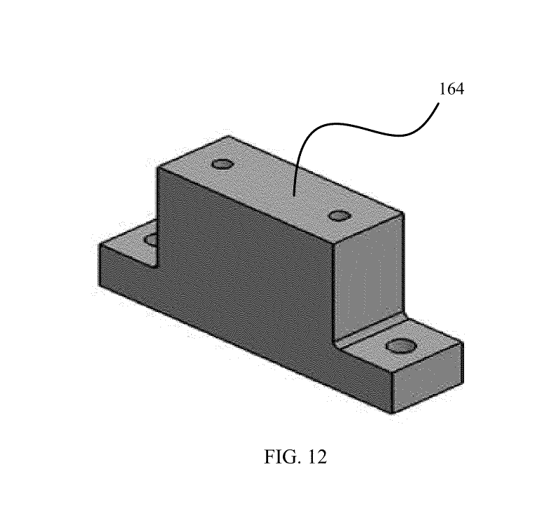

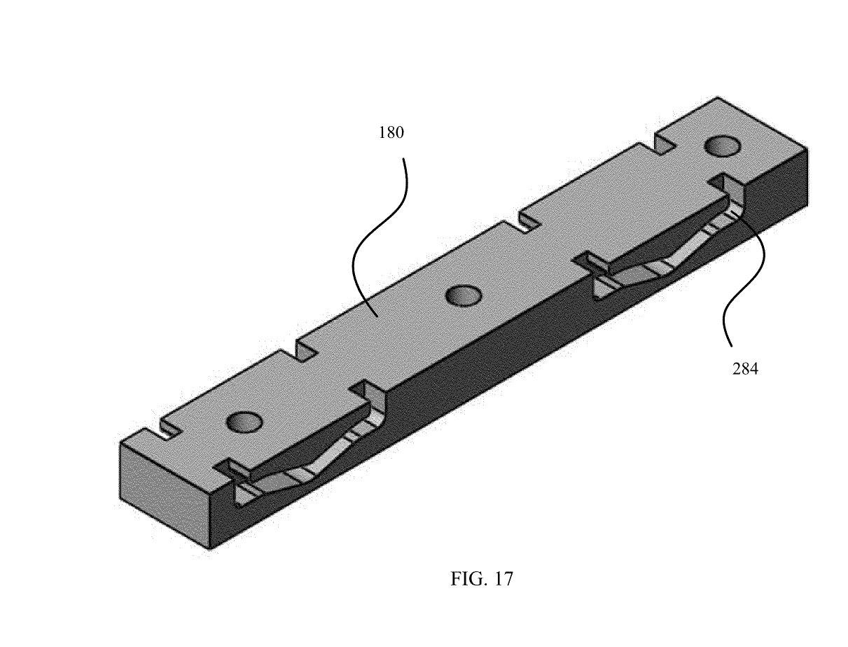

FIG. 4 illustrates an example device 400 in which embodiments may be implemented. Device 400 includes a first member 102 (see also FIG. 7). The first member 102 includes a plurality of thorax orifices 124. The first member 102 is operably coupled to a second member 104. The second member 104 may be operably coupled to a shim 154 (see also FIG. 9). The shim 154 may be operably coupled to a base member 106. The base member 106 may be operably coupled to a base support 150 (see also FIG. 11). The base support 150 may be operably coupled to a manual drive mechanism 160. The manual drive mechanism 160 includes an actuator 162 that is operably coupled to an actuator extension 164 (see also FIG. 12). The actuator extension 164 may be operably coupled to the first member 102. Accordingly, activation of the manual drive mechanism 160 will cause movement of the first member 102. Device 400 may include a friction plate 152 (see also FIG. 8). The friction plate 152 may be operably coupled to the second member 104 and may be in slideable contact with the first member 102. Device 400 may include a plate cover 156 (see also FIG. 10). Plate cover 156 may be operably coupled to device 400 on the top of friction plate 152. Accordingly, the order of the plate cover 156, the friction plate 152, the second member 104, and the base member may be from the top of device 400 to the bottom of device 400 respectively. The first member 102 may be configured to laterally move relative to the second member 104 while being slideably restricted by the friction plate 152. Device 400 is illustrated with two operably coupled sweeper support members 180 (see also FIG. 17). The sweeper support members 180 may each be operably coupled to the top of the plate cover 156. Each of the sweeper support members 180 may include two sweeper guides 284 that are cut into the side of each of the sweeper support members 180 (see also FIG. 17). Device 400 may include a sweeper arm 286 (see also FIG. 13). The sweeper arm 286 may be include a sweeper bracket 176 that is operably coupled to sweeper paddles 178 with sweeper couplings 282 (see also FIG. 13). The sweeper arm 286 may include sweeper pins 280 that are operably coupled into the sides of the sweeper arm 286. Device 400 is illustrated with a sweeper arm 286 that is operably coupled to two sweeper support members 180 through insertion of the sweeper pins 280 (shown in FIG. 13) that are coupled to the sides of the sweeper arm 286 into the sweeper guides 284 that are cut into the sides of the sweeper support members 180 (see also FIGS. 13 and 17). Device 400 is illustrated with a sweeper knob 278 that is operably coupled to a sweeper bracket 176 (see also FIG. 13). The sweeper knob 278 is configured to allow a user 116 to grasp the sweeper knob 278 and move the sweeper arm 286 that is guided by the sweeper support members 180.

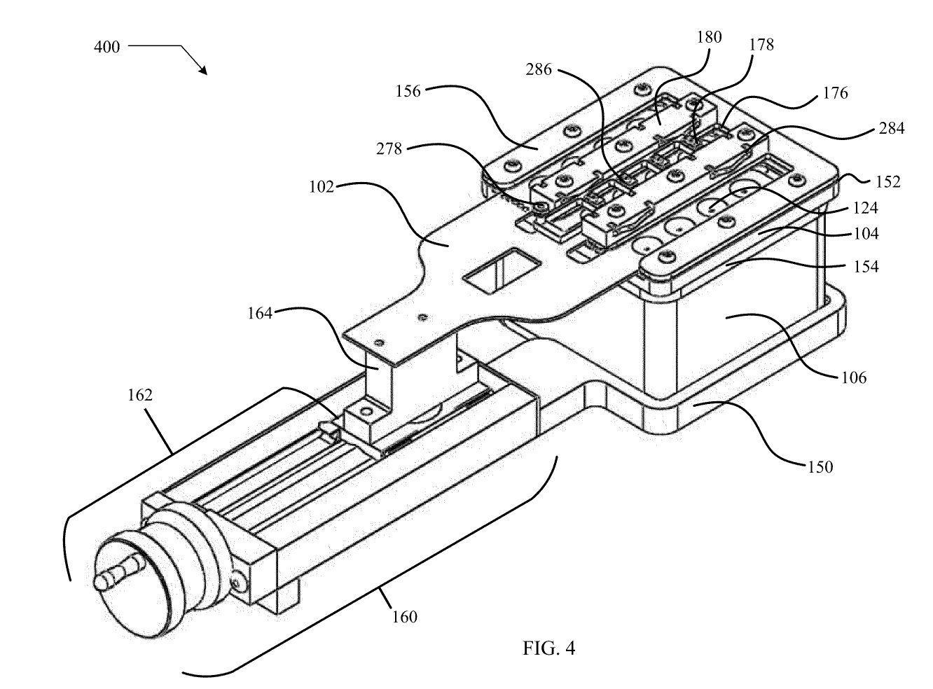

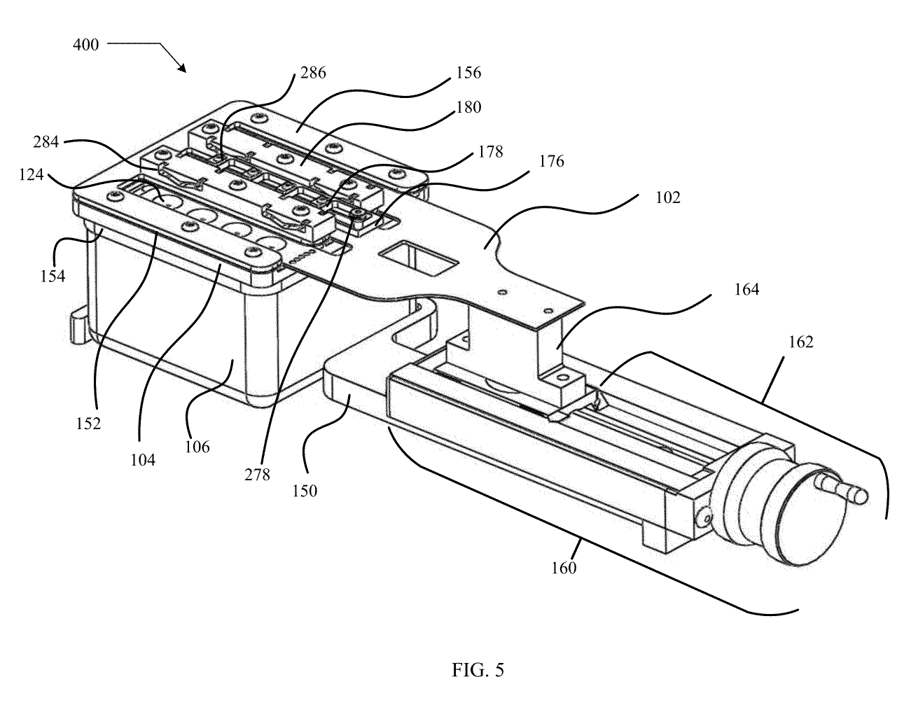

FIG. 5 illustrates another view of example device 400 in which embodiments may be implemented. Device 400 includes a first member 102 (see also FIG. 7). The first member 102 includes a plurality of thorax orifices 124. The first member 102 is operably coupled to a second member 104. The second member 104 may be operably coupled to a shim 154 (see also FIG. 9). The shim 154 may be operably coupled to a base member 106. The base member 106 may be operably coupled to a base support 150 (see also FIG. 11). The base support 150 may be operably coupled to a manual drive mechanism 160. The manual drive mechanism 160 includes an actuator 162 that may be operably coupled to an actuator extension 164 (see also FIG. 12). The actuator extension 164 may be operably coupled to the first member 102. Accordingly, activation of the manual drive mechanism 160 will cause movement of the first member 102. Device 400 may include a friction plate 152 (see also FIG. 8). The friction plate 152 may be operably coupled to the second member 104 in slideable contact with the first member 102. Device 400 may include a plate cover 156 (see also FIG. 10). Plate cover 156 may be operably coupled to device 400 on the top of friction plate 152. Accordingly, the order of the plate cover 156, the friction plate 152, the second member 104, and the base member may be from the top of device 400 to the bottom of device 400 respectively. The first member 102 may be configured to laterally move relative to the second member 104 while being slideably restricted by the friction plate 152. Device 400 is illustrated with two operably coupled sweeper support members 180 (see also FIG. 17). The sweeper support members 180 may each be operably coupled to the top of the plate cover 156. Each of the sweeper support members 180 may include two sweeper guides 284 that are cut into the side of each of the sweeper support members 180 (see also FIG. 17). Device 400 may include a sweeper arm 286 (see also FIG. 13). The sweeper arm 286 may include a sweeper bracket 176 that is operably coupled to sweeper paddles 178 with sweeper couplings 282 (see also FIG. 13). The sweeper arm 286 may include sweeper pins 280 that are operably coupled into the sides of the sweeper arm 286. Device 400 is illustrated with a sweeper arm 286 that is operably coupled to two sweeper support members 180 through insertion of the sweeper pins 280 that are coupled to the sides of the sweeper arm 286 into the sweeper guides 284 that are cut into the sides of the sweeper support members 180 (see also FIGS. 13 and 17). Device 400 is illustrated with a sweeper knob 278 that is operably coupled to a sweeper bracket 176 (see also FIG. 13). The sweeper knob 278 is configured to allow a user 116 to grasp the sweeper knob 278 and move the sweeper arm 286 that is guided by the sweeper support members 180.

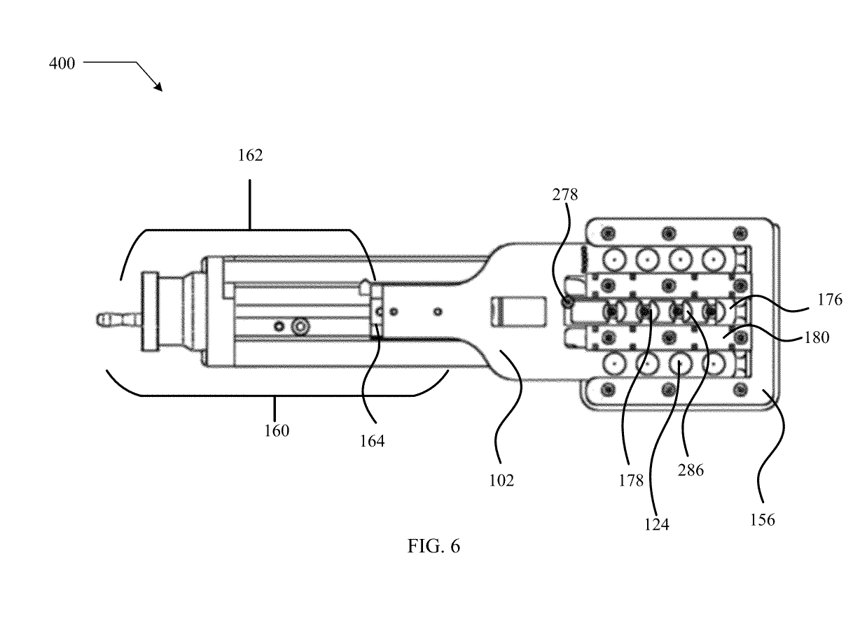

FIG. 6 illustrates a top view of example device 400 in which embodiments may be implemented. Device 400 includes a first member 102 (see also FIG. 7). The first member 102 includes a plurality of thorax orifices 124. The first member 102 may be operably coupled to an actuator extension 164 that may be operably coupled to an actuator 162 that is part of a manual drive mechanism 160. Device 400 is illustrated with two operably coupled sweeper support members 180 (see also FIG. 17). The sweeper support members 180 may each be operably coupled to the top of the plate cover 156. Device 400 may include a sweeper arm 286 (see also FIG. 13). The sweeper arm 286 may include a sweeper bracket 176 that is operably coupled to sweeper paddles 178 (see also FIG. 13). Device 400 is illustrated with a sweeper arm 286 that is operably coupled to two sweeper support members 180 (see also FIGS. 13 and 17). Device 400 is illustrated with a sweeper knob 278 that is operably coupled to a sweeper bracket 176 (see also FIG. 13). The sweeper knob 278 is configured to allow a user 116 to grasp the sweeper knob 278 and move the sweeper arm 286 that is guided by the sweeper support members 180.

FIG. 7A illustrates an embodiment of a first member 102 that includes a plurality of thorax orifices 124. The first member 102 illustrated in FIG. 7A includes three protrusions that each include thorax orifices 124. However, a first member 102 may be configured in numerous ways. For example, in some embodiments, a first member 102 may be configured as a square plate. In some embodiments, a first member 102 may be configured as a rectangular plate. In some embodiments, a first member 102 may be configured as a curved plate. The first member 102 illustrated in FIG. 7A includes holes that may be used as attachment points to couple the first member 102 to other components of a device.

A first member 102 may be constructed through use of many fabrication methods. For example, in some embodiments, a first member 102 may be machined. In some embodiments, a first member 102 may be constructed through use of a three-dimensional printer. In some embodiments, a first member 102 may be cast. In some embodiments, a first member 102 may be stamped. In some embodiments, a first member 102 may be fabricated through use of a laser. In some embodiments, a first member 102 may be fabricated with a water jet.

A first member 102 may be constructed from numerous types of material. Examples of such material include, but are not limited to, metal, glass, plastic, composite materials, fiberglass, asbestos, and the like. In some embodiments, a first member 102 may be constructed from combinations of materials.

FIG. 7B illustrates an isometric top view of an embodiment of a second member 104 that includes a plurality of head orifices 132. The second member 104 illustrated in FIG. 7B includes three recessed portions that are configured to accept the three protrusions of the first member 102 as shown in FIG. 7A. However, a second member 104 may be configured in numerous ways. For example, in some embodiments, a second member 104 may be configured as a flat plate. In some embodiments, a second member 104 may be configured as a square plate. In some embodiments, a second member 104 may be configured as a rectangular plate. In some embodiments, a second member 104 may be configured as a curved plate. The second member 104 illustrated in FIG. 7B includes holes that may be used as attachment points to couple the second member 104 to other components of a device.

A second member 104 may be constructed through use of many fabrication methods. For example, in some embodiments, a second member 104 may be machined. In some embodiments, a second member 104 may be constructed through use of a three-dimensional printer. In some embodiments, a second member 104 may be cast. In some embodiments, a second member 104 may be stamped. In some embodiments, a second member 104 may be fabricated through use of a laser. In some embodiments, a second member 104 may be fabricated with a water jet.

A second member 104 may be constructed from numerous types of material. Examples of such material include, but are not limited to, metal, glass, plastic, composite materials, fiberglass, asbestos, and the like. In some embodiments, a second member 104 may be constructed from combinations of materials.

FIG. 7C illustrates an isometric bottom view of an embodiment of a second member 104 that includes a plurality of head orifices 132. The second member 104 illustrated in FIG. 7C includes three recessed portions. However, a second member 104 may be configured in numerous ways. For example, in some embodiments, a second member 104 may be configured as a flat plate. In some embodiments, a second member 104 may be configured as a square plate. In some embodiments, a second member 104 may be configured as a rectangular plate. In some embodiments, a second member 104 may be configured as a curved plate. The second member 104 illustrated in FIG. 7C includes holes that may be used as attachment points to couple the second member 104 to other components of a device.

FIG. 7D illustrates a top view of an embodiment of a second member 104 that includes a plurality of head orifices 132. The second member 104 illustrated in FIG. 7D includes three recessed portions that are configured to accept the three protrusions of the first member 102 as shown in FIG. 7A. However, a second member 104 may be configured in numerous ways. For example, in some embodiments, a second member 104 may be configured as a flat plate. In some embodiments, a second member 104 may be configured as a square plate. In some embodiments, a second member 104 may be configured as a rectangular plate. In some embodiments, a second member 104 may be configured as a curved plate. The second member 104 illustrated in FIG. 7D includes holes that may be used as attachment points to couple the second member 104 to other components of a device.

FIG. 7E illustrates a bottom view of an embodiment of a second member 104 that includes a plurality of head orifices 132. The second member 104 illustrated in FIG. 7E includes three recessed portions. However, a second member 104 may be configured in numerous ways. For example, in some embodiments, a second member 104 may be configured as a flat plate. In some embodiments, a second member 104 may be configured as a square plate. In some embodiments, a second member 104 may be configured as a rectangular plate. In some embodiments, a second member 104 may be configured as a curved plate. The second member 104 illustrated in FIG. 7E includes holes that may be used as attachment points to couple the second member 104 to other components of a device.

FIG. 8 illustrates an embodiment of a friction plate 152. The friction plate 152 illustrated in FIG. 8 includes four protrusions that create three spaces that are configured to accept the three protrusions of the first member 102 illustrated in FIGS. 4-7. However, a friction plate 152 may be constructed in numerous configurations. For example, in some embodiments, a friction plate 152 may be curved and configured to wrap around an edge of a first member 102, a second member 104, or a first member 102 and a second member 104. The friction plate 152 illustrated in FIG. 7 includes holes that may be used as attachment points to couple the friction plate 152 to other components of a device.

A friction plate 152 may be constructed through use of many fabrication methods. For example, in some embodiments, a friction plate 152 may be machined. In some embodiments, a friction plate 152 may be constructed through use of a three-dimensional printer. In some embodiments, a friction plate 152 may be cast. In some embodiments, a friction plate 152 may be stamped. In some embodiments, a friction plate 152 may be fabricated through use of a laser. In some embodiments, a friction plate 152 may be fabricated with a water jet.

A friction plate 152 may be constructed from numerous types of material. Examples of such material include, but are not limited to, metal, glass, plastic, composite materials, fiberglass, asbestos, and the like. In some embodiments, a friction plate 152 may be constructed from combinations of materials.

FIG. 9 illustrates an embodiment of a shim 154. The shim 154 illustrated in FIG. 9 includes four protrusions that create three spaces that are configured to accept the three protrusions of the first member 102 illustrated in FIGS. 4-7. However, a shim 154 may be constructed in numerous configurations. For example, in some embodiments, a shim 154 may be constructed that has a U-shape that will accept a first member 102. The shim 154 illustrated in FIG. 9 includes holes that may be used as attachment points to couple the shim 154 to other components of a device.

A shim 154 may be constructed through use of many fabrication methods. For example, in some embodiments, a shim 154 may be machined. In some embodiments, a shim 154 may be constructed through use of a three-dimensional printer. In some embodiments, a shim 154 may be cast. In some embodiments, a shim 154 may be stamped. In some embodiments, a shim 154 may be fabricated through use of a laser. In some embodiments, a shim 154 may be fabricated with a water jet.

A shim 154 may be constructed from numerous types of material. Examples of such material include, but are not limited to, metal, glass, plastic, composite materials, fiberglass, and the like. In some embodiments, a shim 154 may be constructed from combinations of materials. In some embodiments, a shim 154 may be constructed from a compressible material. Accordingly, in some embodiments, a shim 154 may be constructed so that it can be compressed to a desired thickness.

FIG. 10 illustrates an embodiment of a plate cover 156. The plate cover 156 illustrated in FIG. 10 includes four protrusions that create three spaces that are configured to accept the three protrusions of the first member 102 illustrated in FIGS. 4-7. However, a plate cover 156 may be constructed in numerous configurations. For example, in some embodiments, a plate cover 156 may be constructed that has a rectangular shape with cross-members to which sweeper support members 180 may be coupled. The plate cover 156 illustrated in FIG. 10 includes holes that may be used as attachment points to couple the plate cove 156 to other components of a device.

In some embodiments, a plate cover 156 may be operably coupled to numerous other components. Examples of such components include, but are not limited to, a movable member 238 that is part of a collection unit 112, a detection support member 218 that is part of a detection unit 114, a detector 200, an image acquisition device 194, and the like. Accordingly, in some embodiments, a plate cover 156 may be configured to operably couple numerous components to a device.

A plate cover 156 may be constructed through use of many fabrication methods. For example, in some embodiments, a plate cover 156 may be machined. In some embodiments, a plate cover 156 may be constructed through use of a three-dimensional printer. In some embodiments, a plate cover 156 may be cast. In some embodiments, a plate cover 156 may be stamped. In some embodiments, a plate cover 156 may be fabricated through use of a laser. In some embodiments, a plate cover 156 may be fabricated with a water jet.

A plate cover 156 may be constructed from numerous types of material. Examples of such material include, but are not limited to, metal, glass, plastic, composite materials, fiberglass, and the like. In some embodiments, a plate cover 156 may be constructed from combinations of materials.

FIG. 11 illustrates an embodiment of a base support 150. The base support 150 illustrated in FIG. 11 has a hook-shape. In alternate embodiments, however, a base support 150 may be constructed in numerous configurations. For example, in some embodiments, a base support 150 may be constructed that has a rectangular shape that will accept a base member 106. The base support 150 illustrated in FIG. 11 includes holes that may be used as attachment points to couple the base support 150 to other components of a device.

In FIGS. 4, 5 and 6, exemplary device 400 was illustrated with base support 150 operably coupled to a base member 106 and to a manual drive mechanism 160. In some embodiments, a base support 150 may be operably coupled to numerous other components. Examples of such components include, but are not limited to, a movable member 238 that is part of a collection unit 112, a detection support member 218 that is part of a detection unit 114, a detector 200, an image acquisition device 194, and the like. Accordingly, in some embodiments, a base support 150 may be configured to operably couple numerous components to a device.

A base support 150 may be constructed through use of many fabrication methods. For example, in some embodiments, a base support 150 may be machined. In some embodiments, a base support 150 may be constructed through use of a three-dimensional printer. In some embodiments, a base support 150 may be cast. In some embodiments, a base support 150 may be fabricated through use of a laser. In some embodiments, a base support 150 may be fabricated with a water jet.

A base support 150 may be constructed from numerous types of material. Examples of such material include, but are not limited to, metal, glass, plastic, composite materials, fiberglass, and the like. In some embodiments, a base support 150 may be constructed from combinations of materials.

FIG. 12 illustrates an embodiment of an actuator extension 164. In FIGS. 4, 5 and 6, exemplary device 400 was illustrated with actuator extension 164 operably coupled to a first member 102 and to a manual drive mechanism 160. Accordingly, in some embodiments, an actuator extension 164 may be used to couple a drive mechanism 108 to another component of a device when it is desirable to move the component. For example, in some embodiments, an actuator extension 164 may be used to couple a drive mechanism to a moveable member 238. An actuator extension 164 may be constructed in numerous configurations. The actuator extension 164 illustrated in FIG. 12 includes holes that may be used as attachment points to couple the base actuator extension 164 to other components of a device.

An actuator extension 164 may be constructed through use of many fabrication methods. For example, in some embodiments, an actuator extension 164 may be machined. In some embodiments, an actuator extension 164 may be constructed through use of a three-dimensional printer. In some embodiments, an actuator extension 164 may be cast. In some embodiments, an actuator extension 164 may be fabricated through use of a laser. In some embodiments, an actuator extension 164 may be fabricated with a water jet.

An actuator extension 164 may be constructed from numerous types of material. Examples of such material include, but are not limited to, metal, glass, plastic, composite materials, fiberglass, and the like. In some embodiments, an actuator extension 164 may be constructed from combinations of materials.

FIG. 13 illustrates an embodiment of a sweeper arm 286 that includes a sweeper bracket 176 and a plurality of sweeper paddles 178. Also illustrated are a plurality of sweeper couplings 282, a plurality of sweeper pins 280, and a sweeper knob 278 that can be operably coupled to the sweeper arm 286.

In some embodiments, a sweeper arm 286 may be assembled from components. For example, in some embodiments, a sweeper arm 286 may be assembled from a sweeper bracket 176 to which sweeper paddles 178 are operably coupled. Sweeper pins 280 may operatively couple the sweeper arm 286 with one or more sweeper guides 284 in one or more sweeper support members 180 (e.g. FIG. 4). In some embodiments, a sweeper arm 286 may be constructed from a continuous piece of material. For example, in some embodiments, a sweeper arm 286 may be machined from a single billet of metal. In some embodiments, a sweeper arm 286 may be constructed through use of a three-dimensional printer. In some embodiments, a sweeper arm 286 may be cast. In some embodiments, a sweeper arm 286 may be fabricated through use of a laser. In some embodiments, a sweeper arm 286 may be fabricated with a water jet. Accordingly, a sweeper arm 286 may be fabricated through use of many methods.

A sweeper arm 286 may be constructed from numerous types of material. Examples of such material include, but are not limited to, metal, glass, plastic, composite materials, fiberglass, and the like. In some embodiments, a sweeper arm 286 may be constructed from combinations of materials.

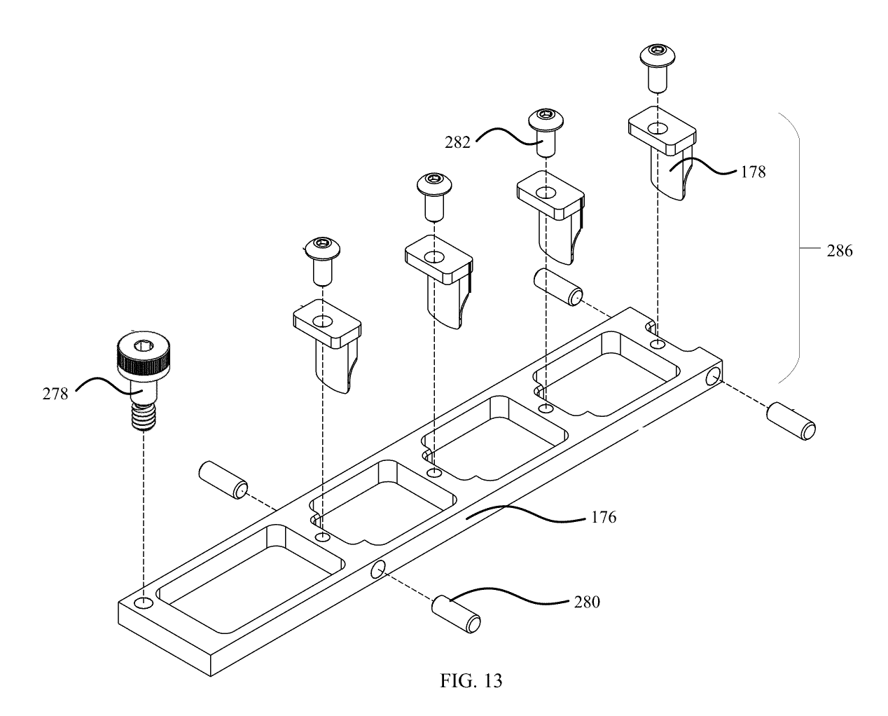

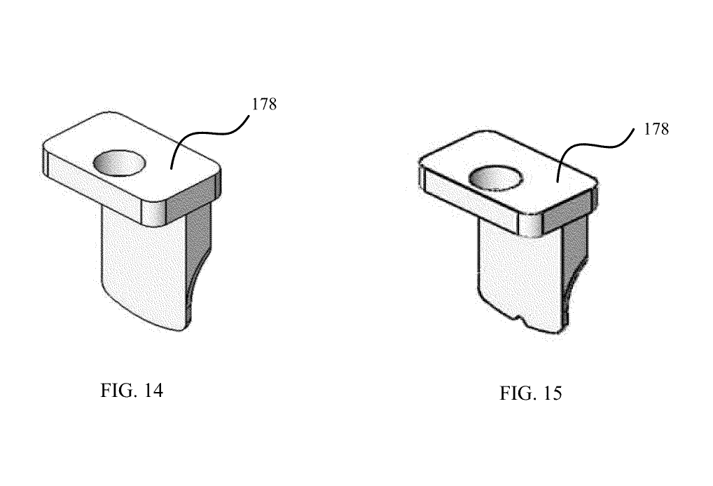

FIGS. 14 and 15 each illustrate a different embodiment of a sweeper paddle 178. In FIG. 14, a sweeper paddle 178 with a continuous edge is illustrated. In FIG. 15, a sweeper paddle 178 with a discontinuous edge is illustrated. The sweeper paddle 178 that is illustrated in FIG. 15 has an indentation in the lower edge of the sweeper paddle 178.

In some embodiments, a sweeper paddle 178 may be selected for use with a specific insect. For example, in some embodiments, a sweeper paddle 178 may be selected that has an indentation that is configured so that it will sweep the thorax from an immobilized mosquito and leave the remaining salivary glands intact. Accordingly, in some embodiments, a sweeper paddle 178 having a larger indentation may be selected for use with larger insects and a sweeper paddle 178 having a smaller indentation may be selected for use with smaller insects.

A sweeper paddle 178 may be constructed through use of many fabrication methods. For example, in some embodiments, a sweeper paddle 178 may be machined. In some embodiments, a sweeper paddle 178 may be constructed through use of a three-dimensional printer. In some embodiments, a sweeper paddle 178 may be cast. In some embodiments, a sweeper paddle 178 may be fabricated through use of a laser. In some embodiments, a sweeper paddle 178 may be fabricated with a water jet.

A sweeper paddle 178 may be constructed from numerous types of material. Examples of such material include, but are not limited to, metal, glass, plastic, composite materials, fiberglass, and the like. In some embodiments, a sweeper paddle 178 may be constructed from combinations of materials.

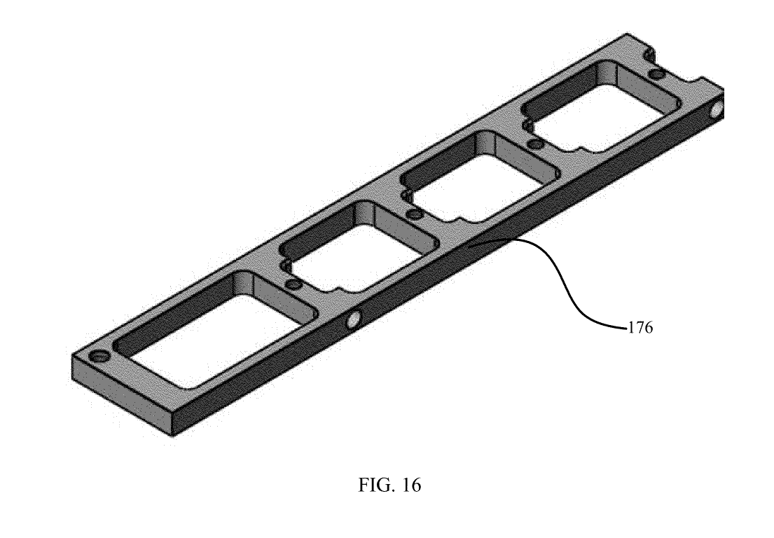

FIG. 16 illustrates an embodiment of a sweeper bracket 176. A sweeper bracket 176 may be configured in numerous ways (see also FIG. 13). For example, in some embodiments, a sweeper bracket 176 may be configured to be coupled to one or more sweeper paddles 178. In some embodiments, a sweeper bracket 176 may be configured to be coupled to one or more sweeper pins 280. In some embodiments, a sweeper bracket 176 may be configured to be coupled to one or more sweeper pins 280 and orient the one or more sweeper pins 280 to operably couple with one or more sweeper guides 284 in a sweeper support member 180 (see also FIG. 17). In some embodiments, a sweeper bracket 176 may be configured to be coupled to one or more sweeper knobs 278. In some embodiments, a sweeper bracket 176 may be configured to be coupled to one or more sweeper couplings 282 that operably couple one or more sweeper paddles 178 to the sweeper bracket 176. In some embodiments, a sweeper bracket 176 may be configured to be coupled to one or more sweeper drive mechanisms 184.

A sweeper bracket 176 may be constructed through use of many fabrication methods. For example, in some embodiments, a sweeper bracket 176 may be machined. In some embodiments, a sweeper bracket 176 may be constructed through use of a three-dimensional printer. In some embodiments, a sweeper bracket 176 may be cast. In some embodiments, a sweeper bracket 176 may be fabricated through use of a laser. In some embodiments, a sweeper bracket 176 may be fabricated with a water jet.

A sweeper bracket 176 may be constructed from numerous types of material. Examples of such material include, but are not limited to, metal, glass, plastic, composite materials, fiberglass, and the like. In some embodiments, a sweeper bracket 176 may be constructed from combinations of materials.

FIG. 17 illustrates an embodiment of a sweeper support member 180. A sweeper support member 180 may be configured in numerous ways. For example, in some embodiments, a sweeper support member 180 may be configured to include one or more sweeper guides 284 that are configured to accept one or more sweeper pins 280 that couple a sweeper arm 286 to the sweeper support member 180 (see also FIG. 13). In some embodiments, the one or more sweeper guides 284 may be configured so that a sweeper arm 286 that is coupled to the sweeper support member 180 will move vertically down and then up when the sweeper arm 286 is moved horizontally. In some embodiments, a sweeper arm 286 may be operably coupled to two sweeper support members 180 that include matched sweeper guides 284 that operably couple with sweeper pins 280 that are operably coupled to opposite sides of the sweeper arm 286. Accordingly, a sweeper guide 284 may be configured so that when the sweeper arm 286 is moved horizontally, a sweeper paddle 178 of the sweeper arm 286 can descend into a thorax orifice 124. This motion allows the sweeper paddle 178 to contact an insect that is immobilized in the thorax orifice 124 and sweep the thorax portion of the immobilized insect. Accordingly, such a configuration may be used to sweep a thorax portion from an immobilized insect and thereby extract a salivary gland from the insect.

In some embodiments, a sweeper support member 180 may be configured to be raised and lowered relative to a first member 102. For example, in some embodiments, a sweeper support member 180 may be coupled to a device with bolts that allow the sweeper support member 180 to be raised and lowered. In such embodiments, the sweeper support member 180 may be calibrated for a specific type of insect. For example, a sweeper support member 180 may be raised for use with a large insect and lowered for use with a small insect.

A sweeper support member 180 may be constructed through use of many fabrication methods. For example, in some embodiments, a sweeper support member 180 may be machined. In some embodiments, a sweeper support member 180 may be constructed through use of a three-dimensional printer. In some embodiments, a sweeper support member 180 may be cast. In some embodiments, a sweeper support member 180 may be fabricated through use of a laser. In some embodiments, a sweeper support member 180 may be fabricated with a water jet.

A sweeper support member 180 may be constructed from numerous types of material. Examples of such material include, but are not limited to, metal, glass, plastic, composite materials, fiberglass, and the like. In some embodiments, a sweeper support member 180 may be constructed from combinations of materials.

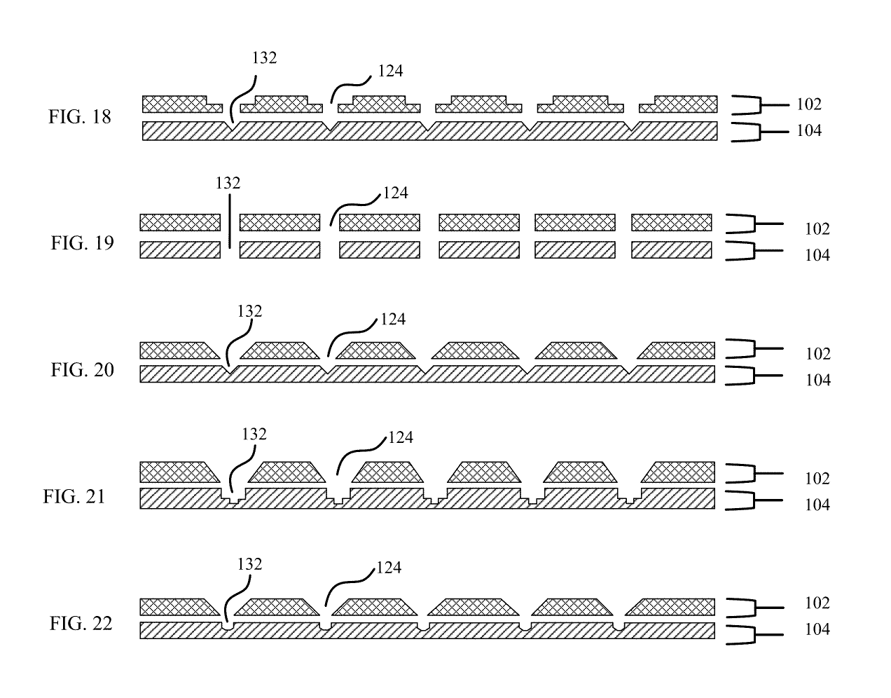

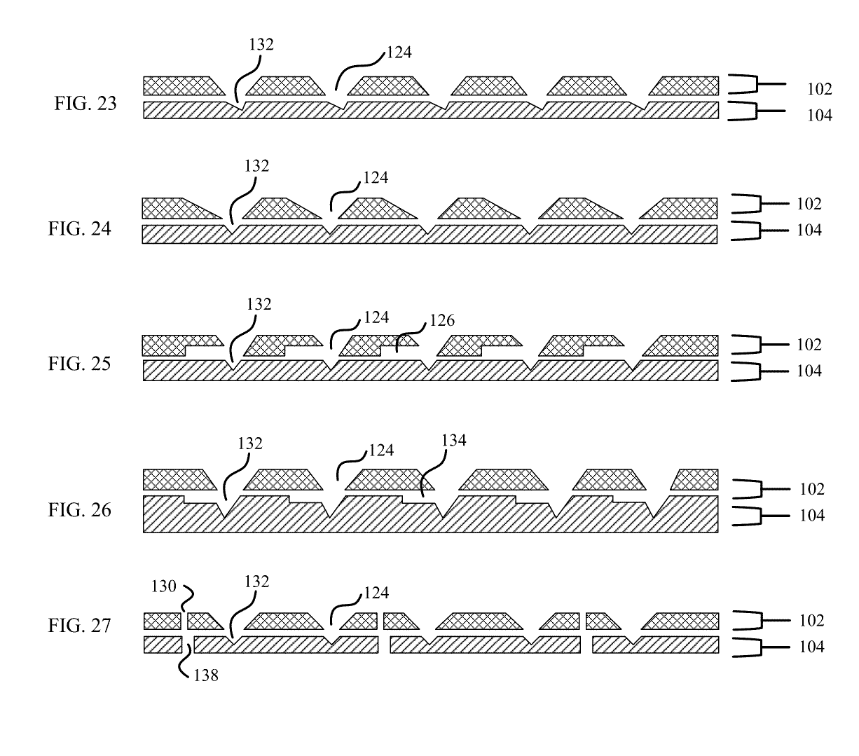

FIGS. 18-27 illustrate side cross-sectional views of various embodiments of first members 102 and second members 104. In FIGS. 18-27, the first members 102 and the second members 104 are shown with a space between them for illustration purposes. However, in some embodiments, the first members 102 and the second members 104 may be in direct physical contact with each other. FIG. 18 illustrates a side cross-sectional view of a first member 102 that has staged thorax orifices 124 and a second member 104 that has substantially right circular cone shaped head orifices 132. FIG. 19 illustrates a side cross-sectional view of a first member 102 that has substantially circular thorax orifices 124 and a second member 104 that has substantially circular shaped head orifices 132. FIG. 20 illustrates a side cross-sectional view of a first member 102 that has substantially right circular truncated cone shaped thorax orifices 124 and a second member 104 that has substantially right circular cone shaped head orifices 132. FIG. 21 illustrates a side cross-sectional view of a first member 102 that has substantially truncated cone shaped thorax orifices 124 and a second member 104 that has staged head orifices 132. FIG. 22 illustrates a side cross-sectional view of a first member 102 that has substantially truncated cone shaped thorax orifices 124 and a second member 104 that has circular head orifices 132. FIG. 23 illustrates a side cross-sectional view of a first member 102 that has substantially truncated cone shaped thorax orifices 124 and a second member 104 that has substantially oblique cone shaped head orifices 132. FIG. 24 illustrates a side cross-sectional view of a first member 102 that has substantially oblique truncated cone shaped thorax orifices 124 and a second member 104 that has substantially right circular cone shaped head orifices 132. FIG. 25 illustrates a side cross-sectional view of a first member 102 that has substantially circular truncated cone shaped thorax orifices 124 that include a thorax trough 126 and a second member 104 that has substantially circular cone shaped head orifices 132. FIG. 26 illustrates a side cross-sectional view of a first member 102 that has substantially circular truncated cone shaped thorax orifices 124 and a second member 104 that has substantially right circular cone shaped head orifices 132 that include a head trough 134. FIG. 27 illustrates a side cross-sectional view of a first member 102 that has a suction hole 130 and substantially circular truncated cone shaped thorax orifices 124 and a second member 104 that has a suction hole 138 and substantially circular cone shaped head orifices 132.

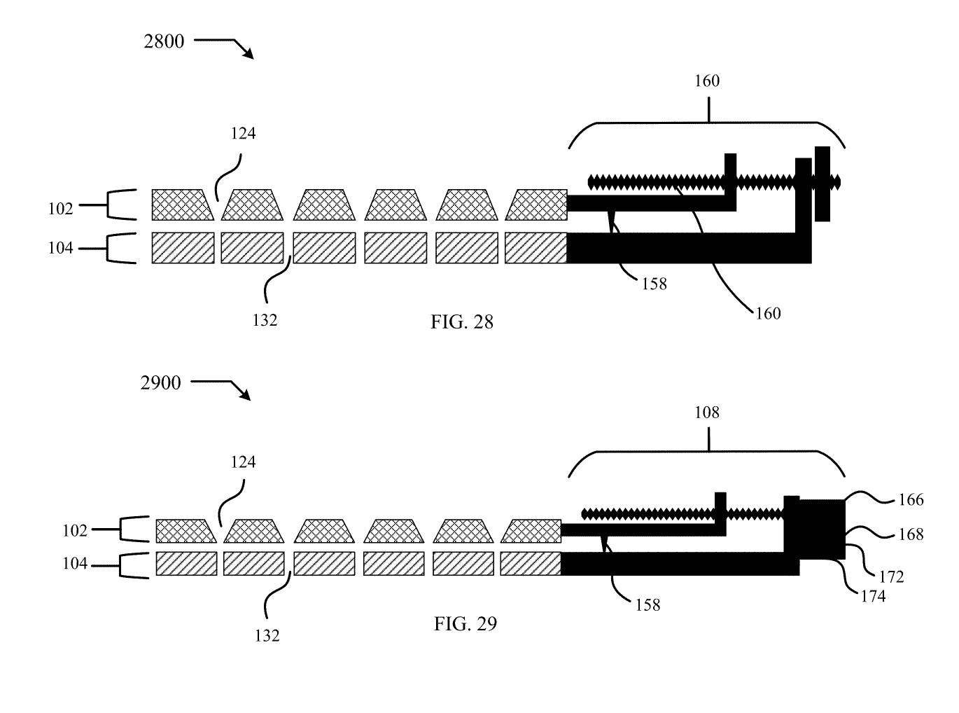

FIG. 28 illustrates an embodiment of system 2800. System 2800 includes a first member 102 that has substantially truncated cone shaped thorax orifices 124 and a second member 104 that has substantially circular head orifices 132. The first member 102 and the second member 104 are operably coupled to a manual drive mechanism 160. The manual drive mechanism 160 includes a threaded actuator 160. Device 2800 also includes a position indicator 158 that may indicate the relative position of the first member 102 to the second member 104.

FIG. 29 illustrates an embodiment of system 2900. System 2900 includes a first member 102 that has substantially truncated cone shaped thorax orifices 124 and a second member 104 that has substantially circular head orifices 132. The first member 102 and the second member 104 are operably coupled to a drive mechanism 108. The drive mechanism 108 includes an operably coupled drive motor 166. The drive mechanism 108 includes an operably coupled drive processor 168. The drive mechanism 108 includes an operably coupled drive receiver 172. The drive mechanism 108 includes an operably coupled drive transmitter 174. Accordingly, in some embodiments, system 2900 may receive one or more signals 122. In some embodiments, system 2900 may transmit one or more signals 122. In some embodiments, system 2900 may process one or more signals 122. For example, in some embodiments, system 2900 may receive one or more signals 122 that were transmitted by one or more control units 120 that direct the operation of the drive motor 166. In some embodiments, system 2900 may receive one or more signals 122 that were transmitted by one or more detection units 114 that direct the operation of the drive motor 166. In some embodiments, system 2900 may receive one or more signals 122 that were transmitted by one or more image acquisition devices 194 that direct the operation of the drive motor 166. In some embodiments, system 2900 may transmit one or more signals 122 that include information related to the operation of the drive motor 166. System 2900 also includes a position indicator 158 that may indicate the relative position of the first member 102 to the second member 104.

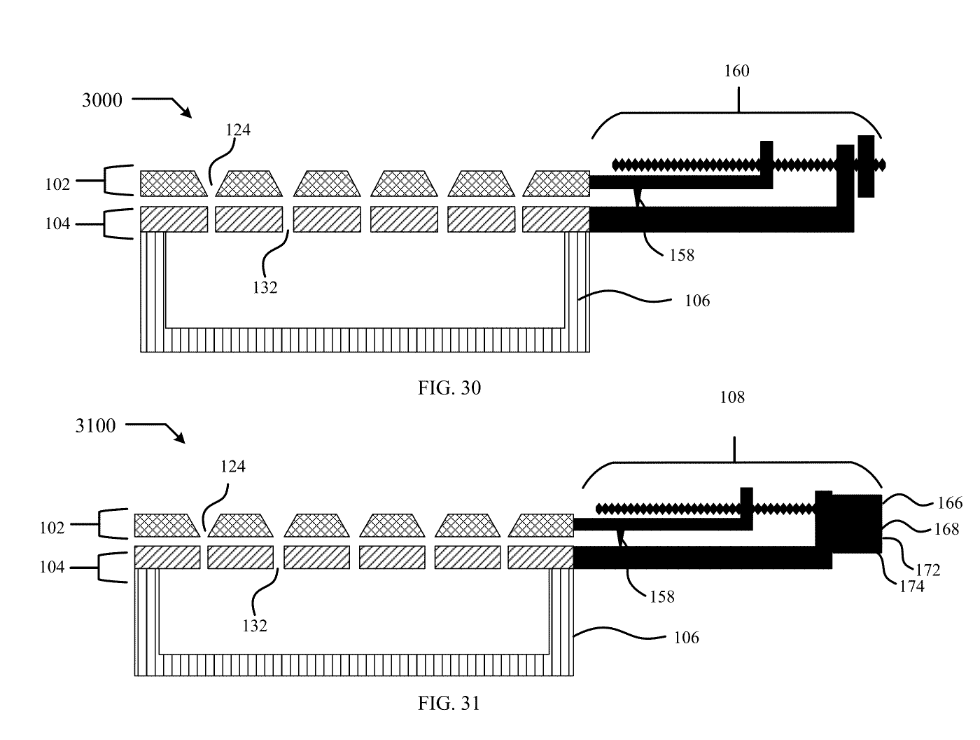

FIG. 30 illustrates an embodiment of system 3000. System 3000 includes a first member 102 that has substantially truncated cone shaped thorax orifices 124 and a second member 104 that has substantially circular head orifices 132. The first member 102 and the second member 104 are operably coupled to a manual drive mechanism 160. The manual drive mechanism 160 includes a threaded actuator 160. Device 3000 also includes an operably coupled base member 106. FIG. 30 illustrates base member 106 being operably coupled to the second member 104. However, in some embodiments, base member 106 may be operably coupled to the first member 102. In some embodiments, base member 106 may be operably coupled to the first member 102 and to the second member 104. Device 3000 also includes a position indicator 158 that may indicate the relative position of the first member 102 to the second member 104.

FIG. 31 illustrates an embodiment of system 3100. System 3100 includes a first member 102 that has substantially truncated cone shaped thorax orifices 124 and a second member 104 that has substantially circular head orifices 132. System 3100 also include an operably coupled base member 106. FIG. 31 illustrates base member 106 being operably coupled to the second member 104. However, in some embodiments, base member 106 may be operably coupled to the first member 102. In some embodiments, base member 106 may be operably coupled to the first member 102 and to the second member 104. The first member 102 and the second member 104 are operably coupled to a drive mechanism 108. The drive mechanism 108 includes an operably coupled drive motor 166. The drive mechanism 108 includes an operably coupled drive processor 168. The drive mechanism 108 includes an operably coupled drive receiver 172. The drive mechanism 108 includes an operably coupled drive transmitter 174. Accordingly, in some embodiments, system 3100 may receive one or more signals 122. In some embodiments, system 3100 may transmit one or more signals 122. In some embodiments, system 3100 may process one or more signals 122. In some embodiments, system 3100 may receive one or more signals 122 that were transmitted by one or more control units 120 that direct the operation of the drive motor 166. In some embodiments, system 3100 may receive one or more signals 122 that were transmitted by one or more detection units 114 that direct the operation of the drive motor 166. In some embodiments, system 3100 may receive one or more signals 122 that were transmitted by one or more image acquisition devices 194 that direct the operation of the drive motor 166. In some embodiments, system 3100 may transmit one or more signals 122 that include information related to the operation of the drive motor 166. Device 3100 also includes a position indicator 158 that may indicate the relative position of the first member 102 to the second member 104.

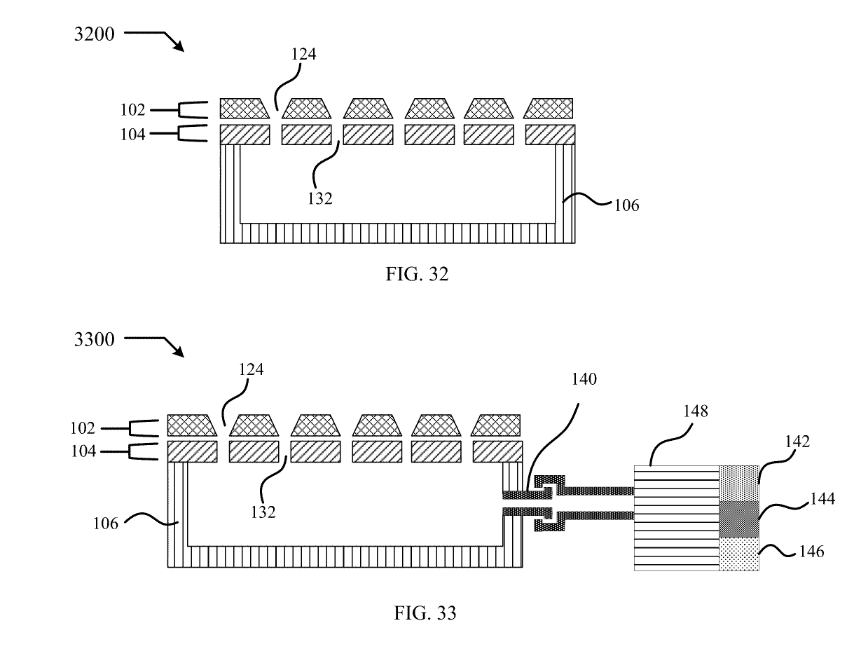

FIG. 32 illustrates an embodiment of system 3200. System 3000 includes a first member 102 that has substantially truncated cone shaped thorax orifices 124 and a second member 104 that has substantially circular head orifices 132. System 3200 also includes an operably coupled base member 106. FIG. 32 illustrates base member 106 being operably coupled to the second member 104. However, in some embodiments, base member 106 may be operably coupled to the first member 102. In some embodiments, base member 106 may be operably coupled to the first member 102 and to the second member 104.

FIG. 33 illustrates an embodiment of system 3300. System 3300 includes a first member 102 that has substantially truncated cone shaped thorax orifices 124 and a second member 104 that has substantially circular head orifices 132. System 3300 also includes an operably coupled base member 106. FIG. 33 illustrates base member 106 being operably coupled to the second member 104. However, in some embodiments, base member 106 may be operably coupled to the first member 102. In some embodiments, base member 106 may be operably coupled to the first member 102 and to the second member 104. The base member 106 includes base suction coupling 140. In some embodiments, a base suction coupling 140 may be configured to be operably coupled to a suction device 148. Numerous types of suction devices 148 may be used. Examples of such suction devices 148 include, but are not limited to, vacuum pumps, suction pumps, and the like. In FIG. 33, base member 106 is illustrated as being operably coupled to one suction device 148. In some embodiments, a base member 106 may be operably coupled to one or more suction devices 148. In some embodiments, a suction device 148 may be operably coupled to one or more base receivers 142. In some embodiments, a suction device 148 may be operably coupled to one or more base transmitters 144. In some embodiments, a suction device 148 may be operably coupled to one or more base processors 146. Accordingly, in some embodiments, system 3300 may receive one or more signals 122. In some embodiments, system 3300 may transmit one or more signals 122. In some embodiments, system 3300 may process one or more signals 122. For example, in some embodiments, system 3300 may receive one or more signals 122 that were transmitted by one or more control units 120 that direct the operation of an operably coupled suction device 148. In some embodiments, system 3300 may receive one or more signals 122 that were transmitted by one or more detection units 114 that direct the operation of an operably coupled suction device 148. In some embodiments, system 3300 may receive one or more signals 122 that were transmitted by one or more image acquisition devices 194 that direct the operation of an operably coupled suction device 148. In some embodiments, system 3300 may transmit one or more signals 122 that include information related to the operation of an operably coupled suction device 148.

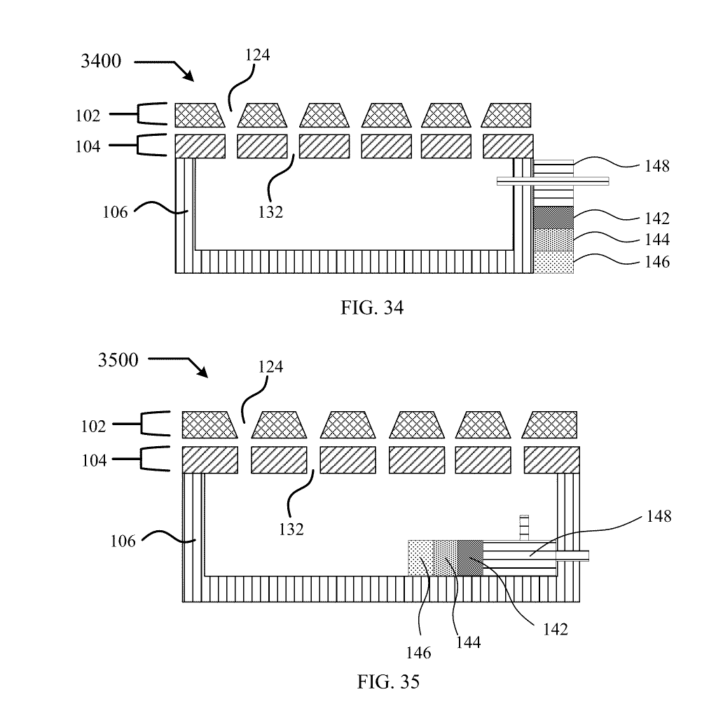

FIG. 34 illustrates an embodiment of system 3400. System 3400 includes a first member 102 that has substantially truncated cone shaped thorax orifices 124 and a second member 104 that has substantially circular head orifices 132. System 3400 also includes an operably coupled base member 106. FIG. 34 illustrates base member 106 being operably coupled to the second member 104. However, in some embodiments, base member 106 may be operably coupled to the first member 102. In some embodiments, base member 106 may be operably coupled to the first member 102 and to the second member 104. The base member 106 is illustrated as being directly coupled to a suction device 148 that is external to the base member 106. Numerous types of suction devices 148 may be used. Examples of such suction devices 148 include, but are not limited to, vacuum pumps, suction pumps, and the like. In FIG. 34, base member 106 is illustrated as being operably coupled to one suction device 148 having an inlet positioned within the base member 106 and a discharge positioned to the outside of the base member 106. In some embodiments, a base member 106 may be operably coupled to one or more suction devices 148. In some embodiments, base member 106 may be operably coupled to one or more base receivers 142. In some embodiments, base member 106 may be operably coupled to one or more base transmitters 144. In some embodiments, base member 106 may be operably coupled to one or more base processors 146. Accordingly, in some embodiments, system 3400 may receive one or more signals 122. In some embodiments, system 3400 may transmit one or more signals 122. In some embodiments, system 3400 may process one or more signals 122. For example, in some embodiments, system 3400 may receive one or more signals 122 that were transmitted by one or more control units 120 that direct the operation of an operably coupled suction device 148. In some embodiments, system 3400 may receive one or more signals 122 that were transmitted by one or more detection units 114 that direct the operation of an operably coupled suction device 148. In some embodiments, system 3400 may receive one or more signals 122 that were transmitted by one or more image acquisition devices 194 that direct the operation of an operably coupled suction device 148. In some embodiments, system 3400 may transmit one or more signals 122 that include information related to the operation of an operably coupled suction device 148.

FIG. 35 illustrates an embodiment of system 3500. System 3500 includes a first member 102 that has substantially truncated cone shaped thorax orifices 124 and a second member 104 that has substantially circular head orifices 132. System 3500 also includes an operably coupled base member 106. FIG. 35 illustrates base member 106 being operably coupled to the second member 104. However, in some embodiments, base member 106 may be operably coupled to the first member 102. In some embodiments, base member 106 may be operably coupled to the first member 102 and to the second member 104. The base member 106 is illustrated as being directly coupled to a suction device 148 that is internal to the base member 106. Numerous types of suction devices 148 may be used. Examples of such suction devices 148 include, but are not limited to, vacuum pumps, suction pumps, and the like. In FIG. 35, base member 106 is illustrated as being operably coupled to one suction device 148 having an inlet positioned within the base member 106 and a discharge positioned to the outside of the base member 106. In some embodiments, a base member 106 may be operably coupled to one or more suction devices 148. In some embodiments, base member 106 may be operably coupled to one or more base receivers 142. In some embodiments, base member 106 may be operably coupled to one or more base transmitters 144. In some embodiments, base member 106 may be operably coupled to one or more base processors 146. Accordingly, in some embodiments, system 3500 may receive one or more signals 122. In some embodiments, system 3500 may transmit one or more signals 122. In some embodiments, system 3500 may process one or more signals 122. For example, in some embodiments, system 3500 may receive one or more signals 122 that were transmitted by one or more control units 120 that direct the operation of an operably coupled suction device 148. In some embodiments, system 3500 may receive one or more signals 122 that were transmitted by one or more detection units 114 that direct the operation of an operably coupled suction device 148. In some embodiments, system 3500 may receive one or more signals 122 that were transmitted by one or more image acquisition devices 194 that direct the operation of an operably coupled suction device 148. In some embodiments, system 3500 may transmit one or more signals 122 that include information related to the operation of an operably coupled suction device 148.

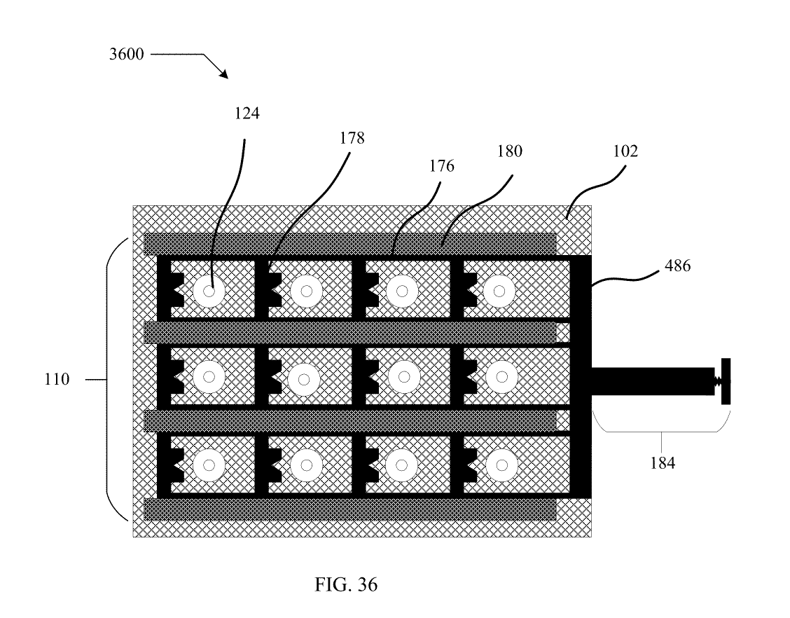

FIG. 36 illustrates an embodiment of system 3600. A top view of an embodiment of a sweeper unit 110 is illustrated. In this embodiment, a plurality of sweeper paddles 178 are operably coupled to a plurality of sweeper brackets 176 to form a sweeper arm 486. The sweeper arm 486 is operably coupled to a sweeper drive mechanism 184. In this embodiment, the sweeper drive mechanism 184 is illustrated as a manual sweeper drive mechanism 184. The sweeper arm 486 is operably coupled to a plurality of sweeper support members 180. The sweeper support members 180 are operably coupled to a first member 102. The first member 102 includes a plurality of thorax orifices 124. The sweeper support members 180 align the sweeper arm 468 with the thorax orifices 124 so that the sweeper paddles 178 are oriented to sweep across the plurality of thorax orifices 124. In this embodiment, the sweeper drive mechanism 184 may be used to advance the sweeper arm 468.

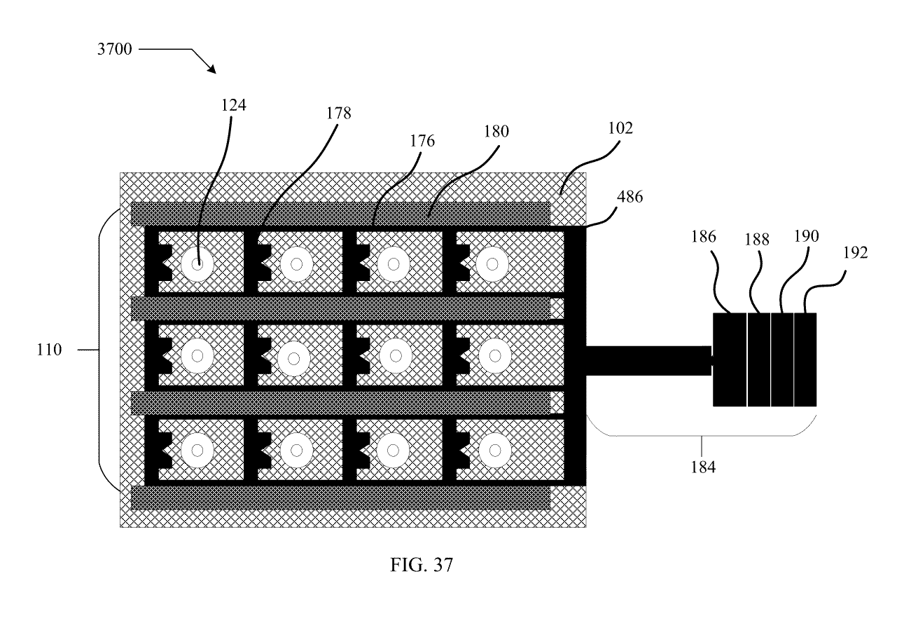

FIG. 37 illustrates an embodiment of system 3700. A top view of an embodiment of a sweeper unit 110 is illustrated. In this embodiment, a plurality of sweeper paddles 178 are operably coupled to a plurality of sweeper brackets 176 to form a sweeper arm 486. The sweeper arm 486 is operably coupled to a sweeper drive mechanism 184. In this embodiment, the sweeper drive mechanism 184 is illustrated as a sweeper drive mechanism 184 that includes a sweeper motor 186. The sweeper arm 486 is operably coupled to a plurality of sweeper support members 180. The sweeper support members 180 are operably coupled to a first member 102. The first member 102 includes a plurality of thorax orifices 124. The sweeper support members 180 align the sweeper arm 468 with the thorax orifices 124 so that the sweeper paddles 178 are oriented to sweep across the plurality of thorax orifices 124. In this embodiment, the sweeper drive mechanism 184 may be used to advance the sweeper arm 468. In this embodiment, the sweeper unit 110 includes one or more sweeper receivers 188. In this embodiment, the sweeper unit 110 includes one or more sweeper transmitters 190. In this embodiment, the sweeper unit 110 includes one or more sweeper processors 192. Accordingly, in this embodiment, sweeper unit 110 may receive one or more signals 122. In this embodiment, sweeper unit 110 may transmit one or more signals 122. In this embodiment, sweeper unit 110 may process one or more signals 122. In some embodiments, sweeper unit 100 may receive one or more signals 122 from one or more control units 120. In some embodiments, sweeper unit 100 may receive one or more signals 122 from one or more detection units 114. In some embodiments, sweeper unit 100 may receive one or more signals 122 from one or more image acquisition devices 194. Accordingly, in some embodiments, sweeper unit 110 may operate in a feedback loop. For example, in some embodiments, a sweeper receiver 188 may receive one or more signals 122 that direct the sweeper motor 186 to operate thereby advancing sweeper arm 486. In some embodiments, such signals 122 may be transmitted by one or more detection units 114. In some embodiments, such signals 122 may be transmitted by one or more image acquisition devices 194. In some embodiments, such signals 122 may be transmitted by one or more control units 120. Accordingly, in some embodiments, a sweeper motor 186 may be user 116 controlled. For example, in some embodiments, a user 116 may use an image acquisition device 194 to determine the extent to which the thorax region of an insect has been swept from an insect that is immobilized in the first member 102. The user 116 may then utilize a user interface 118 to cause one or more signals 122 to be transmitted that direct a sweeper motor 186 to operate.

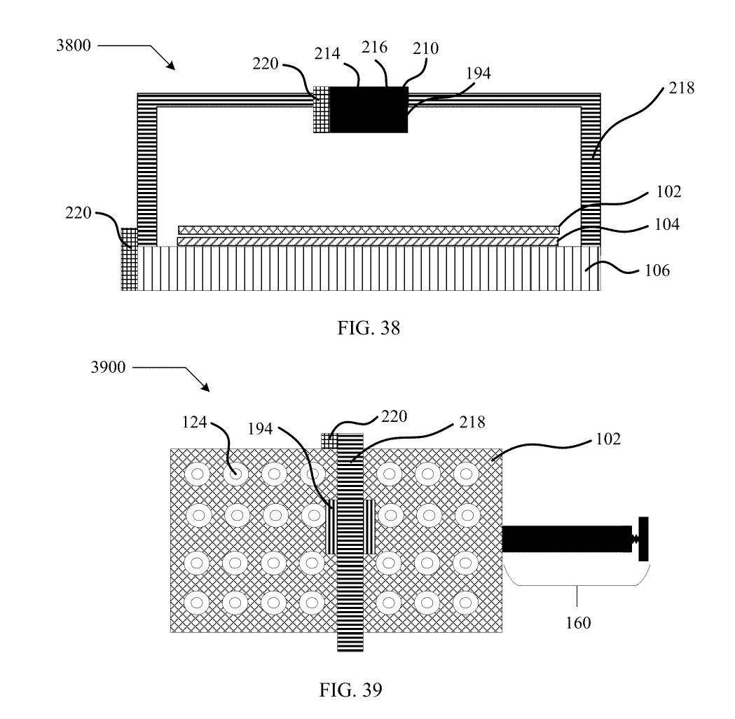

FIG. 38 illustrates a side view of an embodiment of system 3800. System 3800 includes a first member 102 that is operably coupled to a second member 104. The first member 102 and the second member 104 are operably coupled to a base unit 106. The base unit 106 may be operably coupled to a detection support member 218. The detection support member 218 may be operably coupled to a detection motor 220. Accordingly, in some embodiments, the detection support member 218 may be stationary. In some embodiments, the detection support member 218 may be mobile. An image acquisition device 194 may be operably coupled to the detection support member 218. System 3800 may include a detection receiver 216. System 3800 may include a detection transmitter 214. System 3800 may include a detection processor 210. Accordingly, in some embodiments, system 3800 may receive one or more signals 122. In some embodiments, system 3800 may transmit one or more signals 122. In some embodiments, system 3800 may process one or more signals 122. The image acquisition device 194 may be operably coupled to a detection motor 220. Accordingly, in some embodiments, the image acquisition device 194 may be stationary. In some embodiments, the image acquisition device 194 may be mobile. In some embodiments, the image acquisition device 194 may be scanned along the length of the first member 102. In some embodiments, the image acquisition device 194 may be scanned along the width of the first member 102. In some embodiments, the image acquisition device 194 may be scanned along the length and width of the first member 102. In some embodiments, system 3800 may receive one or more signals 122 that direct operation of a detection motor 220. Accordingly, in some embodiments, system 3800 may receive one or more signals 122 that cause an image acquisition device 194 to move to a selected position through movement of the image acquisition device 194 on the detection support member 218 and/or through movement of the detection support member 218. In some embodiment, system 3800 may include one or more operably coupled sweeper arms 286 that are operably coupled to one or more sweeper support members 180 (not shown).

In some embodiments, a user 116 may control one or more detection motors 220 in order to control the position of an image acquisition device 194. For example, in some embodiments, system 3800 may acquire and transmit one or more signals 122 that include one or more images that are displayed on a user interface 118. A user 116 may view the images and then cause one or more signals 122 to be transmitted that control one or more detection motors 220 that act to position an image acquisition device 194.

FIG. 39 illustrates a top view of an embodiment of system 3900. System 3900 includes a first member 102 that includes a plurality of thorax orifices 124. The first member 102 is operably coupled to a manual drive mechanism 160. System 3900 includes a detection support member 218 that is operably coupled to an image acquisition unit 194. The detection support member 218 may be operably coupled to a detection motor 220. Accordingly, in some embodiments, the detection support member 218 may be stationary. In some embodiments, the detection support member 218 may be mobile. The image acquisition device 194 may be operably coupled to a detection receiver 216 (not shown). The image acquisition device 194 may be operably coupled to a detection transmitter 214 (not shown). The image acquisition device 194 may be operably coupled to a detection processor 210 (not shown). Accordingly, in some embodiments, system 3900 may receive one or more signals 122. In some embodiments, system 3900 may transmit one or more signals 122. In some embodiments, system 3900 may process one or more signals 122. The image acquisition device 194 may be operably coupled to a detection motor 220 (not shown). Accordingly, in some embodiments, the image acquisition device 194 may be stationary. In some embodiments, the image acquisition device 194 may be mobile. In some embodiments, the image acquisition device 194 may be scanned along the length of the first member 102. In some embodiments, the image acquisition device 194 may be scanned along the width of the first member 102. In some embodiments, the image acquisition device 194 may be scanned along the length and width of the first member 102. In some embodiments, system 3900 may receive one or more signals 122 that direct operation of a detection motor 220. Accordingly, in some embodiments, system 3900 may receive one or more signals 122 that cause an image acquisition device 194 to move to a selected position through movement of the image acquisition device 194 on the detection support member 218 and/or through movement of the detection support member 218. In some embodiment, system 3900 may include one or more operably coupled sweeper arms 286 that are operably coupled to one or more sweeper support members 180 (not shown).

In some embodiments, a user 116 may control one or more detection motors 220 in order to control the position of an image acquisition device 194. For example, in some embodiments, system 3900 may acquire and transmit one or more signals 122 that include one or more images that are displayed on a user interface 118. A user 116 may view the images and then cause one or more signals 122 to be transmitted that control one or more detection motors 220 that act to position an image acquisition device 194.

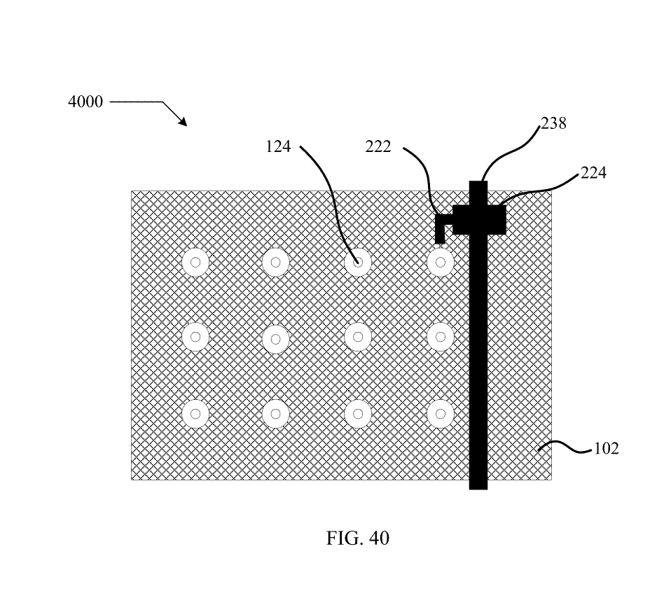

FIG. 40 illustrates a top view of an embodiment of system 4000. System 4000 includes a first member 102 that includes a plurality of thorax orifices 124. A moveable member 238 is illustrated as being operably coupled to the first member 102. In some embodiments, moveable member 238 may be moved along the length of the first member 102. A scraper aligner 224 is operably coupled to the moveable member 238 and to a scraper 222. Accordingly, in some embodiments, the scraper aligner 224 may be moved on the moveable member 238 to cause the scraper 222 to travel across the width of the first member 102. In some embodiment, system 4000 may include one or more operably coupled sweeper arms 286 that are operably coupled to one or more sweeper support members 180 (not shown).

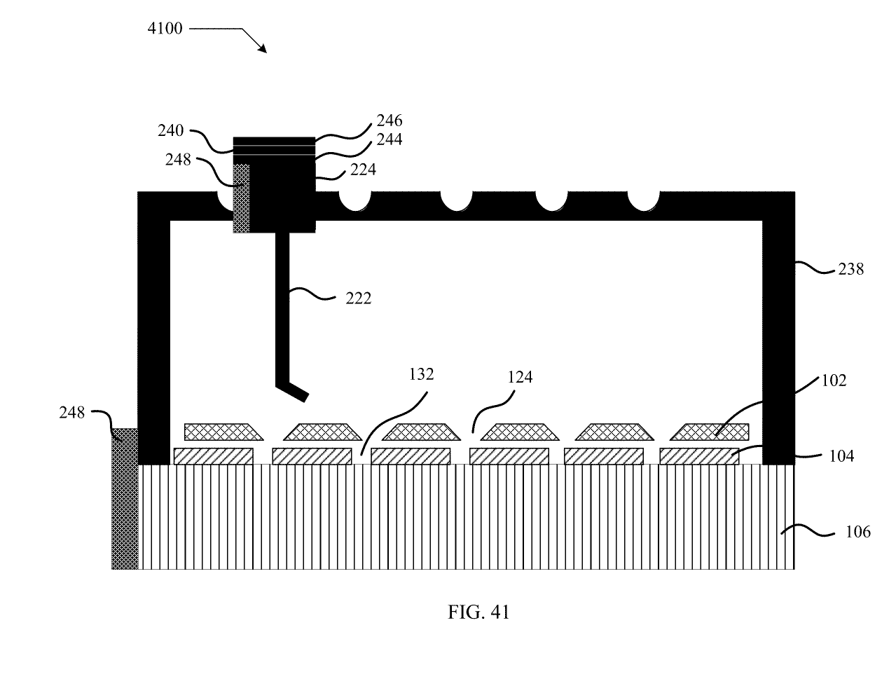

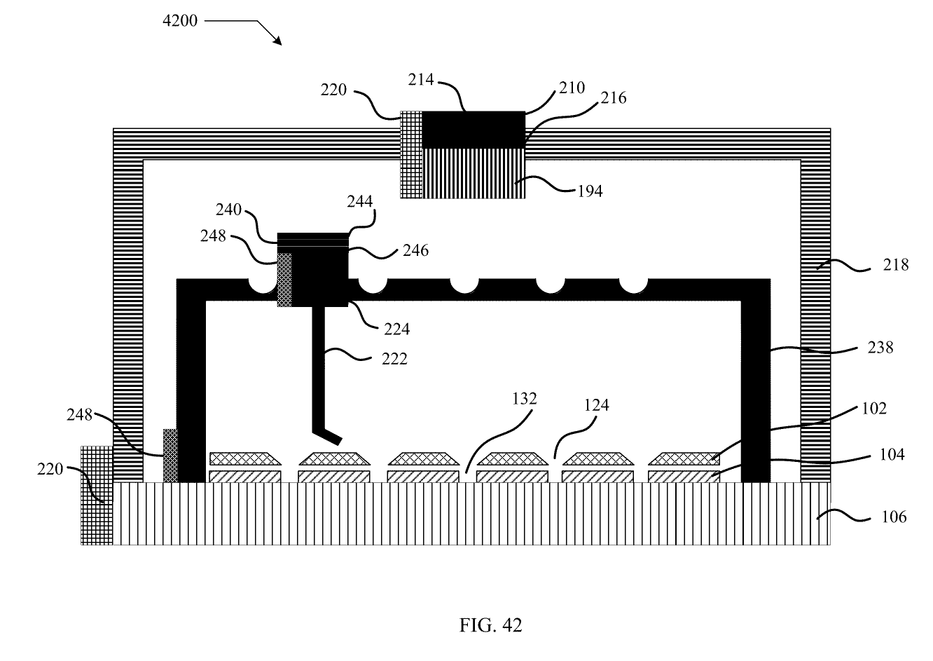

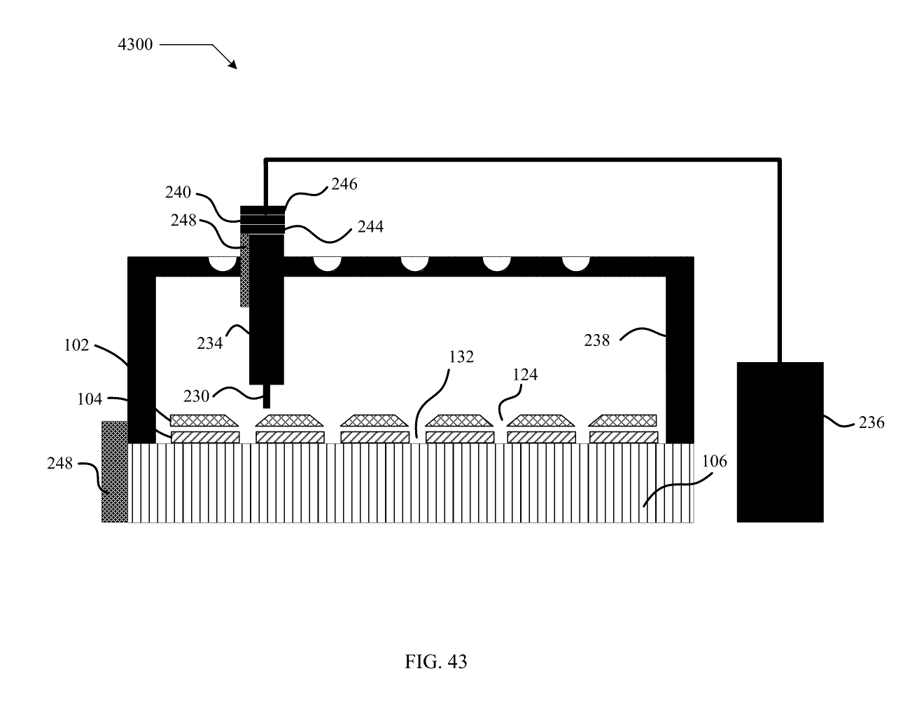

FIG. 41 illustrates a side view of an embodiment of system 4100. System 4100 includes a first member 102 that is operably coupled to a second member 104. The first member 102 includes a plurality of thorax orifices 124 and the second member 104 includes a plurality of head orifices 132. The first member 102 and the second member 104 are operably coupled to a base unit 106. The base unit 106 may be operably coupled to a moveable member 238. Moveable member 238 may be operably coupled to a collection motor 248. Accordingly, in some embodiments, the moveable member 238 may be stationary. In some embodiments, the moveable member 238 may be mobile. A scraper aligner 224 may be operably coupled to the moveable member 238. The scraper aligner 224 may be operably coupled to a scraper 222. Accordingly, in some embodiments, scraper aligner 224 may be moved alone the moveable member 238 to move the scraper 222 across the first member 102. In some embodiments, scraper aligner 224 may be operably coupled to a collection motor 248. System 4100 may include one or more collection receivers 244. System 4100 may include one or more collection transmitters 246. System 4100 may include one or more collection processors 240. Accordingly, in some embodiments, system 4100 may receive one or more signals 122. In some embodiments, system 4100 may transmit one or more signals 122. In some embodiments, system 4100 may process one or more signals 122. In some embodiments, system 4100 may receive one or more signals 122 that direct operation of a collection motor 248. Accordingly, in some embodiments, system 4100 may receive one or more signals 122 that direct a scraper 222 to move to a selected position through movement of the scraper aligner 224 on the moveable member 238 and/or through movement of the moveable member 238.

In some embodiments, a user 116 may control one or more collection motors 248 in order to control the position of a scraper 222. For example, in some embodiments, a user 116 may utilize a user interface 118 to cause transmission of one or more signals 122 that control one or more collection motors 248 that act to position a scraper 222. In some embodiment, system 4100 may include one or more operably coupled sweeper arms 286 that are operably coupled to one or more sweeper support members 180 (not shown).

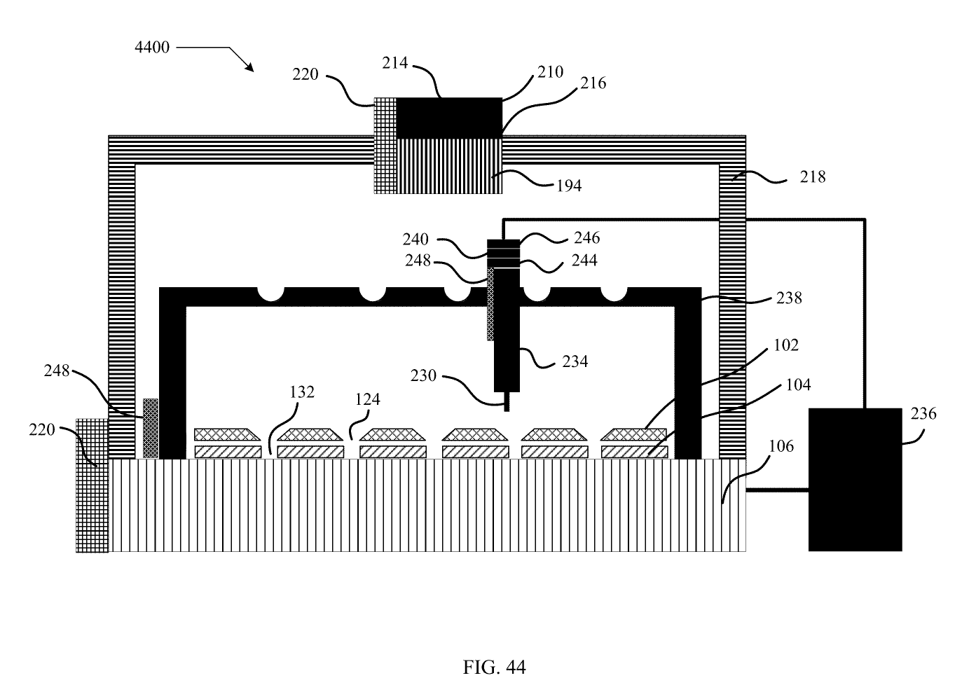

FIG. 42 illustrates a side view of an embodiment of system 4200. System 4200 includes a first member 102 that is operably coupled to a second member 104. The first member 102 includes a plurality of thorax orifices 124 and the second member 104 includes a plurality of head orifices 132. The first member 102 and the second member 104 are operably coupled to a base unit 106. The base unit 106 may be operably coupled to a moveable member 238. Moveable member 238 may be operably coupled to a collection motor 248. Accordingly, in some embodiments, the moveable member 238 may be stationary. In some embodiments, the moveable member 238 may be mobile. A scraper aligner 224 may be operably coupled to the moveable member 238. The scraper aligner 224 may be operably coupled to a scraper 222. Accordingly, in some embodiments, scraper aligner 224 may be moved alone the moveable member 238 to move the scraper 222 across the width of first member 102. In some embodiments, the moveable member 238 may be moved to move the scraper 222 across the length of first member 102. In some embodiments, scraper aligner 224 may be operably coupled to a collection motor 248. System 4200 may include one or more collection receivers 244. System 4200 may include one or more collection transmitters 246. System 4200 may include one or more collection processors 240. Accordingly, in some embodiments, system 4200 may receive one or more signals 122. In some embodiments, system 4200 may transmit one or more signals 122. In some embodiments, system 4200 may process one or more signals 122. In some embodiments, system 4200 may receive one or more signals 122 that direct operation of a collection motor 248. Accordingly, in some embodiments, system 4200 may receive one or more signals 122 that direct a scraper 222 to move to a selected position through movement of the scraper aligner 224 on the moveable member 238 and/or through movement of the moveable member 238.

In some embodiments, a user 116 may control one or more collection motors 248 in order to control the position of a scraper 222. For example, in some embodiments, a user 116 may utilize a user interface 118 to cause transmission of one or more signals 122 that control one or more collection motors 248 that act to position a scraper 222. In some embodiments, the scraper 222 may be positioned to collect one or more insect salivary glands. In some embodiment, system 4100 may include one or more operably coupled sweeper arms 286 that are operably coupled to one or more sweeper support members 180 (not shown).

System 4200 may include a detection support member 218. In some embodiments, a detection support member 218 may be operably coupled to a base member 106. The detection support member 218 is operably coupled to a detection motor 220. Accordingly, in some embodiments, the detection support member 218 may be stationary. In some embodiments, the detection support member 218 may be mobile. An image acquisition device 194 is operably coupled to the detection support member 218. System 4200 may include a detection receiver 216. System 4200 may include a detection transmitter 214. System 4200 may include a detection processor 210. Accordingly, in some embodiments, system 4100 may receive one or more signals 122. In some embodiments, system 4200 may transmit one or more signals 122. In some embodiments, system 4200 may process one or more signals 122. The image acquisition device 194 may be operably coupled to a detection motor 220. Accordingly, in some embodiments, the image acquisition device 194 may be stationary. In some embodiments, the image acquisition device 194 may be mobile. In some embodiments, the image acquisition device 194 may be scanned along the length of the first member 102. In some embodiments, the image acquisition device 194 may be scanned along the width of the first member 102. In some embodiments, the image acquisition device 194 may be scanned along the length and width of the first member 102. In some embodiments, system 4200 may receive one or more signals 122 that direct operation of a detection motor 220. Accordingly, in some embodiments, system 4200 may receive one or more signals 122 that cause an image acquisition device 194 to move to a selected position through movement of the image acquisition device 194 on the detection support member 218 and/or through movement of the detection support member 218.

In some embodiments, a user 116 may control one or more detection motors 220 in order to control the position of an image acquisition device 194. For example, in some embodiments, system 4200 may acquire one or more images and transmit one or more signals 122 that include the one or more images that are displayed on a user interface 118. A user 116 may view the images and then cause one or more signals 122 to be transmitted that control one or more detection motors 220 that act to position an image acquisition device 194. In some embodiment, system 4200 may include one or more operably coupled sweeper arms 286 that are operably coupled to one or more sweeper support members 180 (not shown).

FIG. 43 illustrates a side view of an embodiment of system 4300. System 4300 includes a first member 102 that is operably coupled to a second member 104. The first member 102 includes a plurality of thorax orifices 124 and the second member 104 includes a plurality of head orifices 132. The first member 102 and the second member 104 are operably coupled to a base unit 106. The base unit 106 may be operably coupled to a moveable member 238. Moveable member 238 may be operably coupled to a collection motor 248. Accordingly, in some embodiments, the moveable member 238 may be stationary. In some embodiments, the moveable member 238 may be mobile. An intake support member 234 that is operably coupled to a suction intake 230 may be operably coupled to the moveable member 238. The intake support member 234 may be operably coupled to a suction device 236. Accordingly, in some embodiments, intake support member 234 may be moved alone the moveable member 238 to move the suction intake 230 across the first member 102. In some embodiments, intake support member 234 may be operably coupled to a collection motor 248. System 4300 may include one or more collection receivers 244. System 4300 may include one or more collection transmitters 246. System 4300 may include one or more collection processors 240. Accordingly, in some embodiments, system 4300 may receive one or more signals 122. In some embodiments, system 4300 may transmit one or more signals 122. In some embodiments, system 4300 may process one or more signals 122. In some embodiments, system 4300 may receive one or more signals 122 that direct operation of a collection motor 248. Accordingly, in some embodiments, system 4300 may receive one or more signals 122 that direct an intake support member 234 to move to a selected position through movement of the intake support member 234 on the moveable member 238 and/or through movement of the moveable member 238.

In some embodiments, a user 116 may control one or more collection motors 248 in order to control the position of a suction intake 230. For example, in some embodiments, a user 116 may utilize a user interface 118 to effect transmission of one or more signals 122 that control one or more collection motors 248 that act to position a suction intake 230. In some embodiments, the suction intake 230 may be positioned to collect one or more insect salivary glands. In some embodiment, system 4300 may include one or more operably coupled sweeper arms 286 that are operably coupled to one or more sweeper support members 180 (not shown).

FIG. 44 illustrates a side view of an embodiment of system 4400. System 4400 includes a first member 102 that is operably coupled to a second member 104. The first member 102 includes a plurality of thorax orifices 124 and the second member 104 includes a plurality of head orifices 132. The first member 102 and the second member 104 are operably coupled to a base unit 106. The base unit 106 may be operably coupled to a moveable member 238. Moveable member 238 may be operably coupled to a collection motor 248. Accordingly, in some embodiments, the moveable member 238 may be stationary. In some embodiments, the moveable member 238 may be mobile. An intake support member 234 that is operably coupled to a suction intake 230 may be operably coupled to the moveable member 238. The intake support member 234 may be operably coupled to a suction device 236. Accordingly, in some embodiments, intake support member 234 may be moved alone the moveable member 238 to move the suction intake 230 across the first member 102. In some embodiments, intake support member 234 may be operably coupled to a collection motor 248. System 4400 may include one or more collection receivers 244. System 4400 may include one or more collection transmitters 246. System 4400 may include one or more collection processors 240. Accordingly, in some embodiments, system 4400 may receive one or more signals 122. In some embodiments, system 4400 may transmit one or more signals 122. In some embodiments, system 4400 may process one or more signals 122. In some embodiments, system 4400 may receive one or more signals 122 that direct operation of a collection motor 248. Accordingly, in some embodiments, system 4400 may receive one or more signals 122 that direct an intake support member 234 to move to a selected position through movement of the intake support member 234 on the moveable member 238 and/or through movement of the moveable member 238.

In some embodiments, a user 116 may control one or more collection motors 248 in order to control the position of a suction intake 230. For example, in some embodiments, a user 116 may utilize a user interface 118 to cause transmission of one or more signals 122 that control one or more collection motors 248 that act to position a suction intake 230. In some embodiments, the suction intake 230 may be positioned to collect one or more insect salivary glands

System 4400 may include a detection support member 218. In some embodiments, a detection support member 218 may be operably coupled to a base member 106. The detection support member 218 may be operably coupled to a detection motor 220. Accordingly, in some embodiments, the detection support member 218 may be stationary. In some embodiments, the detection support member 218 may be mobile. An image acquisition device 194 may be operably coupled to the detection support member 218. System 4400 may include a detection receiver 216. System 4400 may include a detection transmitter 214. System 4400 may include a detection processor 210. Accordingly, in some embodiments, system 4400 may receive one or more signals 122. In some embodiments, system 4400 may transmit one or more signals 122. In some embodiments, system 4400 may process one or more signals 122. The image acquisition device 194 may be operably coupled to a detection motor 220. Accordingly, in some embodiments, the image acquisition device 194 may be stationary. In some embodiments, the image acquisition device 194 may be mobile. In some embodiments, the image acquisition device 194 may be scanned along the length of the first member 102. In some embodiments, the image acquisition device 194 may be scanned along the width of the first member 102. In some embodiments, the image acquisition device 194 may be scanned along the length and width of the first member 102. In some embodiments, system 4400 may receive one or more signals 122 that direct operation of a detection motor 220. Accordingly, in some embodiments, system 4400 may receive one or more signals 122 that cause an image acquisition device 194 to move to a selected position through movement of the image acquisition device 194 on the detection support member 218 and/or through movement of the detection support member 218.

In some embodiments, a user 116 may control one or more detection motors 220 in order to control the position of an image acquisition device 194. For example, in some embodiments, system 4400 may acquire and transmit one or more signals 122 that include one or more images that are displayed on a user interface 118. A user 116 may view the images and then cause one or more signals 122 to be transmitted that control one or more detection motors 220 that act to position an image acquisition device 194. In some embodiment, system 4400 may include one or more operably coupled sweeper arms 286 that are operably coupled to one or more sweeper support members 180 (not shown).

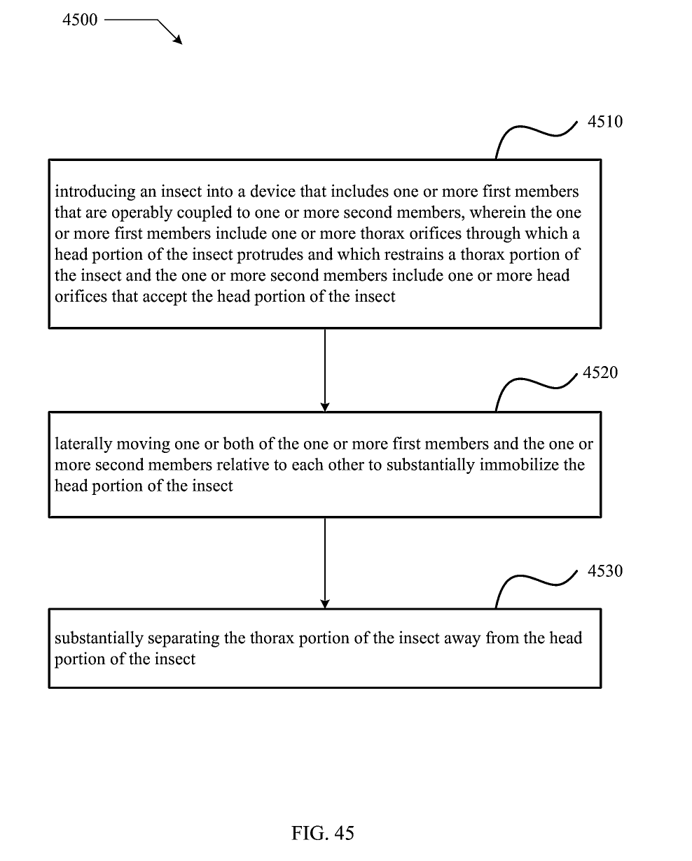

FIG. 45 illustrates operational flow 4500 that includes operation 4510 that includes introducing an insect into a device that includes one or more first members 102 that are operably coupled to one or more second members 104, wherein the one or more first members 102 include one or more thorax orifices 124 through which a head portion of the insect protrudes and which restrains a thorax portion of the insect and the one or more second members 104 include one or more head orifices 132 that accept the head portion of the insect, operation 4520 that includes laterally moving one or both of the one or more first members 102 and the one or more second members 104 relative to each other to substantially immobilize the head portion of the insect, and operation 4530 that includes substantially separating (or sweeping) the thorax portion of the insect from the head portion of the insect.

In FIG. 45 and in the following description that includes various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

Operation 4510 includes introducing an insect into a device that includes one or more first members 102 that are operably coupled to one or more second members 104, wherein the one or more first members 102 include one or more thorax orifices 124 through which a head portion of the insect protrudes and which restrains a thorax portion of the insect and the one or more second members 104 include one or more head orifices 132 that accept the head portion of the insect. Numerous types of insects may be introduced into a device. Examples of such insects include, but are not limited to, mosquitos, bees, wasps, crickets, fruit flies, beetles, and the like. Accordingly, in some embodiments, a first member 102 and a second member 104 may be selected for use with a specific type of insect. Accordingly, a first member 102 and a second member 104 may be configured with a thorax orifice 124 and a head orifice 132 that may be used with a selected insect. In some embodiments, the dimensions of an insect may be determined in order to select a first member 102 and/or a second member 104. The dimensions of an insect may be determined through use of numerous methods. In some embodiments, a microscope 198 may be used to measure the dimensions of an insect. Such dimensions may include, but are not limited to, the length of the head of an insect, the length of the head and neck of an insect, the width of the head of an insect, and the like. Such dimension determinations may be used to select a first member 102 and second member 104 for use with an insect. An insect may be introduced into a device manually. For example, a user 116 may place an insect into the device. An insect may be introduced into a device through use of an automated protocol. For example, in some embodiments, an insect may introduced into a device through use of suction.

Operation 4520 includes laterally moving one or both of the one or more first members 102 and the one or more second members 104 relative to each other to substantially immobilize the head portion of the insect. In some embodiments, a user 116 may manually move a first member 102 relative to a second member 104. In some embodiments, an automated protocol may be used to move a first member 102 relative to a second member 104.

Operation 4530 includes substantially separating the thorax portion of the insect from the head portion of the insect. In some embodiments, a user 116 may manually separate the thorax portion of an insect from the head portion of an insect. For example, in some embodiments, a user 116 may use a tweezers to grasp the thorax portion of an insect and pull the thorax portion away from the head portion of the insect. In some embodiments, a user 116 may use a sweeper arm 286 to sweep the thorax portion of an insect away from the head portion of the insect. In some embodiments, an automated protocol may be used to separate the thorax portion of an insect away from the head portion of the insect. In some embodiments, the thorax portion of the insect may be separated from the head portion of the insect to extract a salivary gland from the insect.

In some embodiments, operation 4510 includes introducing a mosquito into the device (not shown). In some embodiments, a mosquito may be introduced into a device that includes one or more first members 102 that include one or more thorax orifices 124 through which a head portion of the mosquito protrudes and which restrains a thorax portion of the mosquito and one or more second members 104 that include one or more head orifices 132 that accept the head portion of the mosquito. Numerous types of mosquitos may be introduced into a device. Accordingly, in some embodiments, a first member 102 and a second member 104 of a device may be specifically selected for use with a specific type of mosquito. In some embodiments, a first member 102 and a second member 104 may include one or more thorax orifices 124 and one or more head orifices 132 which are specifically configured for a female anopheles mosquito. For example, in some embodiments, a first member 102 and a second member 104 may be selected for use with an anopheles stephensi mosquito. In some instances, an anopheles stephensi mosquito will have a probiscus that is between about 1.73 mm and about 2.08 mm in length. In some instances, an anopheles stephensi mosquito will have a head plus probiscus length that is between about 2.23 mm and about 2.6 mm. In some instances, an anopheles stephensi mosquito will have a head that is between about 0.6 mm and about 0.8 mm in width. In some instances, an anopheles stephensi mosquito will have a thorax that is between about 0.82 mm and about 1.08 mm in width. In some embodiments, a first member 102 may be selected that includes a substantially planar thorax plate 128 with a thickness of between about 0.060 inch and about 0.066 inch. In some embodiments, a first member 102 may be selected that includes a substantially planar thorax plate 128 with a thickness of between about 0.060 inch and about 0.066 inch which includes a substantially truncated cone shaped thorax orifice 124 having a base diameter that is between about 0.49 inch and about 0.51 inch with a hole that has a diameter between about 0.036 inch and about 0.04 inch. In some embodiments, a first member 102 may be selected that includes a substantially planar thorax plate 128 with a thickness of about 0.062 inch which includes a substantially truncated cone shaped thorax orifice 124 having a base diameter that is about 0.5 inch with a hole that has a diameter of about 0.037 inch. In some embodiments, a first member 102 may be selected that includes a substantially planar thorax plate 128 with a thickness of between about 0.060 inch and about 0.066 inch which includes a substantially truncated cone shaped thorax orifice 124 having an entry angle that is between about 14 degrees and about 16 degrees relative to the horizontal axis of the thorax plate 128 with a hole that has a diameter between about 0.036 inch and about 0.04 inch. Accordingly, first members 102 may be selected that include a thorax orifice 124 that may be configured in numerous ways to accept numerous types of mosquitos. Second members 104 may be selected that include a head orifice 132 that may be configured in numerous ways to accept numerous types of mosquitos. For example, in some embodiments, a second member may be selected that includes a substantially planar head plate 136 with a thickness of between about 0.1 inch and about 0.3 inch. In some embodiments, a second member may be selected that includes a substantially planar head plate 136 with a thickness of about 0.2 inch. In some embodiments, a second member may be selected that includes a substantially planar head plate 136 with a thickness of between about 0.1 inch and about 0.3 inch and a substantially truncated cone shaped head orifice 132 having a base diameter of between about 0.2 inch and about 0.3 inch and a hole diameter that is between about 0.05 inch and about 0.06 inch. In some embodiments, a second member may be selected that includes a substantially planar head plate 136 with a thickness of about 0.2 inch and a substantially truncated cone shaped head orifice 132 having a base diameter of about 0.25 inch with a hole diameter that is about 0.054 inch.

In some embodiments, operation 4510 includes introducing a bee into the device (not shown). In some embodiments, a bee may be introduced into a device that includes one or more first members 102 that include one or more thorax orifices 124 through which a head portion of the bee protrudes and which restrains a thorax portion of the bee and one or more second members 104 that include one or more head orifices 132 that accept the head portion of the bee. Numerous types of bees may be introduced into a device. Accordingly, in some embodiments, a first member 102 and a second member 104 of a device may be specifically selected for use with a specific type of bee. Bees exhibit a large range of dimensions. For example, bumble bee workers may have a head width that is between about 3 mm and 6 mm while honey bee workers may have a head width that is between about 3 mm and 4 mm. Accordingly, a user 116 may select a first member 102 and a second member 104 that configured to use with a specific type of bee.

In some embodiments, operation 4510 includes introducing a wasp into the device (not shown). In some embodiments, a wasp may be introduced into a device that includes one or more first members 102 that include one or more thorax orifices 124 through which a head portion of the wasp protrudes and which restrains a thorax portion of the wasp and one or more second members 104 that include one or more head orifices 132 that accept the head portion of the wasp. Numerous types of wasps may be introduced into a device. Accordingly, in some embodiments, a first member 102 and a second member 104 of a device may be specifically selected for use with a specific type of wasp. For example, a wasp may have a head width that is between about 3 mm and about 5 mm. Accordingly, a user 116 may select a first member 102 and a second member 104 that configured to use with a specific type of wasp.

In some embodiments, operation 4510 includes introducing a cricket into the device (not shown). In some embodiments, a cricket may be introduced into a device that includes one or more first members 102 that include one or more thorax orifices 124 through which a head portion of the cricket protrudes and which restrains a thorax portion of the cricket and one or more second members 104 that include one or more head orifices 132 that accept the head portion of the cricket. Numerous types of crickets may be introduced into a device. Accordingly, in some embodiments, a first member 102 and a second member 104 of a device may be specifically selected for use with a specific type of cricket. For example, a cricket may have a head width that is between about 5 mm and about 6 mm. Accordingly, a user 116 may select a first member 102 and a second member 104 that configured to use with a specific type of cricket.

In some embodiments, operation 4510 includes introducing a fruit fly into the device (not shown). In some embodiments, a fruit fly may be introduced into a device that includes one or more first members 102 that include one or more thorax orifices 124 through which a head portion of the fruit fly protrudes and which restrains a thorax portion of the fruit fly and one or more second members 104 that include one or more head orifices 132 that accept the head portion of the fruit fly. Numerous types of fruit flies may be introduced into a device. Accordingly, in some embodiments, a first member 102 and a second member 104 of a device may be specifically selected for use with a specific type of fruit fly. For example, Drosophila melanogaster may have a head width that is about 1 mm. Accordingly, a user 116 may select a first member 102 and a second member 104 that configured to use with a specific type of fruit fly.

In some embodiments, operation 4510 includes introducing a beetle into the device (not shown). In some embodiments, a beetle may be introduced into a device that includes one or more first members 102 that include one or more thorax orifices 124 through which a head portion of the beetle protrudes and which restrains a thorax portion of the beetle and one or more second members 104 that include one or more head orifices 132 that accept the head portion of the beetle. Numerous types of beetles may be introduced into a device. Accordingly, in some embodiments, a first member 102 and a second member 104 of a device may be specifically selected for use with a specific type of beetle. For example, a cowboy beetle may have a head width that is about 0.5 cm. Accordingly, a user 116 may select a first member 102 and a second member 104 that configured to use with a specific type of beetle.

In some embodiments, operation 4510 includes introducing a tick into the device (not shown). In some embodiments, a tick may be introduced into a device that includes one or more first members 102 that include one or more thorax orifices 124 through which a head portion of the tick protrudes and which restrains a thorax portion of the tick and one or more second members 104 that include one or more head orifices 132 that accept the head portion of the tick. Numerous types of ticks may be introduced into a device. Accordingly, in some embodiments, a first member 102 and a second member 104 of a device may be specifically selected for use with a specific type of tick. For example, a blacklegged tick may have a head width that is about 0.5 mm to about 1.0 mm. Accordingly, a user 116 may select a first member 102 and a second member 104 that configured to use with a specific type of tick.

In some embodiments, operation 4510 includes introducing the insect into the device with one or more attractants (not shown). In some embodiments, one or more attractants may be used to introduce an insect into a device. For example, in some embodiments, an attractant may be placed next to a device such that an insect inserts its head through a first member 102 and into a second member 104 of a device. Numerous attractants may be used. Examples of such attractants include, but are not limited to, gases (e.g., carbon dioxide), food, pheromones, and the like. In some embodiments, one or more attractants may be included within a base member 106 that is operably coupled to a first member 102 and to a second member 104 of a device.

In some embodiments, operation 4510 includes introducing the insect into the device with suction (not shown). In some embodiments, one or more suction devices may be used to introduce an insect into a device. For example, in some embodiments, the first member 102 and second member 104 of a device may be operably coupled to a suction device that creates a suction through the first member 102 and the second member 104 that draws an insect into the first member 102 and second member 104 of the device. In some embodiments, a first member 102 and a second member 104 may be operably coupled to a base member 106 that is operably coupled to a suction device 148.

In some embodiments, operation 4520 includes laterally moving one or more first members 102 relative to one or more second members 104 to immobilize the head portion of the insect (not shown). In some embodiments, a first member 102 may be moved relative to a second member 104 to immobilize the head portion of an insect. In some embodiments, a first member 102 may be mobile and a second member 104 may be stationary. In some embodiments, a first member 102 may be moved relative to a second member 104 to immobilize the head portion and the thorax portion of an insect. In some embodiments, a first member 102 may be moved relative to a second member 104 to immobilize the head portion of an insect while leaving the insect intact. In some embodiments, a first member 102 may be moved relative to a second member 104 to immobilize the head portion of an insect while separating the thorax portion of the insect from the head portion of the insect. In some embodiments, a first member 102 may be moved manually. For example, in some embodiments, a user 116 may manually move a first member 102 by grasping and moving the first member 102. In some embodiments, a user 116 may use a manual drive mechanism 160 to move a first member 102. In some embodiments, a first member 102 may be moved through use of an automated protocol. For example, in some embodiments, a drive motor may be used to move a first member 102. In some embodiments, a drive motor may be controlled electronically.

In some embodiments, operation 4520 includes laterally moving one or more second members 104 relative to one or more first members 102 to immobilize the head portion of the insect (not shown). In some embodiments, a second member 104 may be moved relative to a first member 102 to immobilize the head portion of an insect. In some embodiments, a second member 104 may be mobile and a first member 102 may be stationary. In some embodiments, a second member 104 may be moved relative to a first member 102 to immobilize the head portion and the thorax portion of an insect. In some embodiments, a second member 104 may be moved relative to a first member 102 to immobilize the head portion of an insect while leaving the insect intact. In some embodiments, a second member 104 may be moved relative to a first member 102 to immobilize the head portion of an insect while separating the thorax portion of the insect from the head portion of the insect. In some embodiments, a second member 104 may be moved manually. For example, in some embodiments, a user 116 may manually move a second member 104 by grasping and moving the second member 104. In some embodiments, a user 116 may use a manual drive mechanism 160 to move a second member 104. In some embodiments, a second member 104 may be moved through use of an automated protocol. For example, in some embodiments, a drive motor may be used to move a second member 104. In some embodiments, a drive motor may be controlled electronically.

In some embodiments, operation 4520 includes laterally moving one or more first members 102 and one or more second members 104 relative to each other to immobilize the head portion of the insect (not shown). In some embodiments, a first member 102 and a second member 104 may be moved relative to each other to immobilize the head portion of an insect. In some embodiments, a first member 102 and a second member 104 may be mobile. In some embodiments, a first member 102 and a second member 104 may be moved relative to each other to immobilize the head portion and the thorax portion of an insect. In some embodiments, a first member 102 and a second member 104 may be moved relative to each other to immobilize the head portion of an insect while leaving the insect intact. In some embodiments, a first member 102 and a second member 104 may be moved relative to each other to immobilize the head portion of an insect while separating the thorax portion of the insect from the head portion of the insect. In some embodiments, a first member 102 and a second member 104 may be moved manually. For example, in some embodiments, a user 116 may manually move a first member 102 and a second member 104 by grasping and moving the first member 102 and the second member 104. In some embodiments, a user 116 may use a manual drive mechanism 160 to move a first member 102 and a second member 104. In some embodiments, a first member 102 and a second member 104 may be moved through use of an automated protocol. For example, in some embodiments, a drive motor may be used to move a first member 102 and a second member 104. In some embodiments, a drive motor may be controlled electronically.

In some embodiments, operation 4520 includes utilizing one or more drive mechanisms to laterally move one or both the one or more first members 102 and the one or more second members 104 relative to each other (not shown). In some embodiments, a drive mechanism may be utilized to move a mobile first member 102 relative to an immobile second member 104. In some embodiments, a drive mechanism may be utilized to move a mobile second member 104 relative to an immobile first member 102. In some embodiments, a drive mechanism may be utilized to move a mobile first member 102 and a mobile second member 104 relative to each other. In some embodiments, a manual drive mechanism 160 may be used to move a first member 102 and/or a second member 104. For example, in some embodiments, a user 116 may manually operate a manual drive mechanism 160 to move a first member 102 and/or a second member 104. In some embodiments, a first member 102 and a second member 104 may be moved through use of an automated protocol. For example, in some embodiments, a drive motor 166 may be used to move a first member 102 and a second member 104. In some embodiments, a drive motor 166 may be controlled electronically.

In some embodiments, operation 4520 includes utilizing one or more drive motors 166 to laterally move one or both the one or more first members 102 and the one or more second members 104 relative to each other (not shown). In some embodiments, one or more drive motors 166 may be used to move one or more first members 102 and/or second members 104 relative to each other. Numerous types of drive motors 166 may be used. Examples of such drive motors 166 include, but are not limited to, electric drive motors, piezoelectric drive motors, stepper drive motors, and the like. In some embodiments, a drive motor 166 may be operated directly by a user. For example, in some embodiments, a user 116 may use a switch to turn a drive motor 166 on and off. In some embodiments, a drive motor 166 may be included within a drive mechanism 160. Accordingly, in some embodiments, one or more signals 122 may be used to control the operation of a drive motor 166. For example, in some embodiments, a user 116 may utilize a user interface 118 to cause one or more signals 122 to be transmitted that control the operation of a drive motor 166. In some embodiments, one or more signals 122 may be transmitted by a detection unit 114 that control the operation of a drive motor 166. In some embodiments, one or more signals 122 may be transmitted by an image acquisition device 194 that control the operation of a drive motor 166. Accordingly, the operation of a drive motor 166 may be controlled in numerous ways.

In some embodiments, operation 4530 includes sweeping the thorax portion of the insect away from the head portion of the insect (not shown). In some embodiments, sweeper arm 286 may be used to sweep the thorax portion of an insect away from the head portion of an insect. In some embodiments, the thorax portion of an insect may be manually swept away from the head portion of the insect. For example, in some embodiments, a sweeper arm 286 may be manually moved to sweep the thorax portion of an insect away from the head portion of the insect. In some embodiments, a user 116 may use a tool to sweep the thorax portion of an insect away from the head portion of the insect. For example, in some embodiments, a user 116 may use a brush to sweep the thorax portion of an insect away from the head portion of the insect. In some embodiments, a sweeper arm 286 may be included within a sweeper unit 110. Accordingly, in some embodiments, one or more signals 122 may be used to control the operation of a sweeper motor 186. For example, in some embodiments, a user 116 may utilize a user interface 118 to cause one or more signals 122 to be transmitted that control the operation of a sweeper motor 186. In some embodiments, one or more signals 122 may be transmitted by a detection unit 114 that control the operation of a sweeper motor 186. In some embodiments, one or more signals 122 may be transmitted by an image acquisition device 194 that control the operation of a sweeper motor 186. In some embodiments, an image acquisition device 194 may transmit one or more images that are displayed on a user interface 118. A user 116 may then cause one or more signals 122 to be transmitted that control a sweeper motor 186 that moves a sweeper arm 286 to separate a thorax portion of an insect away from the head portion of the insect.

In some embodiments, operation 4530 includes pulling the thorax portion of the insect away from the head portion of the insect (not shown). In some embodiments, a user 116 may pull the thorax portion of the insect away from the head portion of the insect with a tool. For example, in some embodiments, a user 116 may use a tweezers to grasp the thorax portion of the insect and pull the thorax portion of the insect away from the head portion of the insect.

In some embodiments, operation 4530 includes substantially separating the thorax portion of the insect away from the head portion of the insect so that the one or more salivary glands from the insect remain attached to the head portion and are extracted from the thorax portion (not shown). In some embodiments, sweeper arm 286 may be used to sweep the thorax portion of an insect away from the head portion of an insect to extract one or more salivary glands from the insect. In some embodiments, the thorax portion of an insect may be manually swept away from the head portion of the insect to extract one or more salivary glands from the insect. For example, in some embodiments, a sweeper arm 286 may be manually moved to sweep the thorax portion of an insect away from the head portion of the insect. In some embodiments, a user 116 may use a tool to sweep the thorax portion of an insect away from the head portion of the insect. For example, in some embodiments, a user 116 may use a brush to sweep the thorax portion of an insect away from the head portion of the insect. In some embodiments, a sweeper arm 286 may be included within a sweeper unit 110. Accordingly, in some embodiments, an automated protocol may be used to separate a thorax portion of an insect from a head portion of an insect. For example, in some embodiments, one or more signals 122 may be used to control the operation of a sweeper motor 186. In some embodiments, a user 116 may utilize a user interface 118 to cause one or more signals 122 to be transmitted that control the operation of a sweeper motor 186. In some embodiments, one or more signals 122 may be transmitted by a detection unit 114 that control the operation of a sweeper motor 186. For example, in some embodiments, an image acquisition device 194 may be configured to detect separation of the thorax portion of an insect from the head portion of an insect and transmit one or more signals 122 that control the operation of a sweeper motor 186 in response to detecting the separation. In some embodiments, an image acquisition device 194 may be configured to detect an insect salivary gland and transmit one or more signals 122 that control the operation of a sweeper motor 186 in response to detecting the insect salivary gland. In some embodiments, an image acquisition device 194 may be configured to obtain one or more images of an insect and transmit one or more images that are displayed on a user interface 118. A user 116 may then cause one or more signals 122 to be transmitted that control a sweeper motor 186 that moves a sweeper arm 286 to separate a thorax portion of an insect away from the head portion of the insect. In some embodiments, an image acquisition device 194 may transmit one or more images of an insect salivary gland that are displayed on a user interface 118. A user 116 may then cause one or more signals 122 to be transmitted that control a sweeper motor 186 that moves a sweeper arm 286 to separate a thorax portion of an insect away from the head portion of the insect to extract a salivary gland.

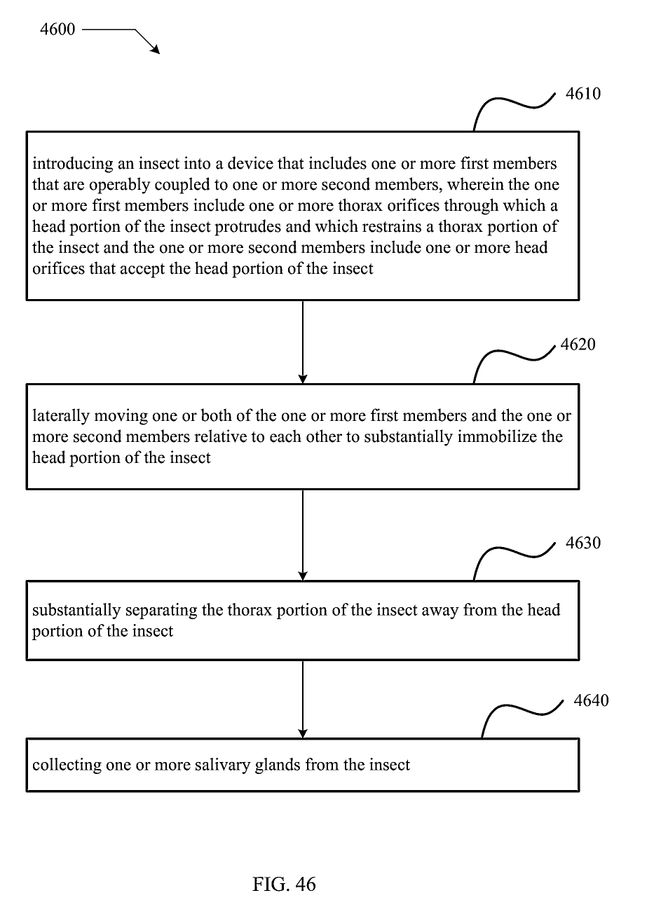

FIG. 46 illustrates operational flow 4600 that includes operations 4610, operation 4620, and operation 4630 that correspond to operations 4510, 4520, and 4530 as described above with regard to FIG. 45 with additional operation 4640 that includes collecting one or more salivary glands from the insect.

In FIG. 46 and in the following description that includes various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

Operation 4640 includes collecting one or more salivary glands from the insect. In some embodiments, one or more salivary glands may be collected from the insect manually. For example, in some embodiments, a user 116 may use a scraper 222 to collect an insect salivary gland. In some embodiments, a user 116 may use a suction intake 230 that is operably coupled to a suction device to collect an insect salivary gland. In some embodiments, a user 116 may utilize a detector 200 to detect an insect salivary gland. For example, in some embodiments, a user 116 may collect an insect salivary gland and then use a detector 200 to confirm collection of the insect salivary gland. In some embodiments, a user 116 may utilize an image acquisition device 194 to detect an insect salivary gland. For example, in some embodiments, a user 116 may detect an insect salivary gland with a microscope 198. In some embodiments, a user 116 may detect an insect salivary gland with a camera 196. Accordingly, in some embodiments, a user 116 may use numerous methods and devices to detect and then collect an insect salivary gland.

In some embodiments, an automated protocol may be used to collect a salivary gland from the insect. For example, in some embodiments, an image acquisition device 194 may obtain one or more images of an insect salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect an insect salivary gland. In some embodiments, one or more such signals 122 may be transmitted that direct an intake support member 234 and/or a moveable member 238 to position an operably coupled suction intake 230 to collect an insect salivary gland. In some embodiments, one or more such signals 122 may be transmitted by an image acquisition device 194 that is configured to detect an insect salivary gland.

In some embodiments, operation 4640 includes collecting one or more salivary glands from a mosquito (not shown). In some embodiments, a user 116 may collect one or more salivary gland from a mosquito manually. For example, in some embodiments, a user 116 may use a scraper 222 to collect a mosquito salivary gland. In some embodiments, a user 116 may use a suction intake 230 that is operably coupled to a suction device to collect a mosquito salivary gland. In some embodiments, a user 116 may utilize a detector 200 to detect a mosquito salivary gland. For example, in some embodiments, a user 116 may collect a mosquito salivary gland and then use a detector 200 to confirm collection of the mosquito salivary gland. In some embodiments, a user 116 may utilize an image acquisition device 194 to detect a salivary gland. For example, in some embodiments, a user 116 may detect a mosquito salivary gland with a microscope 198. In some embodiments, a user 116 may detect a mosquito salivary gland with a camera 196. Accordingly, in some embodiments, a user 116 may use numerous methods and devices to detect and then collect a mosquito salivary gland.

In some embodiments, an automated protocol may be used to collect a mosquito salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a mosquito salivary gland. In some embodiments, one or more such signals 122 may be transmitted that direct an intake support member 234 and/or a moveable member 238 to position an operably coupled suction intake 230 to collect a mosquito salivary gland. In some embodiments, one or more such signals 122 may be transmitted by an image acquisition device 194 that is configured to detect a mosquito salivary gland. In some embodiments, such signals 122 may be received by a collection unit 112 that is directed to collect a mosquito salivary gland. For example, in some embodiments, an image acquisition device 194 may detect one or more mosquito salivary glands and then transmit one or more signals 122 that direct a scraper aligner 224 and/or a moveable member 238 to position an operably coupled scraper 222 to collect a mosquito salivary gland. In some embodiments, an image acquisition device 194 may detect one or more mosquito salivary glands and then transmit one or more signals 122 that direct an intake support member 234 and/or a moveable member 238 to position an operably coupled suction intake 230 to collect a mosquito salivary gland. In some embodiments, an image acquisition device 194 may detect one or more mosquito salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a mosquito salivary gland. In another embodiment, the control unit 120 may then process the one or more signals 122 and then transmit one or more signals 122 that direct an intake support member 234 and/or a moveable member 238 to position an operably coupled suction intake 230 to collect a mosquito salivary gland. Accordingly, in some embodiments, an image acquisition device 194 may be configured to process one or more images in order to detect a mosquito salivary gland. For example, in some embodiments, an image detection device may include a detection processor 210 and detection memory 212. In some embodiments, detection memory 212 may include a database that includes multiple images of insect salivary glands that include images of mosquito salivary glands. Accordingly, a mosquito salivary gland may be detected by comparing collected images against images in the database. An image detection device may be configured in numerous ways to detect a mosquito salivary gland. In some embodiments, a control unit 120 may be configured to process one or more images in order to detect a mosquito salivary gland. For example, in some embodiments, a control unit 120 may include a control processor and control memory. In some embodiments, control memory may include a database that includes multiple images of insect salivary glands that include images of mosquito salivary glands. Accordingly, a mosquito salivary gland may be detected by comparing collected images against images in the database. A control unit 120 may be configured in numerous ways to detect a mosquito salivary gland.

In some embodiments, an image acquisition device 194 may be configured to process one or more images in order to detect the position of a mosquito salivary gland. For example, in some embodiments, an image detection device may detect an x-y grid that is projected onto a first member 102 and determine the position of a mosquito salivary gland on the first member 102. In some embodiments, an image detection device may detect one or more fiducial markers on a first member 102 and determine the position of a mosquito salivary gland on the first member 102. Accordingly, an image acquisition device 194 may be configured in numerous ways to detect the position of a mosquito salivary gland. In some embodiments, a control unit 120 may be configured to process one or more images in order to detect the position of a mosquito salivary gland. For example, in some embodiments, a control unit 120 may process an image that includes an x-y grid that is projected onto a first member 102 and determine the position of a mosquito salivary gland on the first member 102. In some embodiments, a control unit 120 may process an image that includes one or more fiducial markers on a first member 102 and determine the position of a mosquito salivary gland on the first member 102. Accordingly, a control unit 120 may be configured in numerous ways to detect the position of a mosquito salivary gland.

In some embodiments, operation 4640 includes collecting one or more salivary glands from a bee (not shown). In some embodiments, a user 116 may collect one or more salivary gland from a bee manually. For example, in some embodiments, a user 116 may use a scraper 222 to collect a bee salivary gland. In some embodiments, a user 116 may use a suction intake 230 that is operably coupled to a suction device 148 to collect a bee salivary gland. In some embodiments, a user 116 may utilize a detector 200 to detect a bee salivary gland. For example, in some embodiments, a user 116 may collect a bee salivary gland and then use a detector 200 to confirm collection of the bee salivary gland. In some embodiments, a user 116 may utilize an image acquisition device 194 to detect a salivary gland. For example, in some embodiments, a user 116 may detect a bee salivary gland with a microscope 198. In some embodiments, a user 116 may detect a bee salivary gland with a camera 196. Accordingly, in some embodiments, a user 116 may use numerous methods and devices to detect and then collect a bee salivary gland.

In some embodiments, an automated protocol may be used to collect a bee salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a bee salivary gland. In some embodiments, one or more such signals 122 may be transmitted that direct an intake support member 234 and/or a moveable member 238 to position an operably coupled suction intake 230 to collect a bee salivary gland. In some embodiments, one or more such signals 122 may be transmitted by an image acquisition device 194 that is configured to detect a bee salivary gland. In some embodiments, such signals 122 may be received by a collection unit 112 that is directed to collect a bee salivary gland. For example, in some embodiments, an image acquisition device 194 may detect one or more bee salivary glands and then transmit one or more signals 122 that direct a scraper aligner 224 and/or a moveable member 238 to position an operably coupled scraper 222 to collect a bee salivary gland. In some embodiments, an image acquisition device 194 may detect one or more bee salivary glands and then transmit one or more signals 122 that direct an intake support member 234 and/or a moveable member 238 to position an operably coupled suction intake 230 to collect a bee salivary gland. In some embodiments, an image acquisition device 194 may detect one or more bee salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a bee salivary gland. In another embodiments, the control unit 120 may then process the one or more signals 122 and then transmit one or more signals 122 that direct an intake support member 234 and/or a moveable member 238 to position an operably coupled suction intake 230 to collect a bee salivary gland. Accordingly, in some embodiments, an image acquisition device 194 may be configured to process one or more images in order to detect a bee salivary gland. For example, in some embodiments, an image detection device 194 may include a detection processor 210 and detection memory 212. In some embodiments, detection memory 212 may include a database that includes multiple images of insect salivary glands that include images of bee salivary glands. Accordingly, a bee salivary gland may be detected by comparing collected images against images in the database. An image detection device 194 may be configured in numerous ways to detect a bee salivary gland. In some embodiments, a control unit 120 may be configured to process one or more images in order to detect a bee salivary gland. For example, in some embodiments, a control unit 120 may include a control processor 264 and control memory 266. In some embodiments, control memory 266 may include a database that includes multiple images of insect salivary glands that include images of bee salivary glands. Accordingly, a bee salivary gland may be detected by comparing collected images against images in the database. A control unit 120 may be configured in numerous ways to detect a bee salivary gland.

In some embodiments, an image acquisition device 194 may be configured to process one or more images in order to detect the position of a bee salivary gland. For example, in some embodiments, an image detection device may detect an x-y grid that is projected onto a first member 102 and determine the position of a bee salivary gland on the first member 102. In some embodiments, an image detection device 194 may detect one or more fiducial markers on a first member 102 and determine the position of a bee salivary gland on the first member 102. Accordingly, an image acquisition device 194 may be configured in numerous ways to detect the position of a bee salivary gland. In some embodiments, a control unit 120 may be configured to process one or more images in order to detect the position of a bee salivary gland. For example, in some embodiments, a control unit 120 may process an image that includes an x-y grid that is projected onto a first member 102 and determine the position of a bee salivary gland on the first member 102. In some embodiments, a control unit 120 may process an image that includes one or more fiducial markers on a first member 102 and determine the position of a bee salivary gland on the first member 102. Accordingly, a control unit 120 may be configured in numerous ways to detect the position of a bee salivary gland.

In some embodiments, operation 4640 includes collecting one or more salivary glands from a wasp (not shown). In some embodiments, a user 116 may collect one or more salivary gland from a wasp manually. For example, in some embodiments, a user 116 may use a scraper 222 to collect a wasp salivary gland. In some embodiments, a user 116 may use a suction intake 230 that is operably coupled to a suction device to collect a wasp salivary gland. In some embodiments, a user 116 may utilize a detector 200 to detect a wasp salivary gland. For example, in some embodiments, a user 116 may collect a wasp salivary gland and then use a detector 200 to confirm collection of the wasp salivary gland. In some embodiments, a user 116 may utilize an image acquisition device 194 to detect a salivary gland. For example, in some embodiments, a user 116 may detect a wasp salivary gland with a microscope 198. In some embodiments, a user 116 may detect a wasp salivary gland with a camera 196. Accordingly, in some embodiments, a user 116 may use numerous methods and devices to detect and then collect a wasp salivary gland.

In some embodiments, an automated protocol may be used to collect a wasp salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a wasp salivary gland. In some embodiments, one or more such signals 122 may be transmitted that direct an intake support member 234 and/or a moveable member 238 to position an operably coupled suction intake 230 to collect a wasp salivary gland. In some embodiments, one or more such signals 122 may be transmitted by an image acquisition device 194 that is configured to detect a wasp salivary gland. In some embodiments, such signals 122 may be received by a collection unit 112 that is directed to collect a wasp salivary gland. For example, in some embodiments, an image acquisition device 194 may detect one or more wasp salivary glands and then transmit one or more signals 122 that direct a scraper aligner 224 and/or a moveable member 238 to position an operably coupled scraper 222 to collect a wasp salivary gland. In some embodiments, an image acquisition device 194 may detect one or more wasp salivary glands and then transmit one or more signals 122 that direct an intake support member 234 and/or a moveable member 238 to position an operably coupled suction intake 230 to collect a wasp salivary gland. In some embodiments, an image acquisition device 194 may detect one or more wasp salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a wasp salivary gland. In another embodiments, the control unit 120 may then process the one or more signals 122 and then transmit one or more signals 122 that direct an intake support member 234 and/or a moveable member 238 to position an operably coupled suction intake 230 to collect a wasp salivary gland. Accordingly, in some embodiments, an image acquisition device 194 may be configured to process one or more images in order to detect a wasp salivary gland. For example, in some embodiments, an image detection device may include a detection processor 210 and detection memory 212. In some embodiments, detection memory 212 may include a database that includes multiple images of insect salivary glands that include images of wasp salivary glands. Accordingly, a wasp salivary gland may be detected by comparing collected images against images in the database. An image detection device 194 may be configured in numerous ways to detect a wasp salivary gland. In some embodiments, a control unit 120 may be configured to process one or more images in order to detect a wasp salivary gland. For example, in some embodiments, a control unit 120 may include a control processor 264 and control memory 266. In some embodiments, control memory 266 may include a database that includes multiple images of insect salivary glands that include images of wasp salivary glands. Accordingly, a wasp salivary gland may be detected by comparing collected images against images in the database. A control unit 120 may be configured in numerous ways to detect a wasp salivary gland.

In some embodiments, an image acquisition device 194 may be configured to process one or more images in order to detect the position of a wasp salivary gland. For example, in some embodiments, an image detection device may detect an x-y grid that is projected onto a first member 102 and determine the position of a wasp salivary gland on the first member 102. In some embodiments, an image detection device may detect one or more fiducial markers on a first member 102 and determine the position of a wasp salivary gland on the first member 102. Accordingly, an image acquisition device 194 may be configured in numerous ways to detect the position of a wasp salivary gland. In some embodiments, a control unit 120 may be configured to process one or more images in order to detect the position of a wasp salivary gland. For example, in some embodiments, a control unit 120 may process an image that includes an x-y grid that is projected onto a first member 102 and determine the position of a wasp salivary gland on the first member 102. In some embodiments, a control unit 120 may process an image that includes one or more fiducial markers on a first member 102 and determine the position of a wasp salivary gland on the first member 102. Accordingly, a control unit 120 may be configured in numerous ways to detect the position of a wasp salivary gland.

In some embodiments, operation 4640 includes collecting one or more salivary glands from a cricket (not shown). In some embodiments, a user 116 may collect one or more salivary gland from a cricket manually. For example, in some embodiments, a user 116 may use a scraper 222 to collect a cricket salivary gland. In some embodiments, a user 116 may use a suction intake 230 that is operably coupled to a suction device to collect a cricket salivary gland. In some embodiments, a user 116 may utilize a detector 200 to detect a cricket salivary gland. For example, in some embodiments, a user 116 may collect a cricket salivary gland and then use a detector 200 to confirm collection of the cricket salivary gland. In some embodiments, a user 116 may utilize an image acquisition device 194 to detect a salivary gland. For example, in some embodiments, a user 116 may detect a cricket salivary gland with a microscope 198. In some embodiments, a user 116 may detect a cricket salivary gland with a camera 196. Accordingly, in some embodiments, a user 116 may use numerous methods and devices to detect and then collect a cricket salivary gland.

In some embodiments, an automated protocol may be used to collect a cricket salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a cricket salivary gland. In some embodiments, one or more such signals 122 may be transmitted that direct an intake support member 234 and/or a moveable member 238 to position an operably coupled suction intake 230 to collect a cricket salivary gland. In some embodiments, one or more such signals 122 may be transmitted by an image acquisition device 194 that is configured to detect a cricket salivary gland. In some embodiments, such signals 122 may be received by a collection unit 112 that is directed to collect a cricket salivary gland. For example, in some embodiments, an image acquisition device 194 may detect one or more cricket salivary glands and then transmit one or more signals 122 that direct a scraper aligner 224 and/or a moveable member 238 to position an operably coupled scraper 222 to collect a cricket salivary gland. In some embodiments, an image acquisition device 194 may detect one or more cricket salivary glands and then transmit one or more signals 122 that direct an intake support member 234 and/or a moveable member 238 to position an operably coupled suction intake 230 to collect a cricket salivary gland. In some embodiments, an image acquisition device 194 may detect one or more cricket salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a cricket salivary gland. In another embodiments, the control unit 120 may then process the one or more signals 122 and then transmit one or more signals 122 that direct an intake support member 234 and/or a moveable member 238 to position an operably coupled suction intake 230 to collect a cricket salivary gland. Accordingly, in some embodiments, an image acquisition device 194 may be configured to process one or more images in order to detect a cricket salivary gland. For example, in some embodiments, an image detection device may include a detection processor 210 and detection memory 212. In some embodiments, detection memory 212 may include a database that includes multiple images of insect salivary glands that include images of cricket salivary glands. Accordingly, a cricket salivary gland may be detected by comparing collected images against images in the database. An image detection device may be configured in numerous ways to detect a cricket salivary gland. In some embodiments, a control unit 120 may be configured to process one or more images in order to detect a cricket salivary gland. For example, in some embodiments, a control unit 120 may include a control processor and control memory. In some embodiments, control memory may include a database that includes multiple images of insect salivary glands that include images of cricket salivary glands. Accordingly, a cricket salivary gland may be detected by comparing collected images against images in the database. A control unit 120 may be configured in numerous ways to detect a cricket salivary gland.

In some embodiments, an image acquisition device 194 may be configured to process one or more images in order to detect the position of a cricket salivary gland. For example, in some embodiments, an image detection device may detect an x-y grid that is projected onto a first member 102 and determine the position of a cricket salivary gland on the first member 102. In some embodiments, an image detection device may detect one or more fiducial markers on a first member 102 and determine the position of a cricket salivary gland on the first member 102. Accordingly, an image acquisition device 194 may be configured in numerous ways to detect the position of a cricket salivary gland. In some embodiments, a control unit 120 may be configured to process one or more images in order to detect the position of a cricket salivary gland. For example, in some embodiments, a control unit 120 may process an image that includes an x-y grid that is projected onto a first member 102 and determine the position of a cricket salivary gland on the first member 102. In some embodiments, a control unit 120 may process an image that includes one or more fiducial markers on a first member 102 and determine the position of a cricket salivary gland on the first member 102. Accordingly, a control unit 120 may be configured in numerous ways to detect the position of a cricket salivary gland.

In some embodiments, operation 4640 includes collecting one or more salivary glands from a fruit fly (not shown). In some embodiments, a user 116 may collect one or more salivary gland from a fruit fly manually. For example, in some embodiments, a user 116 may use a scraper 222 to collect a fruit fly salivary gland. In some embodiments, a user 116 may use a suction intake 230 that is operably coupled to a suction device to collect a fruit fly salivary gland. In some embodiments, a user 116 may utilize a detector 200 to detect a fruit fly salivary gland. For example, in some embodiments, a user 116 may collect a fruit fly salivary gland and then use a detector 200 to confirm collection of the fruit fly salivary gland. In some embodiments, a user 116 may utilize an image acquisition device 194 to detect a salivary gland. For example, in some embodiments, a user 116 may detect a fruit fly salivary gland with a microscope 198. In some embodiments, a user 116 may detect a fruit fly salivary gland with a camera 196. Accordingly, in some embodiments, a user 116 may use numerous methods and devices to detect and then collect a fruit fly salivary gland.

In some embodiments, an automated protocol may be used to collect a fruit fly salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a fruit fly salivary gland. In some embodiments, one or more such signals 122 may be transmitted that direct an intake support member 234 and/or a moveable member 238 to position an operably coupled suction intake 230 to collect a fruit fly salivary gland. In some embodiments, one or more such signals 122 may be transmitted by an image acquisition device 194 that is configured to detect a fruit fly salivary gland. In some embodiments, such signals 122 may be received by a collection unit 112 that is directed to collect a fruit fly salivary gland. For example, in some embodiments, an image acquisition device 194 may detect one or more fruit fly salivary glands and then transmit one or more signals 122 that direct a scraper aligner 224 and/or a moveable member 238 to position an operably coupled scraper 222 to collect a fruit fly salivary gland. In some embodiments, an image acquisition device 194 may detect one or more fruit fly salivary glands and then transmit one or more signals 122 that direct an intake support member 234 and/or a moveable member 238 to position an operably coupled suction intake 230 to collect a fruit fly salivary gland. In some embodiments, an image acquisition device 194 may detect one or more fruit fly salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a fruit fly salivary gland. In another embodiments, the control unit 120 may then process the one or more signals 122 and then transmit one or more signals 122 that direct an intake support member 234 and/or a moveable member 238 to position an operably coupled suction intake 230 to collect a fruit fly salivary gland. Accordingly, in some embodiments, an image acquisition device 194 may be configured to process one or more images in order to detect a fruit fly salivary gland. For example, in some embodiments, an image detection device may include a detection processor 210 and detection memory 212. In some embodiments, detection memory 212 may include a database that includes multiple images of insect salivary glands that include images of fruit fly salivary glands. Accordingly, a fruit fly salivary gland may be detected by comparing collected images against images in the database. An image detection device may be configured in numerous ways to detect a fruit fly salivary gland. In some embodiments, a control unit 120 may be configured to process one or more images in order to detect a fruit fly salivary gland. For example, in some embodiments, a control unit 120 may include a control processor and control memory. In some embodiments, control memory may include a database that includes multiple images of insect salivary glands that include images of fruit fly salivary glands. Accordingly, a fruit fly salivary gland may be detected by comparing collected images against images in the database. A control unit 120 may be configured in numerous ways to detect a fruit fly salivary gland.

In some embodiments, an image acquisition device 194 may be configured to process one or more images in order to detect the position of a fruit fly salivary gland. For example, in some embodiments, an image detection device may detect an x-y grid that is projected onto a first member 102 and determine the position of a fruit fly salivary gland on the first member 102. In some embodiments, an image detection device may detect one or more fiducial markers on a first member 102 and determine the position of a fruit fly salivary gland on the first member 102. Accordingly, an image acquisition device 194 may be configured in numerous ways to detect the position of a fruit fly salivary gland. In some embodiments, a control unit 120 may be configured to process one or more images in order to detect the position of a fruit fly salivary gland. For example, in some embodiments, a control unit 120 may process an image that includes an x-y grid that is projected onto a first member 102 and determine the position of a fruit fly salivary gland on the first member 102. In some embodiments, a control unit 120 may process an image that includes one or more fiducial markers on a first member 102 and determine the position of a fruit fly salivary gland on the first member 102. Accordingly, a control unit 120 may be configured in numerous ways to detect the position of a fruit fly salivary gland.

In some embodiments, operation 4640 includes collecting one or more salivary glands from a beetle (not shown). In some embodiments, a user 116 may collect one or more salivary gland from a beetle manually. For example, in some embodiments, a user 116 may use a scraper 222 to collect a beetle salivary gland. In some embodiments, a user 116 may use a suction intake 230 that is operably coupled to a suction device to collect a beetle salivary gland. In some embodiments, a user 116 may utilize a detector 200 to detect a beetle salivary gland. For example, in some embodiments, a user 116 may collect a beetle salivary gland and then use a detector 200 to confirm collection of the beetle salivary gland. In some embodiments, a user 116 may utilize an image acquisition device 194 to detect a salivary gland. For example, in some embodiments, a user 116 may detect a beetle salivary gland with a microscope 198. In some embodiments, a user 116 may detect a beetle salivary gland with a camera 196. Accordingly, in some embodiments, a user 116 may use numerous methods and devices to detect and then collect a beetle salivary gland.

In some embodiments, an automated protocol may be used to collect a beetle salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a beetle salivary gland. In some embodiments, one or more such signals 122 may be transmitted that direct an intake support member 234 and/or a moveable member 238 to position an operably coupled suction intake 230 to collect a beetle salivary gland. In some embodiments, one or more such signals 122 may be transmitted by an image acquisition device 194 that is configured to detect a beetle salivary gland. In some embodiments, such signals 122 may be received by a collection unit 112 that is directed to collect a beetle salivary gland. For example, in some embodiments, an image acquisition device 194 may detect one or more beetle salivary glands and then transmit one or more signals 122 that direct a scraper aligner 224 and/or a moveable member 238 to position an operably coupled scraper 222 to collect a beetle salivary gland. In some embodiments, an image acquisition device 194 may detect one or more beetle salivary glands and then transmit one or more signals 122 that direct an intake support member 234 and/or a moveable member 238 to position an operably coupled suction intake 230 to collect a beetle salivary gland. In some embodiments, an image acquisition device 194 may detect one or more beetle salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a beetle salivary gland. In another embodiments, the control unit 120 may then process the one or more signals 122 and then transmit one or more signals 122 that direct an intake support member 234 and/or a moveable member 238 to position an operably coupled suction intake 230 to collect a beetle salivary gland. Accordingly, in some embodiments, an image acquisition device 194 may be configured to process one or more images in order to detect a beetle salivary gland. For example, in some embodiments, an image detection device may include a detection processor 210 and detection memory 212. In some embodiments, detection memory 212 may include a database that includes multiple images of insect salivary glands that include images of beetle salivary glands. Accordingly, a beetle salivary gland may be detected by comparing collected images against images in the database. An image detection device may be configured in numerous ways to detect a beetle salivary gland. In some embodiments, a control unit 120 may be configured to process one or more images in order to detect a beetle salivary gland. For example, in some embodiments, a control unit 120 may include a control processor and control memory. In some embodiments, control memory may include a database that includes multiple images of insect salivary glands that include images of beetle salivary glands. Accordingly, a beetle salivary gland may be detected by comparing collected images against images in the database. A control unit 120 may be configured in numerous ways to detect a beetle salivary gland.

In some embodiments, an image acquisition device 194 may be configured to process one or more images in order to detect the position of a beetle salivary gland. For example, in some embodiments, an image detection device may detect an x-y grid that is projected onto a first member 102 and determine the position of a beetle salivary gland on the first member 102. In some embodiments, an image detection device may detect one or more fiducial markers on a first member 102 and determine the position of a beetle salivary gland on the first member 102. Accordingly, an image acquisition device 194 may be configured in numerous ways to detect the position of a beetle salivary gland. In some embodiments, a control unit 120 may be configured to process one or more images in order to detect the position of a beetle salivary gland. For example, in some embodiments, a control unit 120 may process an image that includes an x-y grid that is projected onto a first member 102 and determine the position of a beetle salivary gland on the first member 102. In some embodiments, a control unit 120 may process an image that includes one or more fiducial markers on a first member 102 and determine the position of a beetle salivary gland on the first member 102. Accordingly, a control unit 120 may be configured in numerous ways to detect the position of a beetle salivary gland.

In some embodiments, operation 4640 includes collecting one or more salivary glands from a tick (not shown). In some embodiments, a user 116 may collect one or more salivary gland from a tick manually. For example, in some embodiments, a user 116 may use a scraper 222 to collect a tick salivary gland. In some embodiments, a user 116 may use a suction intake 230 that is operably coupled to a suction device to collect a tick salivary gland. In some embodiments, a user 116 may utilize a detector 200 to detect a tick salivary gland. For example, in some embodiments, a user 116 may collect a tick salivary gland and then use a detector 200 to confirm collection of the tick salivary gland. In some embodiments, a user 116 may utilize an image acquisition device 194 to detect a salivary gland. For example, in some embodiments, a user 116 may detect a tick salivary gland with a microscope 198. In some embodiments, a user 116 may detect a tick salivary gland with a camera 196. Accordingly, in some embodiments, a user 116 may use numerous methods and devices to detect and then collect a tick salivary gland.

In some embodiments, an automated protocol may be used to collect a tick salivary gland. For example, in some embodiments, an image acquisition device 194 may obtain one or more images of a salivary gland and then send the one or more images to a user interface 118 where the one or more images may be viewed. A user 116 may then use the user interface 118 to cause the transmission of one or more signals 122 that control one or more collection units 112 in response to the one or more images. For example, in some embodiments, one or more such signals 122 may be transmitted that direct a scraper aligner 224 and/or a moveable member 238 to position an operably coupled scraper 222 to collect a tick salivary gland. In some embodiments, one or more such signals 122 may be transmitted that direct an intake support member 234 and/or a moveable member 238 to position an operably coupled suction intake 230 to collect a tick salivary gland. In some embodiments, one or more such signals 122 may be transmitted by an image acquisition device 194 that is configured to detect a tick salivary gland. In some embodiments, such signals 122 may be received by a collection unit 112 that is directed to collect a tick salivary gland. For example, in some embodiments, an image acquisition device 194 may detect one or more tick salivary glands and then transmit one or more signals 122 that direct a scraper aligner 224 and/or a moveable member 238 to position an operably coupled scraper 222 to collect a tick salivary gland. In some embodiments, an image acquisition device 194 may detect one or more tick salivary glands and then transmit one or more signals 122 that direct an intake support member 234 and/or a moveable member 238 to position an operably coupled suction intake 230 to collect a tick salivary gland. In some embodiments, an image acquisition device 194 may detect one or more tick salivary glands and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect a tick salivary gland. In another embodiments, the control unit 120 may then process the one or more signals 122 and then transmit one or more signals 122 that direct an intake support member 234 and/or a moveable member 238 to position an operably coupled suction intake 230 to collect a tick salivary gland. Accordingly, in some embodiments, an image acquisition device 194 may be configured to process one or more images in order to detect a tick salivary gland. For example, in some embodiments, an image detection device may include a detection processor 210 and detection memory 212. In some embodiments, detection memory 212 may include a database that includes multiple images of insect salivary glands that include images of tick salivary glands. Accordingly, a tick salivary gland may be detected by comparing collected images against images in the database. An image detection device may be configured in numerous ways to detect a tick salivary gland. In some embodiments, a control unit 120 may be configured to process one or more images in order to detect a tick salivary gland. For example, in some embodiments, a control unit 120 may include a control processor and control memory. In some embodiments, control memory may include a database that includes multiple images of insect salivary glands that include images of tick salivary glands. Accordingly, a tick salivary gland may be detected by comparing collected images against images in the database. A control unit 120 may be configured in numerous ways to detect a tick salivary gland.

In some embodiments, an image acquisition device 194 may be configured to process one or more images in order to detect the position of a tick salivary gland. For example, in some embodiments, an image detection device may detect an x-y grid that is projected onto a first member 102 and determine the position of a tick salivary gland on the first member 102. In some embodiments, an image detection device may detect one or more fiducial markers on a first member 102 and determine the position of a tick salivary gland on the first member 102. Accordingly, an image acquisition device 194 may be configured in numerous ways to detect the position of a tick salivary gland. In some embodiments, a control unit 120 may be configured to process one or more images in order to detect the position of a tick salivary gland. For example, in some embodiments, a control unit 120 may process an image that includes an x-y grid that is projected onto a first member 102 and determine the position of a tick salivary gland on the first member 102. In some embodiments, a control unit 120 may process an image that includes one or more fiducial markers on a first member 102 and determine the position of a tick salivary gland on the first member 102. Accordingly, a control unit 120 may be configured in numerous ways to detect the position of a tick salivary gland.

In some embodiments, operation 4640 includes detecting one or more salivary glands (not shown). Numerous methods may be utilized to detect one or more insect salivary glands. In some embodiments, an image acquisition device 194 may be used to detect an insect salivary gland. In some embodiments, a microscope 198 may be used to detect an insect salivary gland. Numerous types of microscopy may be used. Examples of such microscopy include, but are not limited to, bright field microscopy, confocal microscopy, dark field microscopy, digital microscopy, fluorescence interference contrast microscopy, fluorescence microscopy, multifocal plane microscopy, phase contrast microscopy, and the like. In some embodiments, an image acquisition device 194 may be a camera 196. In some embodiments, an image acquisition device 194 may be a charge coupled device (CCD). In some embodiments, two-dimensional imaging with a grayscale device may be used to produce a digitized image. In some embodiments, three-dimensional imaging may be used to produce a depth map. In some embodiments, structured light methods may be used for imaging. In some embodiments, shading methods may be used for imaging. In some embodiments, passive stereoscopic methods may be used for imaging. In some embodiments, active stereoscopic methods may be used for imaging. In some embodiments, an image acquisition device 194 may utilize a database that includes one or more images of insect salivary glands. For example, in some embodiments, a database may include one or more images of a salivary gland from a specific type of insect. An image acquisition device 194 may then obtain one or more images of an insect salivary gland and then compare the acquired images to one or more images in the database to determine the presence of an insect salivary gland. In some embodiments, an image acquisition device 194 may be configured to detect a sporozoite. Accordingly, in some embodiments, an insect salivary gland may be detected by detecting one or more sporozoites. In some embodiments, a mosquito salivary gland may be detected by detecting one or more sporozoites.

In some embodiments, operation 4640 includes detecting one or more images of the one or more salivary glands (not shown). Numerous methods may be utilized to obtain one or more images of one or more insect salivary glands. In some embodiments, an image acquisition device 194 may be used to obtain one or more images of an insect salivary gland. In some embodiments, a microscope 198 may be used to obtain one or more images of an insect salivary gland. Numerous types of microscopy may be used. Examples of such microscopy include, but are not limited to, bright field microscopy, confocal microscopy, dark field microscopy, digital microscopy, fluorescence interference contrast microscopy, fluorescence microscopy, multifocal plane microscopy, phase contrast microscopy, and the like. In some embodiments, an image acquisition device 194 may be a camera 196. In some embodiments, an image acquisition device 194 may be a charge coupled device (CCD). In some embodiments, two-dimensional imaging with a grayscale device may be used to produce a digitized image. In some embodiments, three-dimensional imaging may be used to produce a depth map. In some embodiments, structured light methods may be used for imaging. In some embodiments, shading methods may be used for imaging. In some embodiments, passive stereoscopic methods may be used for imaging. In some embodiments, active stereoscopic methods may be used for imaging.

In some embodiments, operation 4640 includes detecting one or more physical properties of the one or more salivary glands (not shown). In some embodiments, the mass of an insect salivary gland may be determined with a balance 202. In some embodiments, the viscosity of an insect salivary gland may be determined with a viscometer. Accordingly, numerous methods and devices may be utilized to determine one or more physical characteristics of an insect salivary gland.

In some embodiments, operation 4640 includes detecting one or more spectral properties of the one or more salivary glands (not shown). In some embodiments, one or more spectrometers 208 may be used to determine one or more spectral properties of one or more insect salivary glands. Examples of spectrometers 208 that may be used include, but are not limited to, ultraviolet/visible light spectrometers 208, circular dichroism spectrometers 208, refractometers 206, mass spectrometers 206, and the like.

In some embodiments, operation 4640 includes collecting the one or more salivary glands by scraping the one or more salivary glands (not shown). In some embodiments, a user 116 may manually use a scraper 222 to collect an insect salivary gland. In some embodiments, an automated protocol may be used to collect an insect salivary gland by scraping the insect salivary gland. For example, in some embodiments, an image acquisition device 194 may obtain one or more images of an insect salivary gland and then send the one or more images to a user interface 118 where the one or more images may be viewed. A user 116 may then use the user interface 118 to cause the transmission of one or more signals 122 that direct a scraper aligner 224 and/or a moveable member 238 to position an operably coupled scraper 222 to collect the insect salivary gland. In some embodiments, an image acquisition device 194 may be configured to detect an insect salivary gland and transmit one or more signals 122 that direct a scraper aligner 224 and/or a moveable member 238 to position an operably coupled scraper 222 to collect the insect salivary gland. In some embodiments, an image acquisition device 194 may detect an insect salivary gland and then transmit one or more signals 122 that are received by a control unit 120. The control unit 120 may then process the one or more signals 122 and then transmit one or more signals 122 that direct a scraper aligner 224 and/or a moveable member 238 to position an operably coupled scraper 222 to collect the insect salivary gland. Accordingly, in some embodiments, an image acquisition device 194 may be configured to process one or more images in order to direct a scraper aligner 224 and/or a moveable member 238 to position an operably coupled scraper 222 to collect an insect salivary gland. In some embodiments, a control unit 120 may be configured to process one or more images in order to direct a scraper aligner 224 and/or a moveable member 238 to position an operably coupled scraper 222 to collect the insect salivary gland.

In some embodiments, an image acquisition device 194 may be configured to process one or more images in order to detect the position of an insect salivary gland. For example, in some embodiments, an image detection device may detect an x-y grid that is projected onto a first member 102 and determine the position of an insect salivary gland on the first member 102. In some embodiments, an image detection device may detect one or more fiducial markers on a first member 102 and determine the position of an insect salivary gland on the first member 102. Accordingly, an image acquisition device 194 may be configured in numerous ways to detect the position of an insect salivary gland and direct a scraper aligner 224 and/or a moveable member 238 to position an operably coupled scraper 222 to collect the insect salivary gland. In some embodiments, a control unit 120 may be configured to process one or more images in order to detect the position of an insect salivary gland. For example, in some embodiments, a control unit 120 may process an image that includes an x-y grid that is projected onto a first member 102 and determine the position of an insect salivary gland on the first member 102 in order to direct a scraper aligner 224 and/or a moveable member 238 to position an operably coupled scraper 222 to collect the insect salivary gland. In some embodiments, a control unit 120 may process an image that includes one or more fiducial markers on a first member 102 and determine the position of an insect salivary gland on the first member 102 in order to direct a scraper aligner 224 and/or a moveable member 238 to position an operably coupled scraper 222 to collect the insect salivary gland. Accordingly, a control unit 120 may be configured in numerous ways to detect the position of an insect salivary gland and direct a scraper aligner 224 and/or a moveable member 238 to position an operably coupled scraper 222 to collect the insect salivary gland.

In some embodiments, operation 4640 includes collecting the one or more salivary glands with suction (not shown). In some embodiments, a user 116 may manually use a suction intake 230 that is operably coupled to a suction device to collect an insect salivary gland. In some embodiments, an automated protocol may be used to collect an insect salivary gland with suction. For example, in some embodiments, an image acquisition device 194 may obtain one or more images of an insect salivary gland and then send the one or more images to a user interface 118 where the one or more images may be viewed. A user 116 may then use the user interface 118 to cause the transmission of one or more signals 122 that direct an intake support member 234 and/or a moveable member 238 to position an operably coupled suction intake 230 to collect the insect salivary gland. In some embodiments, an image acquisition device 194 may be configured to detect an insect salivary gland and transmit one or more signals 122 that direct an intake support member 234 and/or a moveable member 238 to position an operably coupled suction intake 230 to collect the insect salivary gland. In some embodiments, an image acquisition device 194 may detect an insect salivary gland and then transmit one or more signals 122 that are received by a control unit 120. The control unit 120 may then process the one or more signals 122 and then transmit one or more signals 122 that direct an intake support member 234 and/or a moveable member 238 to position an operably coupled suction intake 230 to collect the insect salivary gland. Accordingly, in some embodiments, an image acquisition device 194 may be configured to process one or more images in order to direct an intake support member 234 and/or a moveable member 238 to position an operably coupled suction intake 230 to collect the insect salivary gland. In some embodiments, a control unit 120 may be configured to process one or more images in order to direct an intake support member 234 and/or a moveable member 238 to position an operably coupled suction intake 230 to collect the insect salivary gland.

In some embodiments, an image acquisition device 194 may be configured to process one or more images in order to detect the position of an insect salivary gland. For example, in some embodiments, an image detection device may detect an x-y grid that is projected onto a first member 102 and determine the position of an insect salivary gland on the first member 102. In some embodiments, an image detection device may detect one or more fiducial markers on a first member 102 and determine the position of an insect salivary gland on the first member 102. Accordingly, an image acquisition device 194 may be configured in numerous ways to detect the position of an insect salivary gland and direct an intake support member 234 and/or a moveable member 238 to position an operably coupled suction intake 230 to collect the insect salivary gland. In some embodiments, a control unit 120 may be configured to process one or more images in order to detect the position of an insect salivary gland. For example, in some embodiments, a control unit 120 may process an image that includes an x-y grid that is projected onto a first member 102 and determine the position of an insect salivary gland on the first member 102 in order to direct an intake support member 234 and/or a moveable member 238 to position an operably coupled suction intake 230 to collect the insect salivary gland. In some embodiments, a control unit 120 may process an image that includes one or more fiducial markers on a first member 102 and determine the position of an insect salivary gland on the first member 102 in order to direct an intake support member 234 and/or a moveable member 238 to position an operably coupled suction intake 230 to collect the insect salivary gland. Accordingly, a control unit 120 may be configured in numerous ways to detect the position of an insect salivary gland and direct an intake support member 234 and/or a moveable member 238 to position an operably coupled suction intake 230 to collect the insect salivary gland.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/ /implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Although user 116 is described herein as a single individual, those skilled in the art will appreciate that user 116 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

### Example I

### Mosquito Collection and Preparation

In some embodiments, adult mosquitos may be collected by suction into a fifty milliliter tube that is coupled to a suction device. The fifty milliliter tube contains seventy percent ethanol. The mosquitos should not be left in the ethanol for more than five minutes. The mosquitos are then collected in a cell strainer. The mosquitos are briefly dunked in a petri dish that is filled with insect media. The mosquitos are then swirled to remove the ethanol from the mosquitos. The mosquitos should not be submerged in the insect media for more than five seconds. The mosquitos in the cell strainer are then placed on ice. The mosquitos are not allowed to dry.

### Example II

### Salivary Gland Collection

Device 400 is cleaned and then rinsed with seventy percent ethanol. The mosquitos are sorted so that they can be picked up quickly. The first member of device 400 is positioned at a first operating position. A suction device is turned on that is operably coupled to device 400. The head of each mosquito is then guided into a thorax orifice on the first member. Other appendages, such as legs or wings, are not allowed to enter the thorax orifice. Each mosquito is positioned such that the legs face away from the edge of the thorax orifice. The first member is moved to immobilize the mosquitos. The vacuum device is turned off. The sweeper arm is moved to sweep the thorax portions from the immobilized mosquitos. Any thoraxes from the immobilized mosquitos that are not swept by the sweeper arm are manually swept. The first member is then moved to cut the heads off the mosquitos. The tissue that is left on the first member is pipetted onto a slide and the mosquito salivary glands are detected using a compound microscope that is in a dark field mode.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device comprising:
one or more first members having one or more thorax orifices through which a head portion of an insect can protrude and which restrains a thorax portion of the insect; and
one or more second members having one or more head orifices that can accept the head portion of the insect and that are operably coupled to the one or more first members so that lateral movement of the one or more first members relative to the one or more second members substantially immobilizes the head portion of the insect.

2. The device of claim 1, wherein the one or more first members having one or more thorax orifices through which a head portion of an insect can protrude and which restrains a thorax portion of the insect comprises:
one or more first members having one or more thorax orifices through which the head portion of a mosquito can protrude.

3-14. (canceled)

15. The device of claim 1, wherein the one or more first members having one or more thorax orifices through which a head portion of an insect can protrude and which restrains a thorax portion of the insect comprises:
one or more first members that include one or more substantially planar thorax plates having one or more thorax orifices through which the head portion of the insect can protrude.

16-22. (canceled)

23. The device of claim 1, wherein the one or more second members having one or more head orifices that can accept the head portion of the insect and that are operably coupled to the one or more first members so that lateral movement of the one or more first members relative to the one or more second members substantially immobilizes the head portion of the insect comprises:
one or more second members having one or more head orifices that can accept the head portion of a mosquito.

24-37. (canceled)

38. The device of claim 1, wherein the one or more second members having one or more head orifices that can accept the head portion of the insect and that are operably coupled to the one or more first members so that lateral movement of the one or more first members relative to the one or more second members substantially immobilizes the head portion of the insect comprises:
one or more second members that include one or more substantially planar head plates having one or more head orifices that can accept the head portion of the insect.

39-45. (canceled)

46. The device of claim 1, further comprising:
one or more operably coupled drive mechanisms that move either or both of the one or more first members and the one or more second members laterally relative to each other.

47. (canceled)

48. The device of claim 46, where the one or more operably coupled drive mechanisms that move either or both of the one or more first members and the one or more second members laterally relative to each other comprise:
one or more manual drive mechanisms.

49. The device of claim 46, where the one or more operably coupled drive mechanisms that move either or both of the one or more first members and the one or more second members laterally relative to each other comprise:
one or more drive motors.

50-55. (canceled)

56. The device of claim 1, further comprising:
one or more base members that are operably coupled to the one or more first members and to the one or more second members.

57. The device of claim 56, wherein the one or more base members that are operably coupled to the one or more first members and to the one or more second members comprise:
one or more base members that are configured to be operably coupled to one or more suction devices.

58. (canceled)

59. The device of claim 1, further comprising:
one or more operably coupled sweeper arms.

60. (canceled)

61. The device of claim 59, wherein the one or more operably coupled sweeper arms comprise:
one or more sweeper arms that are slideably coupled to one or more sweeper support members and to one or more sweeper drive mechanisms.

62. The device of claim 1, further comprising:
one or more operably coupled image acquisition devices.

63-65. (canceled)

66. The device of claim 62, wherein the one or more operably coupled image acquisition devices comprise:
one or more image acquisition devices that are configured to detect one or more insect salivary glands.

67. The device of claim 62, wherein the one or more operably coupled image acquisition devices comprise:
one or more image acquisition devices that are configured to detect one or more mosquito salivary glands.

68-74. (canceled)

75. The device of claim 62, wherein the one or more operably coupled image acquisition devices comprise:
one or more image acquisition devices that are operably coupled to one or more drive mechanisms that move either or both of the one or more first members and the one or more second members laterally relative to each other in response to detecting one or more insect salivary glands.

76-85. (canceled)

86. The device of claim 1, further comprising:
one or more operably coupled scrapers.

87-101. (canceled)

102. The device of claim 86, wherein the one or more operably coupled scrapers comprise:
one or more scrapers that are operably coupled to one or more movable members.

103. (canceled)

104. The device of claim 86, wherein the one or more operably coupled scrapers comprise:
one or more scrapers that are operably coupled to one or more movable members that position the one or more scrapers in response to receiving one or more signals from one or more image acquisition devices that are configured to detect one or more insect salivary glands.

105-108. (canceled)

109. The device of claim 1, further comprising:
one or more operably coupled suction assemblies.

110-122. (canceled)

123. The device of claim 109, wherein the one or more operably coupled suction assemblies comprise:
one or more suction assemblies that are operably coupled to one or more movable members.

124-125. (canceled)

126. The device of claim 109, wherein the one or more operably coupled suction assemblies comprise:
one or more suction assemblies that are operably coupled to one or more movable members that position the one or more suction assemblies in response to detecting the one or more insect salivary glands with one or more image acquisition devices.

127-130. (canceled)

131. A device comprising:
one or more first members having one or more thorax orifices through which a head portion of an insect can protrude and which restrains a thorax portion of the insect;
one or more second members having one or more head orifices that can accept the head portion of the insect and that are operably coupled to the one or more first members so that lateral movement of the one or more first members relative to the one or more second members substantially immobilizes the head portion of the insect;
one or more base members that are operably coupled to the one or more first members and to the one or more second members;
one or more drive mechanisms that are operably coupled to one or more position indicators and that move either or both of the one or more first members and the one or more second members laterally relative to each other; and
one or more operably coupled sweeper arms.

132. A system comprising:
circuitry configured to control one or more drive mechanisms that laterally move one or more first members relative to one or more second members of a device;
wherein the one or more first members include one or more thorax orifices through which a head portion of the insect protrudes and which restrains a thorax portion of the insect and the one or more second members include one or more head orifices that accept the head portion of the insect.

133-139. (canceled)

140. The system of claim 132, further comprising:
circuitry configured to control one or more sweeper drive mechanisms.

141-144. (canceled)

145. The system of claim 132, further comprising:
circuitry configured to control one or more image acquisition devices.

146-166. (canceled)

167. The system of claim 145, further comprising:
circuitry configured to control one or more movable members that are operably coupled to one or more scrapers.

168-172. (canceled)

173. The system of claim 145, further comprising:
circuitry configured to control one or more suction assemblies.

174-237. (canceled)

238. A method comprising:
introducing an insect into a device that includes one or more first members that are operably coupled to one or more second members, wherein the one or more first members include one or more thorax orifices through which a head portion of the insect protrudes and which restrains a thorax portion of the insect and the one or more second members include one or more head orifices that accept the head portion of the insect;
laterally moving one or both of the one or more first members and the one or more second members relative to each other to substantially immobilize the head portion of the insect; and
substantially separating the thorax portion of the insect from the head portion of the insect.

239. The method of claim 238, wherein the introducing an insect into a device that includes one or more first members that are operably coupled to one or more second members, wherein the one or more first members include one or more thorax orifices through which a head portion of the insect protrudes and which restrains a thorax portion of the insect and the one or more second members include one or more head orifices that accept the head portion of the insect comprises:
introducing a mosquito into the device.

240-252. (canceled)

253. The method of claim 238, wherein the substantially separating the thorax portion of the insect from the head portion of the insect comprises:
sweeping the thorax portion of the insect away from the head portion of the insect.

254. (canceled)

255. The method of claim 238, wherein the substantially separating the thorax portion of the insect from the head portion of the insect comprises:
substantially separating the thorax portion of the insect from the head portion of the insect so that the one or more salivary glands from the insect remain attached to the head portion and are extracted from the thorax portion.

256. The method of claim 238, further comprising:
collecting one or more salivary glands from the insect.

257. The method of claim 256, wherein the collecting one or more salivary glands from the insect comprises:
collecting one or more salivary glands from a mosquito.

258-269. (canceled)
